(19) United States
(12) Patent Application Publication
(10) Pub. No.: US 2024/0340206 A1
(43) Pub. Date: Oct. 10, 2024

(54) SOUNDING FRAME TRANSMISSION METHOD AND RELATED APPARATUS

(71) Applicant: HUAWEI TECHNOLOGIES CO., LTD., Shenzhen (CN)

(72) Inventors: Yajing ZHOU, Chengdu (CN); Chenchen LIU, Shenzhen (CN); Zhengchun ZHOU, Chengdu (CN); Xianfu LEI, Chengdu (CN)

(21) Appl. No.: 18/671,229

(22) Filed: May 22, 2024

Related U.S. Application Data
(63) Continuation of application No. PCT/CN2022/133792, filed on Nov. 23, 2022.

(30) Foreign Application Priority Data
Nov. 26, 2021 (CN) 202111438461.3

(51) Int. Cl. H04L 27/26; H04L 1/1607; H04L 27/34

(52) U.S. Cl. CPC H04L 27/261; H04L 1/1642; H04L 27/34

(57) ABSTRACT

This application provides a sounding frame transmission method and a related apparatus. The method is applied to a first device, and the method includes: generating a sounding frame, where the sounding frame includes a first field, the first field includes a predefined first sequence, the first sequence includes a sequence obtained after a second sequence is modulated by using at least one of the following modulation modes, and the modulation modes include: QPSK, 16-QAM, 64-QAM, 256-QAM, 1024-QAM, and 4096-QAM; and sending the sounding frame. In this way, channel quality of a communication link in at least one of modulation modes of QPSK, 16-QAM, 64-QAM, 256-QAM, 1024-QAM, and 4096-QAM can be accurately measured when channel measurement is performed by using the first sequence, thereby enriching application scenarios of an EHT-LTF sequence.

### CROSS-REFERENCE TO RELATED APPLICATIONS

This application is a continuation of International Application No. PCT/CN2022/133792, filed on Nov. 23, 2022, which claims priority to Chinese Patent Application No. 202111438461.3, filed on Nov. 26, 2021. The disclosures of the aforementioned applications are hereby incorporated by reference in their entireties.

### TECHNICAL FIELD

This application relates to the field of communication technologies, and in particular, to a sounding frame transmission method and a related apparatus.

### BACKGROUND

In a wireless local area network (WLAN), a communication link may be established between a wireless access point (AP) and a station (STA), to communicate with each other through a shared wireless communication medium. Generally, a WLAN device may adjust a transmission parameter based on channel quality of the communication link, to optimize transmission throughput or reliability of the communication link. For example, in 802.11ax, channel quality of the communication link is measured by using a high efficiency long training field (HE-LTF) sequence; and in 802.11be, channel quality of the communication link is measured by using an extremely high throughput long training field (EHT-LTF) sequence. However, in a current stage, components corresponding to tones in the HE-LTF sequence or the EHT-LTF sequence are all +1, 0, or −1. In other words, a current HE-LTF sequence or a current EHT-LTF sequence is an HE-LTF sequence or an EHT-LTF sequence under binary phase shift keying (BPSK) modulation. It may be understood that distortion of the HE-LTF sequence or the EHT-LTF sequence under BPSK modulation is small, and a peak-to-average power ratio (PAPR) is low. Therefore, when the HE-LTF sequence or the EHT-LTF sequence is used to measure the channel quality of the communication link, only channel quality of the communication link under BPSK modulation can be accurately measured. In other words, the current HE-LTF sequence or the current EHT-LTF sequence is applicable to a single scenario, and cannot accurately measure channel quality of the communication link in more application scenarios.

### SUMMARY

This application provides a sounding frame transmission method and a related apparatus, so that channel quality of a communication link in at least one of modulation modes of QPSK, 16-QAM, 64-QAM, 256-QAM, 1024-QAM and 4096-QAM can be accurately measured when channel measurement is performed by using a first sequence, thereby enriching application scenarios of an EHT-LTF sequence.

According to a first aspect, a sounding frame transmission method is provided. The method is applied to a first device, and the method includes: generating a sounding frame, where the sounding frame includes a first field, the first field includes a predefined first sequence, the first sequence includes a sequence obtained after a second sequence is modulated by using at least one of the following modulation modes, and the modulation modes include: quadrature phase shift keying QPSK, 16-quadrature amplitude modulation 16-QAM, 64-QAM, 256-QAM, 1024-QAM, and 4096-QAM; and sending the sounding frame. In this way, channel quality of a communication link in at least one of modulation modes of QPSK, 16-QAM, 64-QAM, 256-QAM, 1024-QAM, and 4096-QAM can be measured when channel measurement is performed by using the first sequence, thereby enriching application scenarios of an HE-LTF sequence or an EHT-LTF sequence. In addition, because a PAPR of the first sequence is low, distortion of the first sequence is small, so that the channel quality of the communication link in at least one of modulation modes of QPSK, 16-QAM, 64-QAM, 256-QAM, 1024-QAM, and 4096-QAM can be accurately measured when channel measurement is performed by using the first sequence.

According to a second aspect, a sounding frame transmission method is provided. The method is applied to a second device, and the method includes: receiving a sounding frame, where the sounding frame includes a first field, the first field includes a predefined first sequence, the first sequence includes a sequence obtained after a second sequence is modulated by using at least one of the following modulation modes, and the modulation modes include: quadrature phase shift keying QPSK, 16-quadrature amplitude modulation 16-QAM, 64-QAM, 256-QAM, 1024-QAM, and 4096-QAM; and performing channel measurement based on the first sequence. In this way, channel quality of a communication link in at least one of modulation modes of QPSK, 16-QAM, 64-QAM, 256-QAM, 1024-QAM, and 4096-QAM can be measured when channel measurement is performed by using the first sequence, thereby enriching application scenarios of an HE-LTF sequence or an EHT-LTF sequence. In addition, because a PAPR of the first sequence is low, distortion of the first sequence is small, so that the channel quality of the communication link in at least one of modulation modes of QPSK, 16-QAM, 64-QAM, 256-QAM, 1024-QAM, and 4096-QAM can be accurately measured when channel measurement is performed by using the first sequence.

According to a third aspect, a communication apparatus is provided, where the communication apparatus includes a processing module and a transceiver module. The processing module is configured to generate a sounding frame. The sounding frame includes a first field, the first field includes a predefined first sequence, the first sequence includes a sequence obtained after a second sequence is modulated by using at least one of the following modulation modes, and the modulation modes include: quadrature phase shift keying QPSK, 16-quadrature amplitude modulation 16-QAM, 64-QAM, 256-QAM, 1024-QAM, and 4096-QAM. The transceiver module is configured to send the sounding frame.

According to a fourth aspect, a communication apparatus is provided, where the communication apparatus includes a processing module and a transceiver module. The transceiver module is configured to receive a sounding frame. The sounding frame includes a first field, the first field includes a predefined first sequence, the first sequence includes a sequence obtained after a second sequence is modulated by using at least one of the following modulation modes, and the modulation modes include: quadrature phase shift keying QPSK, 16-quadrature amplitude modulation 16-QAM, 64-QAM, 256-QAM, 1024-QAM, and 4096-QAM. The processing module is configured to perform channel measurement based on the first sequence.

Optionally, with reference to the first aspect, the second aspect, the third aspect, or the fourth aspect, the second sequence is an HE-LTF sequence or an EHT-LTF sequence in a 4× mode at an 80 MHz bandwidth.

The HE-LTF sequence is:

HE-LTF₄ₓ(−500:500) =

[1, −1, −1, −1, −1, 1, −1, −1, 1, −1, −1, −1, 1, 1, −1, −1, −1, 1, −1, −1, 1, −1, 1, 1, 1, −1,
1, −1, 1, −1, −1, −1, −1, 1, 1, 1, 1, 1, −1, −1, 1, −1, 1, −1, −1, −1, 1, 1, −1, −1, 1, −1, −1, −1, 1, 1, 1,
−1, −1, 1, 1, −1, −1, 1, −1, 1, 1, −1, 1, −1, 1, 1, 1, −1, 1, −1, 1, 1, 1, 1, 1, 1, −1, −1, −1, 1, −1, 1, −1,
−1, −1, 1, −1, −1, 1, 1, 1, 1, 1, 1, −1, 1, −1, 1, 1, −1, 1, −1, 1, −1, 1, −1, 1, −1, −1, 1, 1, 1, 1, −1, −1,
−1, −1, −1, −1, −1, −1, 1, −1, −1, 1, −1, −1, 1, 1, 1, −1, 1, −1, −1, −1, 1, 1, 1, −1, 1, 1, −1, −1, 1, −1,
−1, −1, 1, 1, 1, 1, −1, 1, 1, 1, 1, 1, 1, −1, 1, −1, −1, 1, −1, 1, −1, −1, 1, 1, 1, 1, 1, −1, 1, 1, −1, −1, 1,
1, 1, −1, 1, 1, −1, 1, 1, −1, −1, 1, 1, −1, −1, −1, −1, 1, 1, 1, 1, 1, −1, 1, 1, 1, 1, 1, −1, 1, −1, 1, −1, −1,
1, −1, −1, −1, −1, −1, 1, −1, −1, −1, 1, 1, −1, 1, −1, 1, −1, −1, −1, −1, −1, 1, 1, 1, 1, −1, 1, −1, −1, 1,
1, −1, −1, −1, 1, 1, 1, 1, 1, −1, 1, −1, 1, −1, −1, 1, 1, 1, −1, 1, 1, 1, 1, 1, −1, 1, 1, −1, 1, −1, 1, −1, −1,
−1, −1, −1, 1, −1, −1, −1, −1, −1, 1, 1, 1, 1, −1, −1, 1, 1, −1, −1, 1, −1, −1, 1, −1, −1, −1, 1, 1, −1, −1,
1, −1, −1, −1, −1, −1, 1, 1, −1, 1, −1, 1, 1, −1, 1, −1, −1, −1, −1, −1, −1, 1, −1, −1, −1, −1, 1, 1, 1, −1,
1, 1, −1, −1, 1, −1, −1, −1, 1, 1, 1, −1, 1, −1, 1, −1, −1, −1, 1, −1, 1, −1, 1, −1, −1, −1, 1, −1, −1, 1, −1,
1, 1, −1, −1, −1, 1, 1, −1, −1, −1, −1, 1, −1, 1, 1, −1, 1, −1, 1, 1, 1, 1, 1, 1, −1, −1, 1, −1, −1, −1, 1,
−1, 1, −1, −1, −1, 1, 1, 1, 1, 1, 1, −1, 1, −1, 1, 1, 1, −1, 1, −1, 1, 1, −1, 1, −1, −1, 1, 1, −1, −1, 1, 1, 1,
−1, −1, −1, 1, −1, −1, 1, 1, −1, −1, −1, 1, −1, 1, −1, −1, 1, 1, 1, 1, 1, −1, −1, −1, −1, 1, −1, 1, −1, 1, 1,
1, −1, 1, −1, −1, 1, −1, −1, −1, 1, 1, −1, −1, −1, 1, −1, −1, 1, −1, −1, −1, −1, 1, −1, 1, 1, −1, −1, −1, 1,
−1, −1, 0, 0, 0, 0, 0, −1, −1, 1, −1, 1, 1, 1, 1, 1, 1, −1, −1, −1, −1, 1, −1, −1, 1, −1, −1, −1, 1, 1, −1,
−1, −1, 1, −1, −1, 1, −1, 1, 1, 1, −1, 1, −1, 1, −1, −1, −1, −1, 1, 1, 1, 1, 1, −1, −1, 1, −1, 1, −1, −1, −1,
1, 1, −1, −1, 1, −1, −1, −1, 1, 1, 1, −1, −1, 1, 1, −1, −1, 1, −1, 1, 1, −1, 1, −1, 1, 1, 1, −1, 1, −1, 1, 1,
1, 1, 1, 1, −1, −1, −1, 1, −1, 1, −1, −1, −1, 1, −1, −1, 1, 1, 1, 1, 1, 1, −1, 1, −1, 1, 1, −1, 1, −1, −1, −1,
−1, 1, 1, −1, −1, −1, 1, 1, −1, 1, −1, −1, 1, −1, −1, −1, 1, −1, 1, −1, 1, −1, −1, −1, 1, −1, 1, −1, 1, 1, 1,
−1, −1, −1, 1, −1, −1, 1, 1, −1, 1, 1, 1, −1, −1, −1, −1, 1, −1, −1, −1, −1, −1, −1, 1, −1, 1, 1, −1, 1, −1,
1, 1, −1, −1, −1, −1, −1, 1, −1, −1, 1, 1, −1, −1, −1, 1, −1, −1, 1, −1, −1, 1, 1, −1, −1, 1, 1, 1, 1, −1, −1,
−1, −1, −1, 1, −1, −1, −1, −1, −1, 1, −1, 1, −1, 1, 1, −1, 1, 1, 1, 1, 1, −1, 1, 1, 1, −1, −1, 1, −1, 1, -1,
1, 1, 1, 1, 1, −1, −1, −1, 1, 1, −1, −1, −1, −1, −1, −1, −1, −1, 1, 1, 1, 1, 1, −1, 1, −1, 1, −1, −1, 1, 1,
1, −1, 1, 1, 1, 1, 1, −1, 1, 1, −1, 1, −1, 1, −1, −1, −1, −1, −1, 1, −1, −1, −1, −1, −1, 1, 1, 1, 1, −1, −1,
1, 1, −1, −1, 1, −1, −1, 1, −1, −1, −1, 1, 1, −1, −1, 1, −1, −1, −1, −1, −1, 1, 1, −1, 1, −1, 1, 1, −1, 1, −1,
−1, −1, −1, −1, −1, 1, −1, −1, −1, −1, 1, 1, 1, −1, 1, 1, −1, −1, 1, −1, −1, −1, 1, 1, 1, −1, 1, −1, −1,
−1, 1, 1, −1, 1, 1, −1, 1, 1, 1, 1, 1, 1, 1, 1, −1, −1, −1, −1, 1, 1, −1, 1, −1, 1, −1, 1, −1, 1, −1, −1, 1, −1,
1, −1, −1, −1, −1, −1, −1, 1, 1, −1, 1, 1, 1, −1, 1, −1, 1, 1, 1, −1, −1, −1, −1, −1, −1, 1, −1, 1, −1, −1,
−1, 1, −1, 1, −1, −1, 1, −1, 1, 1, −1, −1, 1, 1, −1, −1, −1, 1, 1, 1, −1, 1, 1, −1, −1, 1, 1, 1, −1, 1, −1,
1, 1, −1, −1, −1, −1, −1, 1, 1, 1, 1, −1, 1, −1, 1, −1, −1, −1, 1, −1, 1, 1, −1, 1, 1, 1, −1, −1, 1, 1, 1, −1,
1, 1, −1, 1, 1, 1, 1, −1].

The expression HE−LTF_{4×}(−500: 500) means that values on tones whose sequence numbers are −500 to 500 are values in the HE-LTF sequence successively. That is, it can be learned that components of the second sequence are all +1, 0, or −1, and distortion of the HE-LTF sequence under BPSK modulation is small and a PAPR is low. Therefore, channel quality of a link under BPSK modulation can be accurately measured.

The EHT-LTF sequence is:

EHT-LTF₄ₓ(−500:500) =

[1, −1, −1, −1, −1, 1, −1, −1, 1, −1, −1, −1, 1, 1, −1, −1, −1, 1, −1, −1, 1, −1, 1, 1, 1, −1,
1, −1, 1, −1, −1, −1, −1, 1, 1, 1, 1, 1, −1, −1, 1, −1, 1, −1, −1, −1, 1, 1, −1, −1, 1, −1, −1, −1, 1, 1, 1,
−1, −1, 1, 1, −1, −1, 1, −1, 1, 1, −1, 1, −1, 1, 1, 1, −1, 1, −1, 1, 1, 1, 1, 1, 1, −1, −1, −1, 1, −1, 1, −1,
−1, −1, 1, −1, −1, 1, 1, 1, 1, 1, 1, −1, 1, −1, 1, 1, −1, 1, −1, 1, −1, 1, −1, 1, −1, −1, 1, 1, 1, 1, −1, −1,
−1, −1, −1, −1, −1, −1, 1, −1, −1, 1, −1, −1, 1, 1, 1, −1, 1, −1, −1, −1, 1, 1, 1, −1, 1, 1, −1, −1, 1, −1,
−1, −1, 1, 1, 1, 1, −1, 1, 1, 1, 1, 1, 1, −1, 1, −1, −1, 1, −1, 1, −1, −1, 1, 1, 1, 1, 1, −1, 1, 1, −1, −1, 1,
1, 1, −1, 1, 1, −1, 1, 1, −1, −1, 1, 1, −1, −1, −1, −1, 1, 1, 1, 1, 1, −1, 1, 1, 1, 1, 1, −1, 1, −1, 1, −1, −1,
1, −1, −1, −1, −1, −1, 1, −1, −1, −1, 1, 1, −1, 1, −1, 1, −1, −1, −1, −1, −1, 1, 1, 1, 1, −1, 1, −1, −1, 1,
1, −1, −1, −1, 1, 1, 1, 1, 1, −1, 1, −1, 1, −1, −1, 1, 1, 1, −1, 1, 1, 1, 1, 1, −1, 1, 1, −1, 1, −1, 1, −1, −1,
−1, −1, −1, 1, −1, −1, −1, −1, −1, 1, 1, 1, 1, −1, −1, 1, 1, −1, −1, 1, −1, −1, 1, −1, −1, −1, 1, 1, −1, −1,
1, −1, −1, −1, −1, −1, 1, 1, −1, 1, −1, 1, 1, −1, 1, −1, −1, −1, −1, −1, −1, 1, −1, −1, −1, −1, 1, 1, 1, −1,
1, 1, −1, −1, 1, −1, −1, −1, 1, 1, 1, −1, 1, −1, 1, −1, −1, −1, 1, −1, 1, −1, 1, −1, −1, −1, 1, −1, −1, 1,
−1, 1, 1, −1, −1, −1, 1, 1, −1, −1, −1, −1, 1, −1, 1, 1, −1, 1, −1, 1, 1, 1, 1, 1, 1, −1, −1, 1, −1, −1, −1, 1,
−1, 1, −1, −1, −1, 1, 1, 1, 1, 1, 1, −1, 1, −1, 1, 1, 1, −1, 1, −1, 1, 1, −1, 1, −1, −1, 1, 1, −1, −1, 1, 1, 1,
−1, −1, −1, 1, −1, −1, 1, 1, −1, −1, −1, 1, −1, 1, −1, −1, 1, 1, 1, 1, 1, −1, −1, −1, −1, 1, −1, 1, −1, 1, 1,
1, −1, 1, −1, −1, 1, −1, −1, −1, 1, 1, −1, −1, −1, 1, −1, −1, 1, −1, −1, −1, −1, 1, −1, 1, 1, −1, −1, −1, 1,
−1, −1, 0, 0, 0, 0, 0, −1, −1, 1, −1, 1, 1, 1, 1, 1, 1, −1, −1, −1, −1, 1, −1, −1, 1, −1, −1, −1, 1, 1, −1,
−1, −1, 1, −1, −1, 1, −1, 1, 1, 1, −1, 1, −1, 1, −1, −1, −1, −1, 1, 1, 1, 1, 1, −1, −1, 1, −1, 1, −1, −1, −1,
1, 1, −1, −1, 1, −1, −1, −1, 1, 1, 1, −1, −1, 1, 1, −1, −1, 1, −1, 1, 1, −1, 1, −1, 1, 1, 1, −1, 1, −1, 1, 1,
1, 1, 1, 1, −1, −1, −1, 1, −1, 1, −1, −1, −1, 1, −1, −1, 1, 1, 1, 1, 1, 1, −1, 1, −1, 1, 1, −1, 1, −1, −1, −1,
−1, 1, 1, −1, −1, −1, 1, 1, −1, 1, −1, −1, 1, −1, −1, −1, 1, −1, 1, −1, 1, −1, −1, −1, 1, −1, 1, −1, 1, 1, 1,
−1, −1, −1, 1, −1, −1, 1, 1, −1, 1, 1, 1, −1, −1, −1, −1, 1, −1, −1, −1, −1, −1, −1, 1, −1, 1, 1, −1, 1, −1,
1, 1, −1, −1, −1, −1, −1, 1, −1, −1, 1, 1, −1, −1, −1, 1, −1, −1, 1, −1, −1, 1, 1, −1, −1, 1, 1, 1, 1, −1,
−1, −1, −1, −1, 1, −1, −1, −1, −1, −1, 1, −1, 1, −1, 1, 1, −1, 1, 1, 1, 1, 1, −1, 1, 1, 1, −1, −1, 1, −1, 1,
−1, 1, 1, 1, 1, 1, −1, −1, −1, 1, 1, −1, −1, −1, −1, −1, −1, −1, −1, 1, 1, 1, 1, 1, −1, 1, −1, 1, −1, −1, 1, 1,
1, −1, 1, 1, 1, 1, 1, −1, 1, 1, −1, 1, −1, 1, −1, −1, −1, −1, −1, 1, −1, −1, −1, −1, −1, 1, 1, 1, 1, −1, −1,
1, 1, −1, −1, 1, −1, −1, 1, −1, −1, −1, 1, 1, −1, −1, 1, −1, −1, −1, −1, −1, 1, 1, −1, 1, −1, 1, 1, −1, 1,
−1, −1, −1, −1, −1, −1, 1, −1, −1, −1, −1, 1, 1, 1, −1, 1, 1, −1, −1, 1, −1, −1, −1, 1, 1, 1, −1, 1, −1, −1,
−1, 1, 1, −1, 1, 1, −1, 1, 1, 1, 1, 1, 1, 1, 1, −1, −1, −1, −1, 1, 1, −1, 1, −1, 1, −1, 1, −1, 1, −1, −1, 1,
−1, 1, −1, −1, −1, −1, −1, −1, 1, 1, −1, 1, 1, 1, −1, 1, −1, 1, 1, 1, −1, −1, −1, −1, −1, −1, 1, −1, 1, −1,
−1, −1, 1, −1, 1, −1, −1, 1, −1, 1, 1, −1, −1, 1, 1, −1, −1, −1, 1, 1, 1, −1, 1, 1, −1, −1, 1, 1, 1, −1, 1, −1,
1, 1, −1, −1, −1, −1, −1, 1, 1, 1, 1, −1, 1, −1, 1, −1, −1, −1, 1, −1, 1, 1, −1, 1, 1, 1, −1, −1, 1, 1, 1, −1,
1, 1, −1, 1, 1, 1, 1, −1].

The expression EHT−LTF_{4×}(−500: 500) means that values on tones whose sequence numbers are −500 to 500 are values in the EHT-LTF sequence successively. That is, it can be learned that components of the second sequence are all +1, 0, or −1, and distortion of the EHT-LTF sequence under BPSK modulation is small and a PAPR is low. Therefore, channel quality of a link under BPSK modulation can be accurately measured.

Optionally, with reference to the first aspect, the second aspect, the third aspect, or the fourth aspect, the first sequence meets the following formula:

$${s}_{i} = [ {a}_{0} , {c}_{i} , 0 , 0 , 0 , 0 , 0 , ( - 1 j ) * {a}_{1} ] .$$

The second sequence is the HE-LTF sequence, a₀ and a₁ are subsequences in the HE-LTF sequence, j is an imaginary unit, and i is an integer greater than or equal to 1 and less than or equal to 7.

$$\begin{matrix}{c}_{1} = [ 1 j , 1 j , 1 j , - 1 j , - 1 j , - 1 j , 1 j , 1 j , - 1 j ] . \\ {c}_{2} = [ - 1 , - 1 , - 1 , - 1 j , - 1 j , - 1 j , 1 j , 1 j , - 1 j ] . \\ {c}_{3} = [ - 1 , - 1 , - 1 , 1 , 1 , - 1 j , 1 j , 1 j , - 1 j ] . \\ {c}_{4} = [ - 1 , - 1 , - 1 , 1 , 1 , 1 , 1 j , 1 j , - 1 j ] . \\ {c}_{5} = [ - 1 , - 1 , - 1 , 1 , 1 , 1 , - 1 , 1 j , - 1 j ] . \\ {c}_{6} = [ - 1 , - 1 , - 1 , 1 , 1 , 1 , - 1 , - 1 , - 1 j ] . \\ {c}_{7} = [ - 1 , - 1 , - 1 , 1 , 1 , 1 , - 1 , - 1 , 1 ] .\end{matrix}$$

That is, in the foregoing technical solution, a sequence under QPSK modulation is implemented, so that channel quality of a communication link under QPSK modulation can be accurately measured when the channel quality of the communication link is measured by using the sequence.

Optionally, with reference to the first aspect, the second aspect, the third aspect, or the fourth aspect, the first sequence meets the following formula:

$${q}_{1} = \frac{2}{\sqrt{5}} {e}^{\frac{j π}{4}} {s}_{k 1} + \frac{1}{\sqrt{5}} {e}^{\frac{j π}{4}} {s}_{k 2} .$$

sₖ₁=[a₀, cₖ₁, 0,0,0,0,0, (−1j)*a₁]; sₖ₂=[a₀, cₖ₂, 0,0,0,0,0, (−1j)*a₁]; and the second sequence is the HE-LTF sequence, a₀ and a₁ are subsequences in the HE-LTF sequence, and j is an imaginary unit.

k1 is 1, and k2 is 7; or k1 is 4, and k2 is 5 or 6; or k1 is 5, and k2 is 1 or 2.

$$\begin{matrix}{c}_{1} = [ 1 j , 1 j , 1 j , - 1 j , - 1 j , - 1 j , 1 j , 1 j , - 1 j ] . \\ {c}_{2} = [ - 1 , - 1 , - 1 , - 1 j , - 1 j , - 1 j , 1 j , 1 j , - 1 j ] . \\ {c}_{4} = [ - 1 , - 1 , - 1 , 1 , 1 , 1 , 1 j , 1 j , - 1 j ] . \\ {c}_{5} = [ - 1 , - 1 , - 1 , 1 , 1 , 1 , - 1 , 1 j , - 1 j ] . \\ {c}_{6} = [ - 1 , - 1 , - 1 , 1 , 1 , 1 , - 1 , - 1 , - 1 j ] . \\ {c}_{7} = [ - 1 , - 1 , - 1 , 1 , 1 , 1 , - 1 , - 1 , 1 ] .\end{matrix}$$

That is, in the foregoing technical solution, a sequence under 16-QAM modulation is implemented, so that channel quality of a communication link under 16-QAM modulation can be accurately measured when the channel quality of the communication link is measured by using the sequence.

Optionally, with reference to the first aspect, the second aspect, the third aspect, or the fourth aspect, the first sequence meets the following formula:

$${q}_{2} = \frac{4}{\sqrt{21}} {e}^{\frac{j π}{4}} {s}_{k 3} + \frac{2}{\sqrt{21}} {e}^{\frac{j π}{4}} {s}_{k 4} + \frac{1}{\sqrt{21}} {e}^{\frac{j π}{4}} {s}_{k 5} .$$

sₖ₃=[a₀, cₖ₃, 0,0,0,0,0, (−1j)*a₁]; sₖ₄=[a₀, cₖ₄, 0,0,0,0,0, (−1j)*a₁]; sₖ₅=[a₀, cₖ₅, 0,0,0,0,0, (−1j)*a₁]; and the second sequence is the HE-LTF sequence, a₀ and a₁ are subsequences in the HE-LTF sequence, and j is an imaginary unit.

k3 is 1, k4 is 6, and k5 is 7; or k3 is 1, k4 is 7, and k5 is 5 or 6; or k3 is 2, k4 is 7, and k5 is 6 or 7; or k3 is 3, k4 is 5, and k5 is 6; or k3 is 3, k4 is 5, and k5 is 7; or k3 is 3, k4 is 6, and k5 is 5 or 6; or k3 is 3, k4 is 7, and k5 is 1, 2, 3, or 4; or k3 is 4, k4 is 4, and k5 is 7; or k3 is 4, k4 is 5, and k5 is 3, 4, or 5; or k3 is 4, k4 is 6, and k5 is 1, 2, 3, or 4; or k3 is 5, k4 is 1, and k5 is 3 or 4; or k3 is 5, k4 is 1, and k5 is 5; or k3 is 5, k4 is 2, and k5 is 4, 5, or 6; or k3 is 5, k4 is 3, and k5 is 1, 2, 3, or 4; or k3 is 5, k4 is 4, and k5 is 1 or 2; or k3 is 6, k4 is 1, and k5 is 1 or 2; or k3 is 6, k4 is 2, and k5 is 1, 2, or 3.

$${c}_{1} = [ 1 j , 1 j , 1 j , - 1 j , - 1 j , - 1 j , 1 j , 1 j , - 1 j ] .$$

$${c}_{2} = [ - 1 , - 1 , - 1 , - 1 j , - 1 j , - 1 j , 1 j , 1 j , - 1 j ] .$$

$${c}_{3} = [ - 1 , - 1 , - 1 , 1 , 1 , - 1 j , 1 j , 1 j , - 1 j ] .$$

$${c}_{4} = [ - 1 , - 1 , - 1 , 1 , 1 , 1 , 1 j , 1 j , - 1 j ] .$$

$${c}_{5} = [ - 1 , - 1 , - 1 , 1 , 1 , 1 , - 1 , 1 j , - 1 j ] .$$

$${c}_{6} = [ - 1 , - 1 , - 1 , 1 , 1 , 1 , - 1 , - 1 , - 1 j ] .$$

$${c}_{7} = [ - 1 , - 1 , - 1 , 1 , 1 , 1 , - 1 , - 1 , 1 ] .$$

That is, in the foregoing technical solution, a sequence under 64-QAM modulation is implemented, so that channel quality of a communication link under 64-QAM modulation can be accurately measured when the channel quality of the communication link is measured by using the sequence.

Optionally, with reference to the first aspect, the second aspect, the third aspect, or the fourth aspect, the first sequence meets the following formula:

$${q}_{3} = \frac{8}{\sqrt{85}} {e}^{\frac{j π}{4}} {s}_{k 6} + \frac{4}{\sqrt{85}} {e}^{\frac{j π}{4}} {s}_{k 7} + \frac{2}{\sqrt{85}} {e}^{\frac{j π}{4}} {s}_{k 8} + \frac{1}{\sqrt{85}} {e}^{\frac{j π}{4}} {s}_{k 9} .$$

sₖ₆=[a₀, cₖ₆, 0,0,0,0,0, (−1j)*a₁]; sₖ₇=[a₀, cₖ₇, 0,0,0,0,0, (−1j)*a₁]; sₖ₈=[a₀, cₖ₈, 0,0,0,0,0, (−1j)*a₁]; sₖ₉=[a₀, cₖ₉, 0,0,0,0,0, (−1j)*a₁]; and the second sequence is the HE-LTF sequence, a₀ and a₁ are subsequences in the HE-LTF sequence, and j is an imaginary unit.

k6 is 1, k7 is 7, k8 is 4, and k9 is 7; or k6 is 1, k7 is 7, k8 is 6, and k9 is 3; or k6 is 2, k7 is 7, k8 is 7, and k9 is 4; or k6 is 3, k7 is 5, k8 is 7, and k9 is 4; or k6 is 3, k7 is 6, k8 is 5, and k9 is 5; or k6 is 3, k7 is 7, k8 is 1, and k9 is 5; or k6 is 3, k7 is 7, k8 is 2, and k9 is 6; or k6 is 3, k7 is 7 , k8 is 3, and k9 is 4; or k6 is 4, k7 is 4, k8 is 6, and k9 is 7; or k6 is 4, k7 is 6, k8 is 1, and k9 is 6; or k6 is 4, k7 is 6, k8 is 4, and k9 is 3; or k6 is 5, k7 is 1, k8 is 1, and k9 is 7: or k6 is 5, k7 is 2, k8 is 6, and k9 is 2; or k6 is 5, k7 is 4, k8 is 1, and k9 is 1; or k6 is 5, k7 is 4, k8 is 2, and k9 is 3; or k6 is 6, k7 is 1, k8 is 1, and k9 is 1.

$${c}_{1} = [ 1 j , 1 j , 1 j , - 1 j , - 1 j , - 1 j , 1 j , 1 j , - 1 j ] .$$

$${c}_{2} = [ - 1 , - 1 , - 1 , - 1 j , - 1 j , - 1 j , 1 j , 1 j , - 1 j ] .$$

$${c}_{3} = [ - 1 , - 1 , - 1 , 1 , 1 , - 1 j , 1 j , 1 j , - 1 j ] .$$

$${c}_{4} = [ - 1 , - 1 , - 1 , 1 , 1 , 1 , 1 j , 1 j , - 1 j ] .$$

$${c}_{5} = [ - 1 , - 1 , - 1 , 1 , 1 , 1 , - 1 , 1 j , - 1 j ] .$$

$${c}_{6} = [ - 1 , - 1 , - 1 , 1 , 1 , 1 , - 1 , - 1 , - 1 j ] .$$

$${c}_{7} = [ - 1 , - 1 , - 1 , 1 , 1 , 1 , - 1 , - 1 , 1 ] .$$

That is, in the foregoing technical solution, a sequence under 256-QAM modulation is implemented, so that channel quality of a communication link under 256-QAM modulation can be accurately measured when the channel quality of the communication link is measured by using the sequence.

Optionally, with reference to the first aspect, the second aspect, the third aspect, or the fourth aspect, the first sequence meets the following formula:

$${q}_{4} = \frac{16}{\sqrt{341}} {e}^{\frac{j π}{4}} {s}_{k 10} + \frac{8}{\sqrt{341}} {e}^{\frac{j π}{4}} {s}_{k 11} + \frac{4}{\sqrt{341}} {e}^{\frac{j π}{4}} {s}_{k 12} + \frac{2}{\sqrt{341}} {e}^{\frac{j π}{4}} {s}_{k 13} + \frac{1}{\sqrt{345}} {e}^{\frac{j π}{4}} {s}_{k 14} .$$

sₖ₁₀=[a₀, cₖ₁₀, 0,0,0,0,0, (−1j)*a₁]; sₖ₁₁=[a₀, cₖ₁₁, 0,0,0,0,0, (−1j)*a₁]; sₖ₁₂=[a₀, cₖ₁₂, 0,0,0,0,0, (−1j)*a₁]; sₖ₁₃=[a₀, cₖ₁₃, 0,0,0,0,0, (−1j)*a₁]; sₖ₁₄=[a₀, cₖ₁₄, 0,0,0,0,0, (−1j)*a₁]; and the second sequence is the HE-LTF sequence, a₀ and a₁ are subsequences in the HE-LTF sequence, and j is an imaginary unit.

k10 is 1, k11 is 7, k12 is 6, k13 is 1, and k14 is 5; or k10 is 2, k11 is 7, k12 is 5, k13 is 7, and k14 is 5; or k10 is 6, k11 is 1, k12 is 2, k13 is 4, and k14 is 4; or k10 is 4, k11 is 6, k12 is 4, k13 is 1, and k14 is 6; or k10 is 6, k11 is 2, k12 is 1, k13 is 4, and k14 is 5; or k10 is 3, k11 is 6, k12 is 7, k13 is 1, and k14 is 2; or k10 is 5, k11 is 3, k12 is 1, k13 is 6, and k14 is 1; or k10 is 4, k11 is 6, k12 is 2, k13 is 6, and k14 is 6.

$${c}_{1} = [ 1 j , 1 j , 1 j , - 1 j , - 1 j , - 1 j , 1 j , 1 j , - 1 j ] .$$

$${c}_{2} = [ - 1 , - 1 , - 1 , - 1 j , - 1 j , - 1 j , 1 j , 1 j , - 1 j ] .$$

$${c}_{3} = [ - 1 , - 1 , - 1 , 1 , 1 , - 1 j , 1 j , 1 j , - 1 j ] .$$

$${c}_{4} = [ - 1 , - 1 , - 1 , 1 , 1 , 1 , 1 j , 1 j , - 1 j ] .$$

$${c}_{5} = [ - 1 , - 1 , - 1 , 1 , 1 , 1 , - 1 , 1 j , - 1 j ] .$$

$${c}_{6} = [ - 1 , - 1 , - 1 , 1 , 1 , 1 , - 1 , - 1 , - 1 j ] .$$

$${c}_{7} = [ - 1 , - 1 , - 1 , 1 , 1 , 1 , - 1 , - 1 , 1 ] .$$

That is, in the foregoing technical solution, a sequence under 1024-QAM modulation is implemented, so that channel quality of a communication link under 1024-QAM modulation can be accurately measured when the channel quality of the communication link is measured by using the sequence.

Optionally, with reference to the first aspect, the second aspect, the third aspect, or the fourth aspect, the first sequence meets the following formula:

$${q}_{5} = \frac{16}{\sqrt{1365}} {e}^{\frac{j π}{4}} {s}_{k 15} + \frac{16}{\sqrt{1365}} {e}^{\frac{j π}{4}} {s}_{k 16} + \frac{8}{\sqrt{1365}} {e}^{\frac{j π}{4}} {s}_{k 17} + \frac{4}{\sqrt{1365}} {e}^{\frac{j π}{4}} {s}_{k 18} + \frac{2}{\sqrt{1365}} {e}^{\frac{j π}{4}} {s}_{k 19} + \frac{1}{\sqrt{1365}} {e}^{\frac{j π}{4}} {s}_{k 20} .$$

sₖ₁₅=[a₀, cₖ₁₅, 0,0,0,0,0, (−1j)*a₁]; sₖ₁₆=[a₀, cₖ₁₆, 0,0,0,0,0, (−1j)*a₁]; sₖ₁₇=[a₀, cₖ₁₇, 0,0,0,0,0, (−1j)*a₁]; sₖ₁₈=[a₀, cₖ₁₈, 0,0,0,0,0, (−1j)*a₁]; sₖ₁₉=[a₀, cₖ₁₉, 0,0,0,0,0, (−1j)*a₁]; sₖ₂₀=[a₀, cₖ₂₀, 0,0,0,0,0, (−1j)*a₁]; and the second sequence is the HE-LTF sequence, a₀, and a₁are subsequences in the HE-LTF sequence, and j is an imaginary unit.

k15 is 5, k16 is 2, k17 is 4, k18 is 7, k19 is 2, and k20 is 5; or k15 is 5, k16 is 2, k17 is 5, k18 is 1, k19 is 7, and k20 is 2; or k15 is 6, k16 is 2, k17 is 2, k18 is 3, k19 is 7, and k20 is 5; or k15 is 3, k16 is 6, k17 is 6, k18 is 4, k19 is 5, and k20 is 4; or k15 is 4, k16 is 7, k17 is 2, k18 is 2, k19 is 3, and k20 is 2; or k15 is 6, k16 is 1, k17 is 2, k18 is 3, k19 is 5, and k20 is 4; or k15 is 2, k16 is 7, k17 is 7, k18 is 3, k19 is 6, and k20 is 3; or k15 is 1, k16 is 7, k17 is 5, k18 is 5, k19 is 4, and k20 is 2.

$${c}_{1} = [ 1 j , 1 j , 1 j , - 1 j , - 1 j , - 1 j , 1 j , 1 j , - 1 j ] .$$

$${c}_{2} = [ - 1 , - 1 , - 1 , - 1 j , - 1 j , - 1 j , 1 j , 1 j , - 1 j ] .$$

$${c}_{3} = [ - 1 , - 1 , - 1 , 1 , 1 , - 1 j , 1 j , 1 j , - 1 j ] .$$

$${c}_{4} = [ - 1 , - 1 , - 1 , 1 , 1 , 1 , 1 j , 1 j , - 1 j ] .$$

$${c}_{5} = [ - 1 , - 1 , - 1 , 1 , 1 , 1 , - 1 , 1 j , - 1 j ] .$$

$${c}_{6} = [ - 1 , - 1 , - 1 , 1 , 1 , 1 , - 1 , - 1 , - 1 j ] .$$

$${c}_{7} = [ - 1 , - 1 , - 1 , 1 , 1 , 1 , - 1 , - 1 , 1 ] .$$

That is, in the foregoing technical solution, a sequence under 4096-QAM modulation is implemented, so that channel quality of a communication link under 4096-QAM modulation can be accurately measured when the channel quality of the communication link is measured by using the sequence.

Optionally, with reference to the first aspect, the second aspect, the third aspect, or the fourth aspect, a₀, is one of the first to 489^{th} elements in the HE-LTF sequence, and a₁ is one of the 504^{th} to 1001^{st} elements in the HE-LTF sequence. That is, the first sequence is generated based on the HE-LTF sequence in the 4× mode at an 80 MHz bandwidth in 802.11ax, so that the PAPR of the first sequence is low.

Optionally, with reference to the first aspect, the second aspect, the third aspect, or the fourth aspect, the first sequence meets the following formula:

pᵤ=[b₀, dᵤ, 0,0,0,0,0, (−1j)*b₁].

The second sequence is the EHT-LTF sequence, b₀ and b₁ are subsequences in the EHT-LTF sequence, j is an imaginary unit, and u is an integer greater than or equal to 1 and less than or equal to 5.

$${d}_{1} = [ 1 j , 1 j , 1 j , - 1 j , 1 j , 1 j ] .$$

$${d}_{2} = [ - 1 , 1 j , 1 j , - 1 j , 1 j , 1 j ] .$$

$${d}_{3} = [ - 1 , - 1 , - 1 , - 1 j , 1 j , 1 j ] .$$

$${d}_{4} = [ - 1 , - 1 , - 1 , 1 , - 1 , 1 j ] .$$

$${d}_{5} = [ - 1 , - 1 , - 1 , 1 , - 1 , - 1 ] .$$

That is, in the foregoing technical solution, a sequence under QPSK modulation is implemented, so that channel quality of a communication link under QPSK modulation can be accurately measured when the channel quality of the communication link is measured by using the sequence.

Optionally, with reference to the first aspect, the second aspect, the third aspect, or the fourth aspect, the first sequence meets the following formula:

$${q}_{6} = \frac{2}{\sqrt{5}} {e}^{\frac{j π}{4}} {p}_{t 1} + \frac{1}{\sqrt{5}} {e}^{\frac{j π}{4}} {p}_{t 2} .$$

pₜ₁=[b₀, dₜ₁, 0,0,0,0,0, (−1j)*b₁]: pₜ₂=[b₀, dₜ₂, 0,0,0,0,0, (−1j)*b₁]; and the second sequence is the EHT-LTF sequence, b₀ and b₁ are subsequences in the EHT-LTF sequence, and j is an imaginary unit.

t1 is 5, and t2 is 1, 2, 3, 4, or 5; or t1 is 1, and t2 is 5; or t1 is 4, and t2 is 5.

$${d}_{1} = [ 1 j , 1 j , 1 j , - 1 j , 1 j , 1 j ] .$$

$${d}_{2} = [ - 1 , 1 j , 1 j , - 1 j , 1 j , 1 j ] .$$

$${d}_{3} = [ - 1 , - 1 , - 1 , - 1 j , 1 j , 1 j ] .$$

$${d}_{4} = [ - 1 , - 1 , - 1 , 1 , - 1 , 1 j ] .$$

$${d}_{5} = [ - 1 , - 1 , - 1 , 1 , - 1 , - 1 ] .$$

That is, in the foregoing technical solution, a sequence under 16-QAM modulation is implemented, so that channel quality of a communication link under 16-QAM modulation can be accurately measured when the channel quality of the communication link is measured by using the sequence.

Optionally, with reference to the first aspect, the second aspect, the third aspect, or the fourth aspect, the first sequence meets the following formula:

$${q}_{7} = \frac{4}{\sqrt{21}} {e}^{\frac{j π}{4}} {p}_{t 3} + \frac{2}{\sqrt{21}} {e}^{\frac{j π}{4}} {p}_{t 4} + \frac{1}{\sqrt{21}} {e}^{\frac{j π}{4}} {p}_{t 5} .$$

pₜ₃=[b₀, dₜ₃, 0,0,0,0,0, (−1j)*b₁]; pₜ₄=[b₀, dₜ₄, 0,0,0,0,0, (−1j)*b₁]; pₜ₅=[b₀, dₜ₅, 0,0,0,0,0, (−1j)*b₁]; and the second sequence is the EHT-LTF sequence, b₀ and b₁ are subsequences in the EHT-LTF sequence, and j is an imaginary unit.

t3 is 5, t4 is 5, and t5 is 1, 2, 3, 4, or 5; or t3 is 5, t4 is 1, and t5 is 5; or t3 is 5, t4 is 1, and t5 is 1.

$${d}_{1} = [ 1 j , 1 j , 1 j , - 1 j , 1 j , 1 j ] .$$

$${d}_{2} = [ - 1 , 1 j , 1 j , - 1 j , 1 j , 1 j ] .$$

$${d}_{3} = [ - 1 , - 1 , - 1 , - 1 j , 1 j , 1 j ] .$$

$${d}_{4} = [ - 1 , - 1 , - 1 , 1 , - 1 , 1 j ] .$$

$${d}_{5} = [ - 1 , - 1 , - 1 , 1 , - 1 , - 1 ] .$$

That is, in the foregoing technical solution, a sequence under 64-QAM modulation is implemented, so that channel quality of a communication link under 64-QAM modulation can be accurately measured when the channel quality of the communication link is measured by using the sequence.

Optionally, with reference to the first aspect, the second aspect, the third aspect, or the fourth aspect, the first sequence meets the following formula:

$${q}_{8} = \frac{8}{\sqrt{85}} {e}^{\frac{j π}{4}} {p}_{t 6} + \frac{4}{\sqrt{85}} {e}^{\frac{j π}{4}} {p}_{t 7} + \frac{2}{\sqrt{85}} {e}^{\frac{j π}{4}} {p}_{t 8} + \frac{1}{\sqrt{85}} {e}^{\frac{j π}{4}} {p}_{t 9} .$$

pₜ₆=[b₀, dₜ₆, 0,0,0,0,0, (−1j)*b₁]; pₜ₇=[b₀, dₜ₇, 0,0,0,0,0, (−1j)*b₁]; pₜ₈=[b₀, dₜ₈, 0,0,0,0,0, (−1j)*b₁]; pₜ₉=[b₀, dₜ₉, 0,0,0,0,0, (−1j)*b₁]; and the second sequence is the EHT-LTF sequence, b₀ and b₁ are subsequences in the EHT-LTF sequence, and j is an imaginary unit.

t6 is 5, t7 is 5, and t8 is 5, and t9 is 1, 2, 3, or 4; or t6 is 5, t7 is 5, t8 is 1, and t9 is 1, 4, or 5; or t6 is 5, t7 is 1, t8 is 5, and t9 is 5.

$${d}_{1} = [ 1 j , 1 j , 1 j , - 1 j , 1 j , 1 j ] .$$

$${d}_{2} = [ - 1 , 1 j , 1 j , - 1 j , 1 j , 1 j ] .$$

$${d}_{3} = [ - 1 , - 1 , - 1 , - 1 j , 1 j , 1 j ] .$$

$${d}_{4} = [ - 1 , - 1 , - 1 , 1 , - 1 , 1 j ] .$$

$${d}_{5} = [ - 1 , - 1 , - 1 , 1 , - 1 , - 1 ] .$$

That is, in the foregoing technical solution, a sequence under 256-QAM modulation is implemented, so that channel quality of a communication link under 256-QAM modulation can be accurately measured when the channel quality of the communication link is measured by using the sequence.

Optionally, with reference to the first aspect, the second aspect, the third aspect, or the fourth aspect, the first sequence meets the following formula:

$${q}_{9} = \frac{16}{\sqrt{341}} {e}^{\frac{j π}{4}} {p}_{t 10} + \frac{8}{\sqrt{341}} {e}^{\frac{j π}{4}} {p}_{t 11} + \frac{4}{\sqrt{341}} {e}^{\frac{j π}{4}} {p}_{t 12} + \frac{2}{\sqrt{341}} {e}^{\frac{j π}{4}} {p}_{t 13} + \frac{1}{\sqrt{345}} {e}^{\frac{j π}{4}} {p}_{t 14} .$$

pₜ₁₀=[b₀, dₜ₁₀, 0,0,0,0,0, (−1j)*b₁]; pₜ₁₁=[b₀, dₜ₁₁, 0,0,0,0,0, (−1j)*b₁]; pₜ₁₂=[b₀, dₜ₁₂, 0,0,0,0,0, (−1j)*b₁]; pₜ₁₃=[b₀, dₜ₁₃, 0,0,0,0,0, (−1j)*b₁]; pₜ₁₄=[b₀, dₜ₁₄, 0,0,0,0,0, (−1j)*b₁]; and the second sequence is the EHT-LTF sequence, b₀ and b₁ are subsequences in the EHT-LTF sequence, and j is an imaginary unit.

t10 is 5, t11 is 5, t12 is 5, t13 is 1, and t14 is 2 or 4; or t10 is 5, t11 is 5, t12 is 5, t13 is 4, and t14 is 1 or 5; or t10 is 5, t11 is 5, t12 is 1, t13 is 5, and t14 is 1 or 5; or t10 is 5, t11 is 5, t12 is 1, t13 is 5, and t14 is 5; or t10 is 5, t11 is 5, t12 is 5, t13 is 2, and t14 is 5; or t10 is 5, t11 is 5, t12 is 5, t13 is 1, and t14 is 3.

$${d}_{1} = [ 1 j , 1 j , 1 j , - 1 j , 1 j , 1 j ]$$

$${d}_{2} = [ - 1 , 1 j , 1 j , - 1 j , 1 j , 1 j ] .$$

$${d}_{3} = [ - 1 , - 1 , - 1 , - 1 j , 1 j , 1 j ] .$$

$${d}_{4} = [ - 1 , - 1 , - 1 , 1 , - 1 , 1 j ] .$$

$${d}_{5} = [ - 1 , - 1 , - 1 , 1 , - 1 , - 1 ] .$$

That is, in the foregoing technical solution, a sequence under 1024-QAM modulation is implemented, so that channel quality of a communication link under 1024-QAM modulation can be accurately measured when the channel quality of the communication link is measured by using the sequence.

Optionally, with reference to the first aspect, the second aspect, the third aspect, or the fourth aspect, the first sequence meets the following formula:

$${q}_{10} = \frac{16}{\sqrt{1365}} {e}^{\frac{j π}{4}} {p}_{t 15} + \frac{16}{\sqrt{1365}} {e}^{\frac{j π}{4}} {p}_{t 16} + \frac{8}{\sqrt{1365}} {e}^{\frac{j π}{4}} {p}_{t 17} + \frac{4}{\sqrt{1365}} {e}^{\frac{j π}{4}} {p}_{t 18} + \frac{2}{\sqrt{1365}} {e}^{\frac{j π}{4}} {p}_{t 19} + \frac{1}{\sqrt{1365}} {e}^{\frac{j π}{4}} {p}_{t 20} .$$

pₜ₁₅=[b₀, dₜ₁₅, 0,0,0,0,0, (−1j)*b₁]; pₜ₁₆=[b₀, dₜ₁₆, 0,0,0,0,0, (−1j)*b₁]; pₜ₁₇=[b₀, dₜ₁₇, 0,0,0,0,0, (−1j)*b₁]; pₜ₁₈=[b₀, dₜ₁₈, 0,0,0,0,0, (−1j)*b₁]; pₜ₁₉=[b₀, dₜ₁₉, 0,0,0,0,0, (−1j)*b₁]; pₜ₂₀=[b₀, dₜ₂₀, 0,0,0,0,0, (−1j)*b₁]; and the second sequence is the EHT-LTF sequence, b₀ and b₁ are subsequences in the EHT-LTF sequence, and j is an imaginary unit.

t15 is 5, t16 is 5, t17 is 5, t18 is 1, t19 is 2, and t20 is 5; or t15 is 5, t16 is 5, t17 is 5, t18 is 1, t19 is 1, and t20 is 3; or t15 is 5, t16 is 5, t17 is 1, t18 is 5, t19 is 5, and t20 is 1; or t15 is 5, t16 is 5, t17 is 5, t18 is 5, t19 is 3, and t20 is 3; or t15 is 5, t16 is 5, t17 is 5, t18 is 1, t19 is 1, and t20 is 2; or t15 is 5, t16 is 5, t17 is 5, t18 is 1, t19 is 4, and t20 is 1; or t15 is 5, t16 is 5, t17 is 5, t18 is 4, t19 is 5, and t20 is 1; or t15 is 5, t16 is 5, t17 is 5, t18 is 1, t19 is 4, and t20 is 5.

$${d}_{1} = [ 1 j , 1 j , 1 j , - 1 j , 1 j , 1 j ] .$$

$${d}_{2} = [ - 1 , 1 j , 1 j , - 1 j , 1 j , 1 j ] .$$

$${d}_{3} = [ - 1 , - 1 , - 1 , - 1 j , 1 j , 1 j ] .$$

$${d}_{4} = [ - 1 , - 1 , - 1 , 1 , - 1 , 1 j ] .$$

$${d}_{5} = [ - 1 , - 1 , - 1 , 1 , - 1 , - 1 ] .$$

That is, in the foregoing technical solution, a sequence under 4096-QAM modulation is implemented, so that channel quality of a communication link under 4096-QAM modulation can be accurately measured when the channel quality of the communication link is measured by using the sequence.

Optionally, with reference to the first aspect, the second aspect, the third aspect, or the fourth aspect, b₀ is one of the first to 492^{nd} elements in the EHT-LTF sequence, and b₁ is one of the 504^{th} to 1001^{st} elements in the EHT-LTF sequence. That is, the first sequence is generated based on the EHT-LTF sequence in the 4× mode at an 80 MHz bandwidth in 802.11be, so that the PAPR of the first sequence is low.

According to a fifth aspect, a chip is provided. The chip includes at least one logic circuit and an input/output interface. The logic circuit is configured to read and execute stored instructions. When the instructions are run, the chip is enabled to perform the method according to either the first aspect or the second aspect.

According to a sixth aspect, a computer-readable storage medium is provided. The computer-readable storage medium stores a computer program. The computer program includes program instructions, and when the program instructions are executed by a computer, the computer is enabled to perform the method according to either the first aspect or the second aspect.

According to a seventh aspect, a communication apparatus is provided, including a processor and a transceiver. The processor is configured to support the communication apparatus in performing a corresponding function in the method in the first aspect or the second aspect. The transceiver is configured to support communication between the communication apparatus and another communication apparatus other than the communication apparatus. The communication apparatus may further include a memory. The memory is configured to be coupled to the processor, and the memory stores program instructions and data for the communication apparatus. The transceiver may be integrated into the communication apparatus or independent of the communication apparatus. This is not limited herein.

According to an eighth aspect, a computer program product including instructions is provided. When the computer program product is run on a computer, the computer is enabled to perform the method according to either the first aspect or the second aspect.

According to a ninth aspect, a communication system is provided, including the first device and/or the second device described above.

### BRIEF DESCRIPTION OF DRAWINGS

The following briefly describes accompanying drawings used in describing embodiments.

FIG. 1 is a schematic diagram of an 80 MHz tone plan in 802.11ax according to an embodiment of this application;

FIG. 2 is a schematic diagram of a frame structure of a sounding frame according to an embodiment of this application;

FIG. 3 is a schematic diagram of an 80 MHz tone plan in 802.11be according to an embodiment of this application;

FIG. 4 is a diagram of a network architecture of a wireless local area network (WLAN) according to an embodiment of this application;

FIG. 5 is a schematic diagram of a hardware structure of a communication apparatus that may be used in an embodiment of this application;

FIG. 6 is a schematic flowchart of a sounding frame transmission method according to an embodiment of this application;

FIG. 7 is a schematic diagram of a frame structure of a sounding frame according to an embodiment of this application; and

FIG. 8 is a schematic diagram of a structure of a communication apparatus according to an embodiment of this application.

### DESCRIPTION OF EMBODIMENTS

The following describes technical solutions in embodiments of this application with reference to accompanying drawings in embodiments of this application. The terms “system” and “network” may be used interchangeably in embodiments of this application. Unless otherwise specified, “/” represents an “or” relationship between associated objects. For example, A/B may represent A or B. The term “and/or” in this application is merely an association relationship for describing associated objects, and represents that three relationships may exist. For example, A and/or B may represent the following three cases: Only A exists, both A and B exist, and only B exists, where A and B may be singular or plural. In addition, in descriptions of this application, unless otherwise specified, “a plurality of” means two or more than two. “At least one of the following” or similar expressions thereof refer to any combination of these items, including any combination of single items or a plurality of items. For example, at least one of a, b, or c may represent a, b, c, a and b, a and c, b and c, or a, b, and c, where a, b, and c may be singular or plural. In addition, to clearly describe technical solutions in embodiments of this application, terms such as “first” and “second” are used in embodiments of this application to distinguish between same items or similar items that have basically same network elements or purposes. A person skilled in the art may understand that the terms such as “first” and “second” do not limit a quantity or an execution sequence, and the terms such as “first” and “second” do not indicate a definite difference.

Reference to “an embodiment”, “some embodiments”, or the like described in embodiments of this application indicates that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily refer to a same embodiment. Instead, the statements mean “one or more but not all of embodiments”, unless otherwise specifically emphasized in another manner. The terms “include”, “comprise”, “have”, and their variants mean “including but not limited to” unless especially emphasized otherwise.

The objectives, technical solutions, and beneficial effects of this application are further described in detail in the following examples. It should be understood that the following descriptions are merely examples of this application, but are not intended to limit the protection scope of this application. Any modification, equivalent replacement, or improvement made based on technical solutions of this application shall fall within the protection scope of this application.

In various embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

The following explains and describes some nouns (or communication terms) in this application.

### 1. 802.11ax Tone Plan

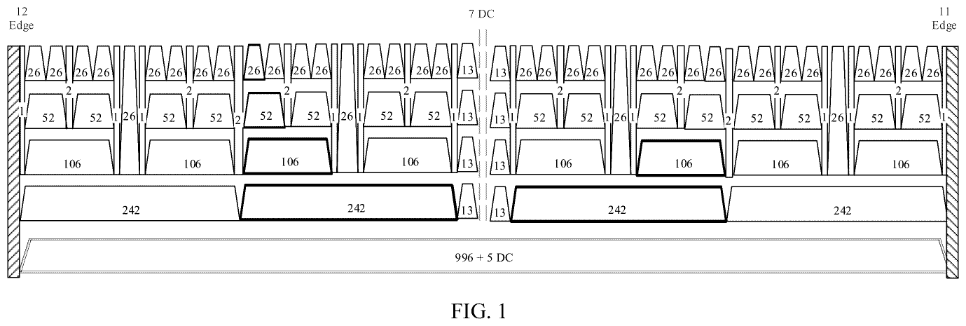

It should be noted that, in this solution, a high efficiency long training field (HE-LTF) sequence at an 80 MHz bandwidth in 802.11ax is modified. Therefore, an 80 MHz tone plan in 802.11ax is described herein. FIG. 1 is a schematic diagram of an 80 MHz tone plan in 802.11ax according to an embodiment of this application. FIG. 1 shows an 80 MHz tone design in 802.11ax. As shown in FIG. 1, the 80 MHz bandwidth of 802.11ax includes 36 resource units (RUs) 26, or includes 16 RU52s, or includes eight RU106s, or includes four RU242s, or includes one RU996 and five direct current tones. There is no gap between a first RU242 and a second RU242. There are seven direct current tones/null tones between the second RU242 and a third RU242. There is also no gap between the third RU242 and a fourth RU242. It may be understood that an RU26 may be a resource unit including 26 consecutive tones. That is, the RU26 includes 24 data tones and two pilot tones. Similarly, an RU52 may be a resource unit including 52 consecutive tones. That is, the RU52 includes 48 data tones and four pilot pilot tones. An RU106 may be a resource unit including 106 consecutive tones. That is, the RU106 includes 24 data tones and two pilot pilot tones. An RU242 may be a resource unit including 242 consecutive tones. That is, the RU242 includes 234 data tones and eight pilot pilot tones. An RU484 may be a resource unit including 484 consecutive tones. That is, the RU484 includes 468 data tones and 16 pilot pilot tones. An RU996 may be a resource unit including 996 consecutive tones. That is, the RU996 includes 980 data tones and 16 pilot tones.

Based on the 80 MHz tone design shown in FIG. 1, an HE-LTF sequence used for channel estimation is specified in 802.11ax, and a corresponding sounding frame format is defined.

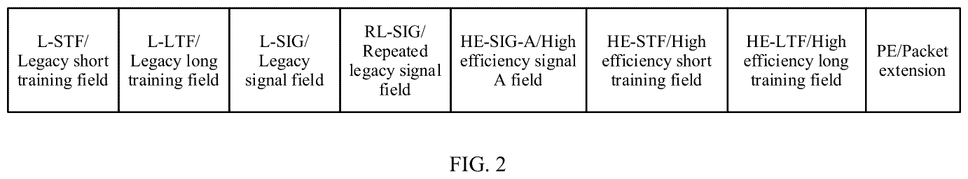

FIG. 2 is a schematic diagram of a frame structure of a sounding frame according to an embodiment of this application. As shown in FIG. 2, the sounding frame includes a legacy short training field (L-STF), a legacy long training field (L-LTF), a legacy signal field (L-SIG), a repeated legacy signal field (RL-SIG), a high efficiency signal A field (HE-SIG-A), a high efficiency short training field (HE-STF), a high efficiency long training field (HE-LTF), and a packet extension (PE) field.

In FIG. 2, the HE-LTF field included in the sounding frame is a high efficiency long training field used for multiple-input multiple-output (MIMO) channel estimation. The field may include one or more HE-LTF symbols, and each symbol is an orthogonal frequency division multiple access (OFDMA) symbol.

Two modes, namely, a 2× mode and a 4× mode are used in the HE-LTF sequence used for channel estimation in an 802.11ax system. Because this application relates to only the 4× mode, the 4× mode is described herein. It may be understood that the 4× mode in the 802.11ax system means that a tone index to which the HE-LTF sequence is mapped is the same as a sequence number of a tone in a tone plan of a data portion.

### 2. 802.11be Tone Plan

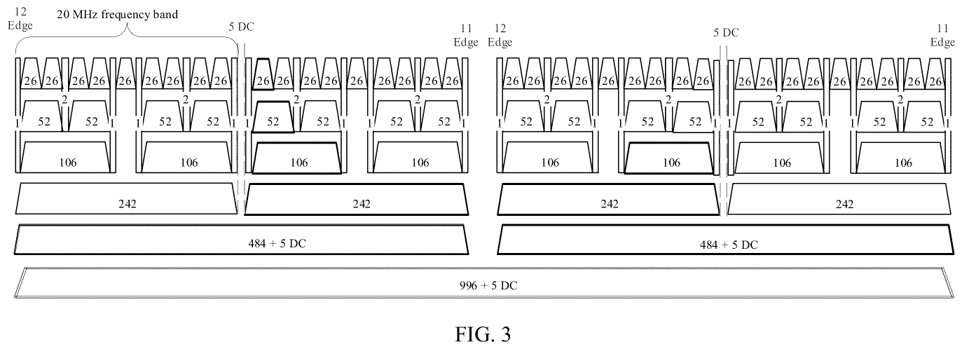

It should be noted that, in this solution, an EHT-LTF sequence at an 80 MHz bandwidth in 802.11be is modified. Therefore, an 80 MHz tone plan in 802.11be is described herein. FIG. 3 is a schematic diagram of an 80 MHz tone plan in 802.11be according to an embodiment of this application. FIG. 3 shows an 80 MHz tone design in 802.11be. As shown in FIG. 3, the 80 MHz bandwidth of 802.11be includes 36 RU26s, or includes 16 RU52s, or includes eight RU106s, or includes four RU242s, or includes two RU484s and five direct current tones/null tones, or includes one RU996 and five direct current tones. There are five direct current tones between a first RU242 and a second RU242. There are also five direct current tones between a third RU242 and a fourth RU242.

It should be noted that, for a case of a tone plan at a larger bandwidth, for example, 160 MHz or 320 MHz, the tone plan may be obtained after the 80 MHz tone plan is replicated and phase-rotated. This is not limited herein.

### 3. 4× Mode

A 4× mode in an 802.11ax system may mean that a tone index to which an HE-LTF sequence is mapped is the same as a sequence number of a tone in a tone plan of a data portion. A 4× mode in an 802.11be system may mean that a tone index to which an EHT-LTF sequence is mapped is the same as a sequence number of a tone in a tone plan of a data portion.

The foregoing content briefly describes meanings of nouns (communication terms) in embodiments of this application to better understand the technical solutions provided in embodiments of this application, and does not constitute a limitation on the technical solutions provided in embodiments of this application.

It should be understood that embodiments of this application may be applied to a wireless local area network (WLAN) scenario, and may be applied to an IEEE 802.11 system standard, for example, 802.11ax, 802.11be, or a next-generation standard. Alternatively, embodiments of this application may be applied to a WLAN system, for example, an internet of things (IoT) network or a vehicle-to-everything (V2X) network. Certainly, embodiments of this application may be further applied to another communication system, for example, an LTE system, an LTE frequency division duplex (FDD) system, an LTE time division duplex (TDD) system, a universal mobile telecommunication system (UMTS), a worldwide interoperability for microwave access (WiMAX) communication system, and a future 6G communication system.

The following uses an example in which embodiments of this application are applicable to a WLAN scenario. It should be understood that the WLAN starts from the 802.11a/g standard, and develops to 802.11n, 802.11ac, 802.11ax, and 802.11be that is currently being discussed. 802.11n may also be referred to as high throughput (HT). 802.11ac may also be referred to as very high throughput (VHT). 802.11ax may also be referred to as high efficiency (HE) or Wi-Fi 6. 802.11be may also be referred to as extremely high throughput (EHT) or (Wi-Fi 7). Standards before HT, such as 802.11a/b/g, are collectively referred to as non-high throughput (Non-HT).

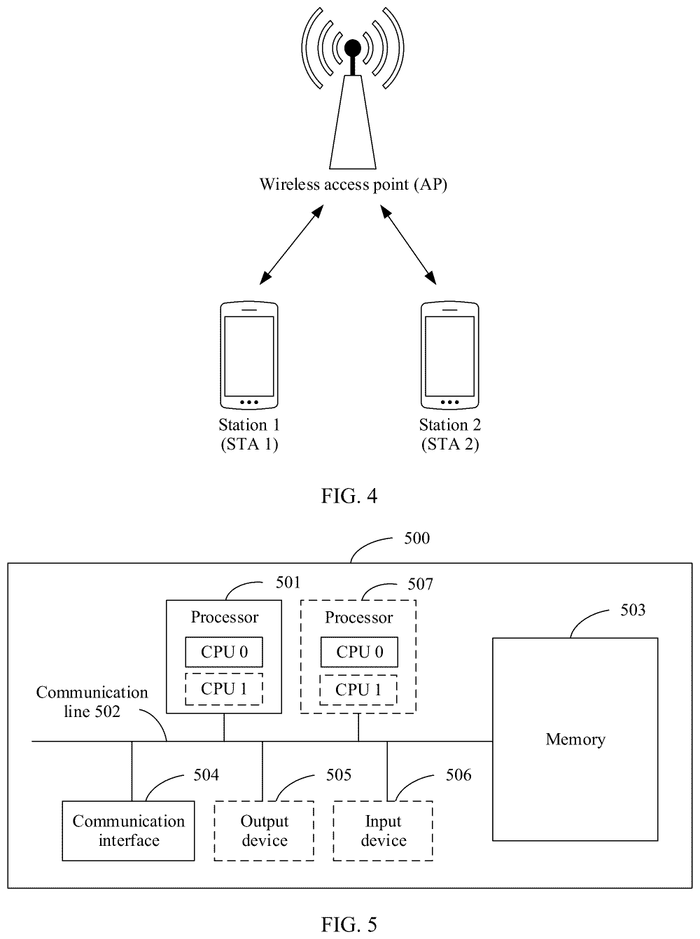

FIG. 4 is a diagram of a network architecture of a WLAN according to an embodiment of this application. In FIG. 4, an example in which the WLAN includes one wireless access point (AP) and two stations (STAs) is used. A STA associated with an AP can receive a radio frame sent by the AP, and can also send a radio frame to the AP. In addition, embodiments of this application are also applicable to communication between APs. For example, the APs may communicate with each other by using a distributed system (DS). Embodiments of this application are also applicable to communication between STAs. It should be understood that quantities of APs and STAs in FIG. 4 are merely an example. There may be more or less APs and STAs.

The access point may be an access point used by a terminal device (such as a mobile phone) to access a wired (or wireless) network, and is mainly deployed at home, in a building, and in a park. A typical coverage radius is tens of meters to hundreds of meters. Certainly, the access point may alternatively be deployed outdoors. The access point is equivalent to a bridge that connects the wired network and the wireless network. A main function of the access point is to connect various wireless network clients together and then connect the wireless network to the Ethernet. For example, the access point may be a terminal device (for example, a mobile phone) or a network device (for example, a router) with a Wi-Fi chip. The access point may be a device that supports the 802.11be standard. Alternatively, the access point may be a device that supports a plurality of wireless local area network (WLAN) standards of the 802.11 family such as 802.11ax, 802.11ac, 802.11n, 802.11g, 802.11b, 802.11a, and the 802.11be next-generation. The access point in this application may be a high efficiency (HE) AP, an extremely high throughput (EHT) AP, or an access point applicable to a future generation Wi-Fi standard.

The STA in this embodiment of this application may be various user terminals, user apparatuses, access apparatuses, subscriber stations, subscriber units, mobile stations, user agents, user devices, or other names that have a wireless communication function. The user terminal may include various handheld devices, vehicle-mounted devices, wearable devices, computing devices, or other processing devices connected to a wireless modem that have a wireless communication function; and various forms of user equipment (UE), mobile stations (MS's), terminals, terminal equipment, portable communication devices, handheld devices, portable computing devices, entertainment devices, game devices or systems, global positioning system devices, any other suitable device configured to perform network communication through a wireless medium, or the like. For example, the STA may be a router, a switch, a bridge, or the like. Herein, for ease of description, the devices mentioned above are collectively referred to as a station or a STA.

The AP and the STA in embodiments of this application may be an AP and a STA that are applicable to an IEEE 802.11 system standard. The AP is an apparatus that is deployed in a wireless communication network and that provides a wireless communication function for a STA associated with the AP. The AP may be used as a center of the communication system, and is usually a network-side product that supports MAC and PHY in the 802.11 system standard, for example, may be a communication device such as a base station, a router, a gateway, a repeater, a communication server, a switch, or a bridge. The base station may include various forms of macro base stations, micro base stations, relay stations, or the like. Herein, for ease of description, the devices mentioned above are collectively referred to as an AP. The STA is usually a terminal product that supports media access control (MAC) and a physical layer (PHY) of the 802.11 system standard, for example, a mobile phone or a notebook computer.

A sounding frame transmission method provided in this application may be applied to a wireless communication system. The wireless communication system may be a wireless local area network or a cellular network. The method may be implemented by a communication device in a wireless communication system or a chip or a processor in a communication device. The communication device may be a wireless communication device that supports parallel transmission of a plurality of links, for example, referred to as a multi-link device or a multi-band device. Compared with a device that supports single-link transmission, the multi-link device has higher transmission efficiency and higher throughput. The multi-link device includes one or more affiliated stations STAs (affiliated STAs). The affiliated STA is a logical station and can work on a same link. The affiliated station may be an access point (AP) or a non-access point station (non-AP STA). For ease of description, in this application, a multi-link device whose station is an AP may be referred to as a multi-link AP, a multi-link AP device, or an AP multi-link device (AP multi-link device), and a multi-link device whose station is a non-AP STA may be referred to as a multi-link STA, a multi-link STA device, or a STA multi-link device (STA multi-link device).

In addition, the technical solutions provided in embodiments of this application are applicable to a plurality of system architectures. Network architectures and service scenarios described in embodiments of this application are intended to more clearly describe the technical solutions in embodiments of this application, but are not intended to limit the technical solutions provided in embodiments of this application. A person of ordinary skill in the art may know that as the network architectures evolve and a new service scenario emerges, the technical solutions provided in embodiments of this application are also applicable to a similar technical problem.

Optionally, the wireless access point, the station, and the like in FIG. 4 may be implemented by one device, or may be jointly implemented by a plurality of devices, or may be a functional module in one device. This is not specifically limited in this embodiment of this application. It may be understood that the foregoing functions may be network elements in a hardware device, or may be software functions running on dedicated hardware, or may be virtualization functions instantiated on a platform (for example, a cloud platform).

For example, each device in FIG. 4 may be implemented by a communication apparatus 500 in FIG. 5. FIG. 5 is a schematic diagram of a hardware structure of a communication apparatus that may be used in an embodiment of this application. The communication apparatus 500 includes at least one processor 501, a communication line 502, a memory 503, and at least one communication interface 504.

The processor 501 may be a general-purpose central processing unit (CPU), a microprocessor, an application-specific integrated circuit (ASIC), or one or more integrated circuits configured to control program execution in the solutions of this application.

The communication line 502 may include a path for transmitting information between the foregoing components.

The communication interface 504 is any apparatus (such as an antenna) of a transceiver type, and is configured to communicate with another device or a communication network, such as the Ethernet, a RAN, or WLAN.

The memory 503 may be a read-only memory (ROM) or another type of static storage device that can store static information and instructions, a random access memory (RAM), or another type of dynamic storage device that can store information and instructions, or may be an electrically erasable programmable read-only memory (EEPROM), a compact disc read-only memory (CD-ROM), or another optical disc storage, an optical disk storage (including a compact disc, a laser disc, an optical disc, a digital versatile disc, a Blu-ray disc, and the like), a magnetic disk storage medium or another magnetic storage device, or any other medium that can be used to carry or store expected program code in instructions or data structure form and that can be accessed by a computer, which is not limited thereto. The memory may exist independently, and is connected to the processor through the communication line 502. Alternatively, the memory may be integrated with the processor. The memory provided in embodiments of this application may be usually non-volatile. The memory 503 is configured to store computer-executable instructions for performing the solutions in this application, and the processor 501 controls execution of the computer-executable instructions. The processor 501 is configured to execute the computer-executable instructions stored in the memory 503, to implement a method provided in the following embodiments of this application.

Optionally, the computer-executable instructions in this embodiment of this application may also be referred to as application program code. This is not specifically limited in this embodiment of this application.

In an embodiment, the processor 501 may include one or more CPUs, for example, a CPU 0 and a CPU 1 in FIG. 5.

In an embodiment, the communication apparatus 500 may include a plurality of processors, for example, the processor 501 and a processor 507 in FIG. 5. Each of the processors may be a single-core (single-CPU) processor, or may be a multi-core (multi-CPU) processor. The processor herein may be one or more devices, circuits, and/or processing cores configured to process data (for example, computer program instructions).

In an embodiment, the communication apparatus 500 may further include an output device 505 and an input device 506. The output device 505 communicates with the processor 501, and may display information in a plurality of manners. For example, the output device 505 may be a liquid crystal display (LCD), a light emitting diode (LED) display device, a cathode ray tube (CRT) display device, a projector, or the like. The input device 506 communicates with the processor 501, and may receive a user input in a plurality of manners. For example, the input device 506 may be a mouse, a keyboard, a touchscreen device, a sensing device, or the like.

The communication apparatus 500 may be a general-purpose device or a dedicated device. In some embodiments, the communication apparatus 500 may be a portable computer, a network server, a palmtop computer (personal digital assistant, PDA), a mobile phone, a tablet computer, a wireless terminal device, an embedded device, or a device having a structure similar to that in FIG. 5. A type of the communication apparatus 500 is not limited in this embodiment of this application.

After the communication apparatus is powered on, the processor 501 may read the software program in the memory 503, interpret and execute instructions of the software program, and process data of the software program. When data needs to be sent in a wireless manner, the processor 501 performs baseband processing on the to-be-sent data, and then outputs a baseband signal to a radio frequency circuit. The radio frequency circuit performs radio frequency processing on the baseband signal, and then sends a radio frequency signal in an electromagnetic wave form by using the antenna. When data is sent to the communication apparatus, the radio frequency circuit receives a radio frequency signal by using the antenna, converts the radio frequency signal into a baseband signal, and outputs the baseband signal to the processor 501. The processor 501 converts the baseband signal into data and processes the data.

In another example, the radio frequency circuit and the antenna may be disposed independently of the processor for baseband processing. For example, in a distributed scenario, the radio frequency circuit and the antenna may be disposed remotely independent of the communication apparatus.

The following describes the technical solutions provided in embodiments of this application with reference to the accompanying drawings. It may be understood that a first device may be the AP in FIG. 4, and a second device may be the AP or the STA in FIG. 4; or the first device may be the STA in FIG. 4, and the second device may also be the STA in FIG. 4. This is not limited herein. The following describes the technical solutions provided in embodiments of this application by using an example in which the first device is an AP and the second device is a STA.

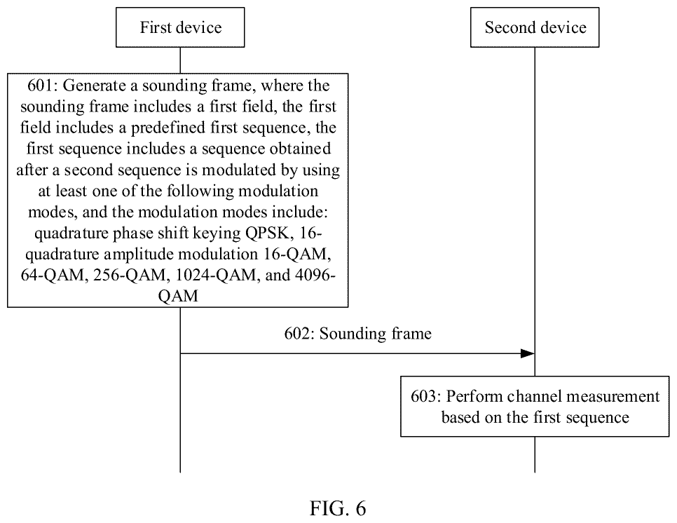

FIG. 6 is a schematic flowchart of a sounding frame transmission method according to an embodiment of this application. As shown in FIG. 6, the method includes but is not limited to the following operations.

601: The first device generates a sounding frame, where the sounding frame includes a first field, the first field includes a predefined first sequence, the first sequence includes a sequence obtained after a second sequence is modulated by using at least one of the following modulation modes, and the modulation modes include: quadrature phase shift keying (QPSK), 16-quadrature amplitude modulation (QAM), 64-QAM, 256-QAM, 1024-QAM, and 4096-QAM.

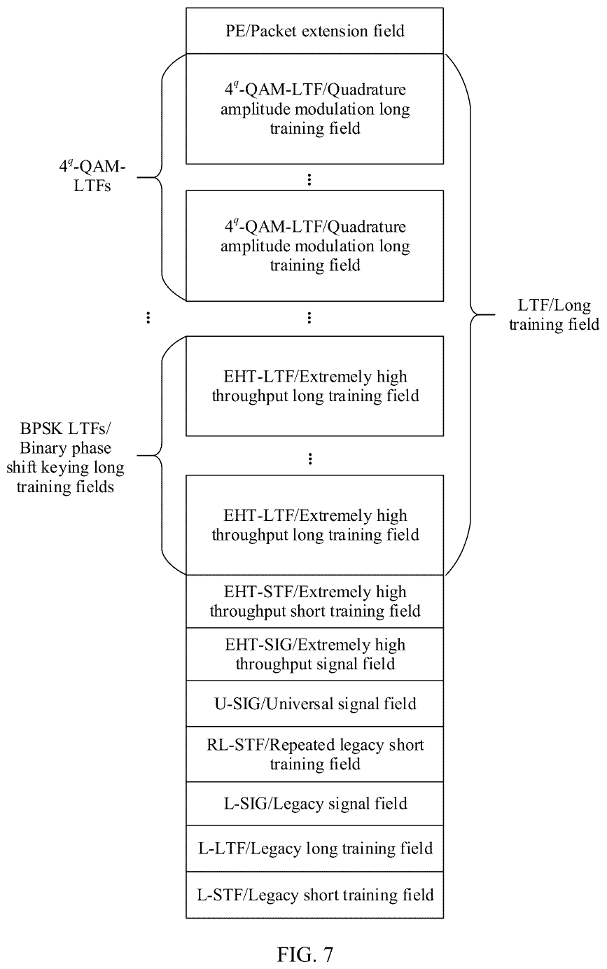

For a frame structure of the sounding frame, refer to FIG. 2 or FIG. 7. Details are not described herein again.

Optionally, the first field may be an HE-LTF field in FIG. 2, or the first field may be an LTF field in FIG. 7. This is not limited herein. For example, in 802.11ax, the first field is the HE-LTF field in FIG. 2, and in 802.11be, the first field is the LTF field in FIG. 7.

That the first sequence includes a sequence obtained after a second sequence is modulated by using at least one of the following modulation modes may be understood as that the first sequence includes at least one of the following: a sequence obtained after the second sequence is modulated by using QPSK, a sequence obtained after the second sequence is modulated by using 16-QAM, a sequence obtained after the second sequence is modulated by using 64-QAM, a sequence obtained after the second sequence is modulated by using 256-QAM, a sequence obtained after the second sequence is modulated by using 1024-QAM, and a sequence obtained after the second sequence is modulated by using 4096-QAM.

Optionally, the second sequence may be an HE-LTF sequence in a 4× mode at an 80 MHz bandwidth in 802.11ax, or an EHT-LTF sequence in a 4× mode at an 80 MHz bandwidth in 802.11be. The “80 MHz bandwidth” mentioned in this application may mean that a bandwidth is 80 MHz.

For example, in 802.11ax, the HE-LTF sequence is:

HE − LTF₄ₓ(−500:500) =

[1, −1, −1, −1, −1, 1, −1, −1, 1, −1, −1, −1, 1, 1, −1, −1, −1, 1, −1, −1, 1, −1, 1, 1, 1, −1,
1, −1, 1, −1, −1, −1, −1, 1, 1, 1, 1, 1, −1, −1, 1, −1, 1, −1, −1, −1, 1, 1, −1, −1, 1, −1, −1, −1, 1, 1, 1,
−1, −1, 1, 1, −1, −1, 1, −1, 1, 1, −1, 1, −1, 1, 1, 1, −1, 1, −1, 1, 1, 1, 1, 1, 1, −1, −1, −1, 1, −1, 1, −1,
−1, −1, 1, −1, −1, 1, 1, 1, 1, 1, 1, −1, 1, −1, 1, 1, −1, 1, −1, 1, −1, 1, −1, 1, −1, −1, 1, 1, 1, 1, −1, −1,
−1, −1, −1, −1, −1, −1, 1, −1, −1, 1, −1, −1, 1, 1, 1, −1, 1, −1, −1, −1, 1, 1, 1, −1, 1, 1, −1, −1, 1, −1,
−1, −1, 1, 1, 1, 1, −1, 1, 1, 1, 1, 1, 1, −1, 1, −1, −1, 1, −1, 1, −1, −1, 1, 1, 1, 1, 1, −1, 1, 1, −1, −1, 1,
1, 1, −1, 1, 1, −1, 1, 1, −1, −1, 1, 1, −1, −1, −1, −1, 1, 1, 1, 1, 1, −1, 1, 1, 1, 1, 1, −1, 1, −1, 1, −1, −1,
1, −1, −1, −1, −1, −1, 1, −1, −1, −1, 1, 1, −1, 1, −1, 1, −1, −1, −1, −1, −1, 1, 1, 1, 1, −1, 1, −1, −1, 1,
1, −1, −1, −1, 1, 1, 1, 1, 1, −1, 1, −1, 1, −1, −1, 1, 1, 1, −1, 1, 1, 1, 1, 1, −1, 1, 1, −1, 1, −1, 1, −1, −1,
−1, −1, −1, 1, −1, −1, −1, −1, −1, 1, 1, 1, 1, −1, −1, 1, 1, −1, −1, 1, −1, −1, 1, −1, −1, −1, 1, 1, −1, −1,
1, −1, −1, −1, −1, −1, 1, 1, −1, 1, −1, 1, 1, −1, 1, −1, −1, −1, −1, −1, −1, 1, −1, −1, −1, −1, 1, 1, 1, −1,
1, 1, −1, −1, 1, −1, −1, −1, 1, 1, 1, −1, 1, −1, 1, −1, −1, −1, 1, −1, 1, −1, 1, −1, −1, −1, 1, −1, −1, 1,
−1, 1, 1, −1, −1, −1, 1, 1, −1, −1, −1, −1, 1, −1, 1, 1, −1, 1, −1, 1, 1, 1, 1, 1, 1, −1, −1, 1, −1, −1, −1, 1,
−1, 1, −1, −1, −1, 1, 1, 1, 1, 1, 1, −1, 1, −1, 1, 1, 1, −1, 1, −1, 1, 1, −1, 1, −1, −1, 1, 1, −1, −1, 1, 1, 1,
−1, −1, −1, 1, −1, −1, 1, 1, −1, −1, −1, 1, −1, 1, −1, −1, 1, 1, 1, 1, 1, −1, −1, −1, −1, 1, −1, 1, −1, 1, 1,
1, −1, 1, −1, −1, 1, −1, −1, −1, 1, 1, −1, −1, −1, 1, −1, −1, 1, −1, −1, −1, −1, 1, −1, 1, 1, −1, −1, −1, 1,
−1, −1, 0, 0, 0, 0, 0, −1, −1, 1, −1, 1, 1, 1, 1, 1, 1, −1, −1, −1, −1, 1, −1, −1, 1, −1, −1, −1, 1, 1, −1,
−1, −1, 1, −1, −1, 1, −1, 1, 1, 1, −1, 1, −1, 1, −1, −1, −1, −1, 1, 1, 1, 1, 1, −1, −1, 1, −1, 1, −1, −1, −1,
1, 1, −1, −1, 1, −1, −1, −1, 1, 1, 1, −1, −1, 1, 1, −1, −1, 1, −1, 1, 1, −1, 1, −1, 1, 1, 1, −1, 1, −1, 1, 1,
1, 1, 1, 1, −1, −1, −1, 1, −1, 1, −1, −1, −1, 1, −1, −1, 1, 1, 1, 1, 1, 1, −1, 1, −1, 1, 1, −1, 1, −1, −1, −1,
−1, 1, 1, −1, −1, −1, 1, 1, −1, 1, −1, −1, 1, −1, −1, −1, 1, −1, 1, −1, 1, −1, −1, −1, 1, −1, 1, −1, 1, 1, 1,
−1, −1, −1, 1, −1, −1, 1, 1, −1, 1, 1, 1, −1, −1, −1, −1, 1, −1, −1, −1, −1, −1, −1, 1, −1, 1, 1, −1, 1, −1,
1, 1, −1, −1, −1, −1, −1, 1, −1, −1, 1, 1, −1, −1, −1, 1, −1, −1, 1, −1, −1, 1, 1, −1, −1, 1, 1, 1, 1, −1,
−1, −1, −1, −1, 1, −1, −1, −1, −1, −1, 1, −1, 1, −1, 1, 1, −1, 1, 1, 1, 1, 1, −1, 1, 1, 1, −1, −1, 1, −1, 1,
−1, 1, 1, 1, 1, 1, −1, −1, −1, 1, 1, −1, −1, −1, −1, −1, −1, −1, −1, 1, 1, 1, 1, 1, −1, 1, −1, 1, −1, −1, 1, 1,
1, −1, 1, 1, 1, 1, 1, −1, 1, 1, −1, 1, −1, 1, −1, −1, −1, −1, −1, 1, −1, −1, −1, −1, −1, 1, 1, 1, 1, −1, −1,
1, 1, −1, −1, 1, −1, −1, 1, −1, −1, −1, 1, 1, −1, −1, 1, −1, −1, −1, −1, −1, 1, 1, −1, 1, −1, 1, 1, −1, 1,
−1, −1, −1, −1, −1, −1, 1, −1, −1, −1, −1, 1, 1, 1, −1, 1, 1, −1, −1, 1, −1, −1, −1, 1, 1, 1, −1, 1, −1, −1,
−1, 1, 1, −1, 1, 1, −1, 1, 1, 1, 1, 1, 1, 1, 1, −1, −1, −1, −1, 1, 1, −1, 1, −1, 1, −1, 1, −1, 1, −1, −1, 1,
−1, 1, −1, −1, −1, −1, −1, −1, 1, 1, −1, 1, 1, 1, −1, 1, −1, 1, 1, 1, −1, −1, −1, −1, −1, −1, 1, −1, 1, −1,
−1, −1, 1, −1, 1, −1, −1, 1, −1, 1, 1, −1, −1, 1, 1, −1, −1, −1, 1, 1, 1, −1, 1, 1, −1, −1, 1, 1, 1, −1, 1, −1,
1, 1, −1, −1, −1, −1, −1, 1, 1, 1, 1, −1, 1, −1, 1, −1, −1, −1, 1, −1, 1, 1, −1, 1, 1, 1, −1, −1, 1, 1, 1, −1,
1, 1, −1, 1, 1, 1, 1, −1].

The expression HE−LTF_{4×}(−500: 500) means that values on tones whose sequence numbers are −500 to 500 are values in the HE-LTF sequence successively. That is, it can be learned that components of the second sequence are all +1, 0, or −1, and distortion of the HE-LTF sequence under BPSK modulation is small and a PAPR is low. Therefore, channel quality of a link under BPSK modulation can be accurately measured.

For another example, in 802.11be, the EHT-LTF sequence is:

EHT − LTF₄ₓ(−500:500) =

[1, −1, −1, −1, −1, 1, −1, −1, 1, −1, −1, −1, 1, 1, −1, −1, −1, 1, −1, −1, 1, −1, 1, 1, 1, −1,
1, −1, 1, −1, −1, −1, −1, 1, 1, 1, 1, 1, −1, −1, 1, −1, 1, −1, −1, −1, 1, 1, −1, −1, 1, −1, −1, −1, 1, 1, 1,
−1, −1, 1, 1, −1, −1, 1, −1, 1, 1, −1, 1, −1, 1, 1, 1, −1, 1, −1, 1, 1, 1, 1, 1, 1, −1, −1, −1, 1, −1, 1, −1,
−1, −1, 1, −1, −1, 1, 1, 1, 1, 1, 1, −1, 1, −1, 1, 1, −1, 1, −1, 1, −1, 1, −1, 1, −1, −1, 1, 1, 1, 1, −1, −1,
−1, −1, −1, −1, −1, −1, 1, −1, −1, 1, −1, −1, 1, 1, 1, −1, 1, −1, −1, −1, 1, 1, 1, −1, 1, 1, −1, −1, 1, −1,
−1, −1, 1, 1, 1, 1, −1, 1, 1, 1, 1, 1, 1, −1, 1, −1, −1, 1, −1, 1, −1, −1, 1, 1, 1, 1, 1, −1, 1, 1, −1, −1, 1,
1, 1, −1, 1, 1, −1, 1, 1, −1, −1, 1, 1, −1, −1, −1, −1, 1, 1, 1, 1, 1, −1, 1, 1, 1, 1, 1, −1, 1, −1, 1, −1, −1,
1, −1, −1, −1, −1, −1, 1, −1, −1, −1, 1, 1, −1, 1, −1, 1, −1, −1, −1, −1, −1, 1, 1, 1, 1, −1, 1, −1, −1, 1,
1, −1, −1, −1, 1, 1, 1, 1, 1, −1, 1, −1, 1, −1, −1, 1, 1, 1, −1, 1, 1, 1, 1, 1, −1, 1, 1, −1, 1, −1, 1, −1, −1,
−1, −1, −1, 1, −1, −1, −1, −1, −1, 1, 1, 1, 1, −1, −1, 1, 1, −1, −1, 1, −1, −1, 1, −1, −1, −1, 1, 1, −1, −1,
1, −1, −1, −1, −1, −1, 1, 1, −1, 1, −1, 1, 1, −1, 1, −1, −1, −1, −1, −1, −1, 1, −1, −1, −1, −1, 1, 1, 1, −1,
1, 1, −1, −1, 1, −1, −1, −1, 1, 1, 1, −1, 1, −1, 1, −1, −1, −1, 1, −1, 1, −1, 1, −1, −1, −1, 1, −1, −1, 1,
−1, 1, 1, −1, −1, −1, 1, 1, −1, −1, −1, −1, 1, −1, 1, 1, −1, 1, −1, 1, 1, 1, 1, 1, 1, −1, −1, 1, −1, −1, −1, 1,
−1, 1, −1, −1, −1, 1, 1, 1, 1, 1, 1, −1, 1, −1, 1, 1, 1, −1, 1, −1, 1, 1, −1, 1, −1, −1, 1, 1, −1, −1, 1, 1, 1,
−1, −1, −1, 1, −1, −1, 1, 1, −1, −1, −1, 1, −1, 1, −1, −1, 1, 1, 1, 1, 1, −1, −1, −1, −1, 1, −1, 1, −1, 1, 1,
1, −1, 1, −1, −1, 1, −1, −1, −1, 1, 1, −1, −1, −1, 1, −1, −1, 1, −1, −1, −1, −1, 1, −1, 1, 1, −1, −1, −1, 1,
−1, −1, 0, 0, 0, 0, 0, −1, −1, 1, −1, 1, 1, 1, 1, 1, 1, −1, −1, −1, −1, 1, −1, −1, 1, −1, −1, −1, 1, 1, −1,
−1, −1, 1, −1, −1, 1, −1, 1, 1, 1, −1, 1, −1, 1, −1, −1, −1, −1, 1, 1, 1, 1, 1, −1, −1, 1, −1, 1, −1, −1, −1,
1, 1, −1, −1, 1, −1, −1, −1, 1, 1, 1, −1, −1, 1, 1, −1, −1, 1, −1, 1, 1, −1, 1, −1, 1, 1, 1, −1, 1, −1, 1, 1,
1, 1, 1, 1, −1, −1, −1, 1, −1, 1, −1, −1, −1, 1, −1, −1, 1, 1, 1, 1, 1, 1, −1, 1, −1, 1, 1, −1, 1, −1, −1, −1,
−1, 1, 1, −1, −1, −1, 1, 1, −1, 1, −1, −1, 1, −1, −1, −1, 1, −1, 1, −1, 1, −1, −1, −1, 1, −1, 1, −1, 1, 1, 1,
−1, −1, −1, 1, −1, −1, 1, 1, −1, 1, 1, 1, −1, −1, −1, −1, 1, −1, −1, −1, −1, −1, −1, 1, −1, 1, 1, −1, 1, −1,
1, 1, −1, −1, −1, −1, −1, 1, −1, −1, 1, 1, −1, −1, −1, 1, −1, −1, 1, −1, −1, 1, 1, −1, −1, 1, 1, 1, 1, −1,
−1, −1, −1, −1, 1, −1, −1, −1, −1, −1, 1, −1, 1, −1, 1, 1, −1, 1, 1, 1, 1, 1, −1, 1, 1, 1, −1, −1, 1, −1, 1,
−1, 1, 1, 1, 1, 1, −1, −1, −1, 1, 1, −1, −1, −1, −1, −1, −1, −1, −1, 1, 1, 1, 1, 1, −1, 1, −1, 1, −1, −1, 1, 1,
1, −1, 1, 1, 1, 1, 1, −1, 1, 1, −1, 1, −1, 1, −1, −1, −1, −1, −1, 1, −1, −1, −1, −1, −1, 1, 1, 1, 1, −1, −1,
1, 1, −1, −1, 1, −1, −1, 1, −1, −1, −1, 1, 1, −1, −1, 1, −1, −1, −1, −1, −1, 1, 1, −1, 1, −1, 1, 1, −1, 1, −
1, −1, −1, −1, −1, −1, 1, −1, −1, −1, −1, 1, 1, 1, −1, 1, 1, −1, −1, 1, −1, −1, −1, 1, 1, 1, −1, 1, −1, −1,
−1, 1, 1, −1, 1, 1, −1, 1, 1, 1, 1, 1, 1, 1, 1, −1, −1, −1, −1, 1, 1, −1, 1, −1, 1, −1, 1, −1, 1, −1, −1, 1,
−1, 1, −1, −1, −1, −1, −1, −1, 1, 1, −1, 1, 1, 1, −1, 1, −1, 1, 1, 1, −1, −1, −1, −1, −1, −1, 1, −1, 1, −1,
−1, −1, 1, −1, 1, −1, −1, 1, −1, 1, 1, −1, −1, 1, 1, −1, −1, −1, 1, 1, 1, −1, 1, 1, −1, −1, 1, 1, 1, −1, 1, −1,
1, 1, −1, −1, −1, −1, −1, 1, 1, 1, 1, −1, 1, −1, 1, −1, −1, −1, 1, −1, 1, 1, −1, 1, 1, 1, −1, −1, 1, 1, 1, −1,
1, 1, −1, 1, 1, 1, 1, −1].

The expression EHT−LTF_{4×}(−500: 500) means that values on tones whose sequence numbers are −500 to 500 are values in the EHT-LTF sequence successively. That is, it can be learned that components of the second sequence are all +1, 0, or −1, and distortion of the EHT-LTF sequence under BPSK modulation is small and a PAPR is low. Therefore, channel quality of a link under BPSK modulation can be accurately measured.

Optionally, the first sequence may be implemented in at least one of Manner 1 to Manner 6 in the following, or the first sequence may be implemented in at least one of Manner 7 to Manner 12 in the following. It may be understood that, for Manner 1 or Manner 7, the first sequence is a sequence obtained after the second sequence is modulated by using QPSK. For Manner 2 or Manner 8, the first sequence is a sequence obtained after the second sequence is modulated by using 16-QAM. For Manner 3 or Manner 9, the first sequence is a sequence obtained after the second sequence is modulated by using 64-QAM. For Manner 4 or Manner 10, the first sequence is a sequence obtained after the second sequence is modulated by using 256-QAM. For Manner 5 or Manner 11, the first sequence is a sequence obtained after the second sequence is modulated by using 1024-QAM. For Manner 6 or Manner 12, the first sequence is a sequence obtained after the second sequence is modulated by using 4096-QAM. It should be noted that the second sequence in Manner 1 to Manner 6 is the HE-LTF sequence in the 4× mode at the 80 MHz bandwidth in 802.11ax, and the second sequence in Manner 7 to Manner 12 is the EHT-LTF sequence in the 4× mode at the 80 MHz bandwidth in 802.11be.

Manner 1: The first sequence meets the following formula (1):

$${s}_{i} = [ {a}_{0} , {c}_{i} , 0 , 0 , 0 , 0 , 0 , ( - 1 j ) * {a}_{1} ] . \qquad ( 1 )$$

i is an integer greater than or equal to 1 and less than or equal to 7. That is, a sequence under QPSK modulation is implemented, so that channel quality of a communication link under QPSK modulation can be accurately measured when the channel quality of the communication link is measured by using the sequence.

Manner 2: The first sequence meets the following formula (2):

$${q}_{1} = \frac{2}{\sqrt{5}} {e}^{\frac{j π}{4}} {s}_{k 1} + \frac{1}{\sqrt{5}} {e}^{\frac{j π}{4}} {s}_{k 2} . \qquad ( 2 )$$

sₖ₁=[a₀, cₖ₁, 0 , 0 , 0 , 0 , 0 , (−1j)*a₁]; and sₖ₂=[a₀, cₖ₂, 0 , 0 , 0 , 0 , 0 , (−1j)*a₁].

k1 is 1, and k2 is 7; or kl is 4, and k2 is 5 or 6; or k1 is 5, and k2 is 1 or 2. That is, a sequence under 16-QAM modulation is implemented, so that channel quality of a communication link under 16-QAM modulation can be accurately measured when the channel quality of the communication link is measured by using the sequence.

Manner 3: The first sequence meets the following formula (3):

$${q}_{2} = \frac{4}{\sqrt{21}} {e}^{\frac{j π}{4}} {s}_{k 3} + \frac{2}{\sqrt{21}} {e}^{\frac{j π}{4}} {s}_{k 4} + \frac{1}{\sqrt{21}} {e}^{\frac{j π}{4}} {s}_{k 5} . \qquad ( 3 )$$

$${s}_{k 3} = [ {a}_{0} , {c}_{k 3} , 0 , 0 , 0 , 0 , 0 , ( - 1 j ) * {a}_{1} ] ;$$

$${s}_{k 4} = [ {a}_{0} , {c}_{k 4} , 0 , 0 , 0 , 0 , 0 , ( - 1 j ) * {a}_{1} ] ;$$

$$and$$

$${s}_{k 5} = [ {a}_{0} , {c}_{k 5} , 0 , 0 , 0 , 0 , 0 , ( - 1 j ) * {a}_{1} ] .$$

k3 is 1, k4 is 6, and k5 is 7; or k3 is 1, k4 is 7, and k5 is 5 or 6; or k3 is 2, k4 is 7, and k5 is 6 or 7; or k3 is 3, k4 is 5, and k5 is 6; or k3 is 3, k4 is 5, and k5 is 7; or k3 is 3, k4 is 6, and k5 is 5 or 6; or k3 is 3, k4 is 7, and k5 is 1, 2, 3, or 4; or k3 is 4, k4 is 4, and k5 is 7; or k3 is 4, k4 is 5, and k5 is 3, 4, or 5; or k3 is 4, k4 is 6, and k5 is 1, 2, 3, or 4; or k3 is 5, k4 is 1, and k5 is 3 or 4; or k3 is 5, k4 is 1, and k5 is 5; or k3 is 5, k4 is 2, and k5 is 4, 5, or 6; or k3 is 5, k4 is 3, and k5 is 1, 2, 3, or 4; or k3 is 5, k4 is 4, and k5 is 1 or 2; or k3 is 6, k4 is 1, and k5 is 1 or 2; or k3 is 6, k4 is 2, and k5 is 1, 2, or 3. That is, a sequence under 64-QAM modulation is implemented, so that channel quality of a communication link under 64-QAM modulation can be accurately measured when the channel quality of the communication link is measured by using the sequence.

Manner 4: The first sequence meets the following formula (4):

$${q}_{3} = \frac{8}{\sqrt{85}} {e}^{\frac{j π}{4}} {s}_{k 6} + \frac{4}{\sqrt{85}} {e}^{\frac{j π}{4}} {s}_{k 7} + \frac{2}{\sqrt{85}} {e}^{\frac{j π}{4}} {s}_{k 8} + \frac{1}{\sqrt{85}} {e}^{\frac{j π}{4}} {s}_{k 9} . \qquad ( 4 )$$

$${s}_{k 6} = [ {a}_{0} , {c}_{k 6} , 0 , 0 , 0 , 0 , 0 , ( - 1 j ) * {a}_{1} ] ;$$

$${s}_{k 7} = [ {a}_{0} , {c}_{k 7} , 0 , 0 , 0 , 0 , 0 , ( - 1 j ) * {a}_{1} ] ;$$

$${s}_{k 8} = [ {a}_{0} , {c}_{k 8} , 0 , 0 , 0 , 0 , 0 , ( - 1 j ) * {a}_{1} ] ;$$

$$and$$

$${s}_{k 9} = [ {a}_{0} , {c}_{k 9} , 0 , 0 , 0 , 0 , 0 , ( - 1 j ) * {a}_{1} ] .$$

k6 is 1, k7 is 7, k8 is 4, and k9 is 7; or k6 is 1, k7 is 7, k8 is 6, and k9 is 3; or k6 is 2, k7 is 7, k8 is 7, and k9 is 4; or k6 is 3, k7 is 5, k8 is 7, and k9 is 4; or k6 is 3, k7 is 6, k8 is 5, and k9 is 5; or k6 is 3, k7 is 7, k8 is 1, and k9 is 5; or k6 is 3, k7 is 7, k8 is 2, and k9 is 6; or k6 is 3, k7 is 7 , k8 is 3, and k9 is 4; or k6 is 4, k7 is 4, k8 is 6, and k9 is 7; or k6 is 4, k7 is 6, k8 is 1, and k9 is 6; or k6 is 4, k7 is 6, k8 is 4, and k9 is 3; or k6 is 5, k7 is 1, k8 is 1, and k9 is 7; or k6 is 5, k7 is 2, k8 is 6, and k9 is 2; or k6 is 5, k7 is 4, k8 is 1, and k9 is 1; or k6 is 5, k7 is 4, k8 is 2, and k9 is 3; or k6 is 6, k7 is 1, k8 is 1, and k9 is 1. That is, a sequence under 256-QAM modulation is implemented, so that channel quality of a communication link under 256-QAM modulation can be accurately measured when the channel quality of the communication link is measured by using the sequence.

Manner 5: The first sequence meets the following formula (5):

$${q}_{4} = \frac{16}{\sqrt{341}} {e}^{\frac{j π}{4}} {s}_{k 10} + \frac{8}{\sqrt{341}} {e}^{\frac{j π}{4}} {s}_{k 11} + \frac{4}{\sqrt{341}} {e}^{\frac{j π}{4}} {s}_{k 12} + \frac{2}{\sqrt{341}} {e}^{\frac{j π}{4}} {s}_{k 13} + \frac{1}{\sqrt{345}} {e}^{\frac{j π}{4}} {s}_{k 14} . \qquad ( 5 )$$

$${s}_{k 10} = [ {a}_{0} , {c}_{k 10} , 0 , 0 , 0 , 0 , 0 , ( - 1 j ) * {a}_{1} ] ;$$

$${s}_{k 11} = [ {a}_{0} , {c}_{k 11} , 0 , 0 , 0 , 0 , 0 , ( - 1 j ) * {a}_{1} ] ;$$

$${s}_{k 12} = [ {a}_{0} , {c}_{k 12} , 0 , 0 , 0 , 0 , 0 , ( - 1 j ) * {a}_{1} ] ;$$

$${s}_{k 13} = [ {a}_{0} , {c}_{k 13} , 0 , 0 , 0 , 0 , 0 , ( - 1 j ) * {a}_{1} ] ;$$

$$and$$

$${s}_{k 14} = [ {a}_{0} , {c}_{k 14} , 0 , 0 , 0 , 0 , 0 , ( - 1 j ) * {a}_{1} ] .$$

k10 is 1, k11 is 7, k12 is 6, k13 is 1, and k14 is 5; or k10 is 2, k11 is 7, k12 is 5, k13 is 7, and k14 is 5; or k10 is 6, k11 is 1, k12 is 2, k13 is 4, and k14 is 4; or k10 is 4, k11 is 6, k12 is 4, k13 is 1, and k14 is 6; or k10 is 6, k11 is 2, k12 is 1, k13 is 4, and k14 is 5; or k10 is 3, k11 is 6, k12 is 7, k13 is 1, and k14 is 2; or k10 is 5, k11 is 3, k12 is 1, k13 is 6, and k14 is 1; or k10 is 4, k11 is 6, k12 is 2, k13 is 6, and k14 is 6. That is, a sequence under 1024-QAM modulation is implemented, so that channel quality of a communication link under 1024-QAM modulation can be accurately measured when the channel quality of the communication link is measured by using the sequence.

Manner 6: The first sequence meets the following formula (6):

$${q}_{5} = \frac{16}{\sqrt{1365}} {e}^{\frac{j π}{4}} {s}_{k 15} + \frac{16}{\sqrt{1365}} {e}^{\frac{j π}{4}} {s}_{k 16} + \frac{8}{\sqrt{1365}} {e}^{\frac{j π}{4}} {s}_{k 17} + \frac{4}{\sqrt{1365}} {e}^{\frac{j π}{4}} {s}_{k 18} + \frac{2}{\sqrt{1365}} {e}^{\frac{j π}{4}} {s}_{k 19} + \frac{1}{\sqrt{1365}} {e}^{\frac{j π}{4}} {s}_{k 20} . \qquad ( 6 )$$

$${s}_{k 15} = [ {a}_{0} , {c}_{k 15} , 0 , 0 , 0 , 0 , 0 , ( - 1 j ) * {a}_{1} ] ;$$

$${s}_{k 16} = [ {a}_{0} , {c}_{k 16} , 0 , 0 , 0 , 0 , 0 , ( - 1 j ) * {a}_{1} ] ;$$

$${s}_{k 17} = [ {a}_{0} , {c}_{k 17} , 0 , 0 , 0 , 0 , 0 , ( - 1 j ) * {a}_{1} ] ;$$

$${s}_{k 18} = [ {a}_{0} , {c}_{k 18} , 0 , 0 , 0 , 0 , 0 , ( - 1 j ) * {a}_{1} ] ;$$

$${s}_{k 19} = [ {a}_{0} , {c}_{k 19} , 0 , 0 , 0 , 0 , 0 , ( - 1 j ) * {a}_{1} ] ;$$

$$and$$

$${s}_{k 20} = [ {a}_{0} , {c}_{k 20} , 0 , 0 , 0 , 0 , 0 , ( - 1 j ) * {a}_{1} ] .$$

k15 is 5, k16 is 2, k17 is 4, k18 is 7, k19 is 2, and k20 is 5; or k15 is 5, k16 is 2, k17 is 5, k18 is 1, k19 is 7, and k20 is 2; or k15 is 6, k16 is 2, k17 is 2, k18 is 3, k19 is 7, and k20 is 5; or k15 is 3, k16 is 6, k17 is 6, k18 is 4, k19 is 5, and k20 is 4: or k15 is 4, k16 is 7, k17 is 2, k18 is 2, k19 is 3, and k20 is 2; or k15 is 6, k16 is 1, k17 is 2, k18 is 3, k19 is 5, and k20 is 4; or k15 is 2, k16 is 7, k17 is 7, k18 is 3, k19 is 6, and k20 is 3; or k15 is 1, k16 is 7, k17 is 5, k18 is 5, k19 is 4, and k20 is 2. That is, a sequence under 4096-QAM modulation is implemented, so that channel quality of a communication link under 4096-QAM modulation can be accurately measured when the channel quality of the communication link is measured by using the sequence.

Manner 7: The first sequence meets the following formula (7):

$${p}_{u} = [ {b}_{0} , {d}_{u} , 0 , 0 , 0 , 0 , 0 , ( - 1 j ) * {b}_{1} ] . \qquad ( 7 )$$

u is an integer greater than or equal to 1 and less than or equal to 5. That is, a sequence under QPSK modulation is implemented, so that channel quality of a communication link under QPSK modulation can be accurately measured when the channel quality of the communication link is measured by using the sequence.

Manner 8: The first sequence meets the following formula (8):

$${q}_{6} = \frac{2}{\sqrt{5}} {e}^{\frac{j π}{4}} {p}_{t 1} + \frac{1}{\sqrt{5}} {e}^{\frac{j π}{4}} {p}_{t 2} . \qquad ( 8 )$$

$${p}_{t 1} = [ {b}_{0} , {d}_{t 1} , 0 , 0 , 0 , 0 , 0 , ( - 1 j ) * {b}_{1} ] ;$$

$$and$$

$${p}_{t 2} = [ {b}_{0} , {d}_{t 2} , 0 , 0 , 0 , 0 , 0 , ( - 1 j ) * {b}_{1} ] .$$

t1 is 5, and t2 is 1, 2, 3, 4, or 5; or t1 is 1, and t2 is 5; or t1 is 4, and t2 is 5. That is, a sequence under 16-QAM modulation is implemented, so that channel quality of a communication link under 16-QAM modulation can be accurately measured when the channel quality of the communication link is measured by using the sequence.

Manner 9: The first sequence meets the following formula (9):

$${q}_{7} = \frac{4}{\sqrt{21}} {e}^{\frac{j π}{4}} {p}_{t 3} + \frac{2}{\sqrt{21}} {e}^{\frac{j π}{4}} {p}_{t 4} + \frac{1}{\sqrt{21}} {e}^{\frac{j π}{4}} {p}_{t 5} . \qquad ( 9 )$$

$${p}_{t 3} = [ {b}_{0} , {d}_{t 3} , 0 , 0 , 0 , 0 , 0 , ( - 1 j ) * {b}_{1} ] ;$$

$${p}_{t 4} = [ {b}_{0} , {d}_{t 4} , 0 , 0 , 0 , 0 , 0 , ( - 1 j ) * {b}_{1} ] ;$$

$$and$$

$${p}_{t 5} = [ {b}_{0} , {d}_{t 5} , 0 , 0 , 0 , 0 , 0 , ( - 1 j ) * {b}_{1} ] .$$

t3 is 5, t4 is 5, and t5 is 1, 2, 3, 4, or 5: or t3 is 5, t4 is 1, and t5 is 5; or t3 is 5, t4 is 1, and t5 is 1. That is, a sequence under 64-QAM modulation is implemented, so that channel quality of a communication link under 64-QAM modulation can be accurately measured when the channel quality of the communication link is measured by using the sequence.

Manner 10: The first sequence meets the following formula (10):

$${q}_{8} = \frac{8}{\sqrt{85}} {e}^{\frac{j π}{4}} {p}_{t 6} + \frac{4}{\sqrt{85}} {e}^{\frac{j π}{4}} {p}_{t 7} + \frac{2}{\sqrt{85}} {e}^{\frac{j π}{4}} {p}_{t 8} + \frac{1}{\sqrt{85}} {e}^{\frac{j π}{4}} {p}_{t 9} . \qquad ( 10 )$$

$${p}_{t 6} = [ {b}_{0} , {d}_{t 6} , 0 , 0 , 0 , 0 , 0 , ( - 1 j ) * {b}_{1} ] ;$$

$${p}_{t 7} = [ {b}_{0} , {d}_{t 7} , 0 , 0 , 0 , 0 , 0 , ( - 1 j ) * {b}_{1} ] ;$$

$${p}_{t 8} = [ {b}_{0} , {d}_{t 8} , 0 , 0 , 0 , 0 , 0 , ( - 1 j ) * {b}_{1} ] ;$$

$$and$$

$${p}_{t 9} = [ {b}_{0} , {d}_{t 9} , 0 , 0 , 0 , 0 , 0 , ( - 1 j ) * {b}_{1} ] .$$

t6 is 5, t7 is 5, and t8 is 5, and t9 is 1, 2, 3, or 4; or t6 is 5, t7 is 5, t8 is 1, and t9 is 1, 4, or 5; or t6 is 5, t7 is 1, t8 is 5, and t9 is 5. That is, a sequence under 256-QAM modulation is implemented, so that channel quality of a communication link under 256-QAM modulation can be accurately measured when the channel quality of the communication link is measured by using the sequence.

Manner 11: The first sequence meets the following formula (11):

$${q}_{9} = \frac{16}{\sqrt{341}} {e}^{\frac{j π}{4}} {p}_{t 10} + \frac{8}{\sqrt{341}} {e}^{\frac{j π}{4}} {p}_{t 11} + \frac{4}{\sqrt{341}} {e}^{\frac{j π}{4}} {p}_{t 12} + \frac{2}{\sqrt{341}} {e}^{\frac{j π}{4}} {p}_{t 13} + \frac{1}{\sqrt{345}} {e}^{\frac{j π}{4}} {p}_{t 14} . {p}_{t 10} = [ {b}_{0 ,} {d}_{t 10} , 0 , 0 , 0 , 0 , 0 , ( - 1 j ) * {b}_{1} ] ; \\ {p}_{t 11} = [ {b}_{0} , {d}_{t 11} , 0 , 0 , 0 , 0 , 0 , ( - {1}_{j} ) * {b}_{1} ] ; {p}_{t 12} = [ {b}_{0} , {d}_{t 12} , 0 , 0 , 0 , 0 , 0 , ( - 1 j ) * {b}_{1} ] ; \\ {p}_{t 13} = [ {b}_{0} , {d}_{t 13 ,} 0 , 0 , 0 , 0 , 0 , ( - {1}_{j} ) * {b}_{1} ] ; and \\ {p}_{t 14} = [ {b}_{0} , {d}_{t 14} , 0 , 0 , 0 , 0 , 0 , ( - 1 j ) * {b}_{1} ] . \qquad ( 11 )$$

t10 is 5, t11 is 5, t12 is 5, t13 is 1, and t14 is 2 or 4; or t10 is 5, t11 is 5, t12 is 5, t13 is 4, and t14 is 1 or 5; or t10 is 5, t11 is 5, t12 is 1, t13 is 5, and t14 is 1 or 5; or t10 is 5, t11 is 5, t12 is 1, t13 is 5, and t14 is 5; or t10 is 5, t11 is 5, t12 is 5, t13 is 2, and t14 is 5; or t10 is 5, t11 is 5, t12 is 5, t13 is 1, and t14 is 3. That is, a sequence under 1024-QAM modulation is implemented, so that channel quality of a communication link under 1024-QAM modulation can be accurately measured when the channel quality of the communication link is measured by using the sequence.

Manner 12: The first sequence meets the following formula (12):

$${q}_{10} = \frac{16}{\sqrt{1365}} {e}^{\frac{j π}{4}} {p}_{t 15} + \frac{16}{\sqrt{1365}} {e}^{\frac{j π}{4}} {p}_{t 16} + \frac{8}{\sqrt{1365}} {e}^{\frac{j π}{4}} {p}_{t 17} + \frac{4}{\sqrt{1365}} {e}^{\frac{j π}{4}} {p}_{t 18} + \frac{2}{\sqrt{1365}} {e}^{\frac{j π}{4}} {p}_{t 19} + \frac{1}{\sqrt{1365}} {e}^{\frac{j π}{4}} {p}_{t 20} . \\ {p}_{t 15} = [ {b}_{0} , {d}_{t 15} , 0 , 0 , 0 , 0 , 0 , ( - 1 j ) * {b}_{1} ] ; \\ {p}_{t 16} = [ {b}_{0} , {d}_{t 16} , 0 , 0 , 0 , 0 , 0 , ( - 1 j ) * {b}_{1} ] ; \\ {p}_{t 17} = [ {b}_{0} , {d}_{t 17} , 0 , 0 , 0 , 0 , 0 , ( - 1 j ) * {b}_{1} ] ; \\ {p}_{t 18} = [ {b}_{0} , {d}_{t 18} , 0 , 0 , 0 , 0 , 0 , ( - 1 j ) * {b}_{1} ] ; \\ {p}_{t 19} = [ {b}_{0} , {d}_{t 19} , 0 , 0 , 0 , 0 , 0 , ( - 1 j ) * {b}_{1} ] ; and \\ {p}_{t 20} = [ {b}_{0} , {d}_{t 20} , 0 , 0 , 0 , 0 , 0 , ( - 1 j ) * {b}_{1} ] . \qquad ( 12 )$$

t15 is 5, t16 is 5, t17 is 5, t18 is 1, t19 is 2, and t20 is 5; or t15 is 5, t16 is 5, t17 is 5, t18 is 1, t19 is 1, and t20 is 3; or t15 is 5, t16 is 5, t17 is 1, t18 is 5, t19 is 5, and t20 is 1; or t15 is 5, t16 is 5, t17 is 5, t18 is 5, t19 is 3, and t20 is 3; or t15 is 5, t16 is 5, t17 is 5, t18 is 1, t19 is 1, and t20 is 2; or t15 is 5, t16 is 5, t17 is 5, t18 is 1, t19 is 4, and t20 is 1; or t15 is 5, t16 is 5, t17 is 5, t18 is 4, t19 is 5, and t20 is 1; or t15 is 5, t16 is 5, t17 is 5, t18 is 1, t19 is 4, and t20 is 5. That is, a sequence under 4096-QAM modulation is implemented, so that channel quality of a communication link under 4096-QAM modulation can be accurately measured when the channel quality of the communication link is measured by using the sequence.

Optionally, in Manner 1 to Manner 6, a₀, and a₁ are subsequences in the HE-LTF sequence, and j an imaginary unit. For example, a₀, is one of the first to 489^{th} elements in the HE-LTF sequence, and a₁ is one of the 504^{th} to 1001^{st} elements in the HE-LTF sequence. That is, the first sequence is generated based on the HE-LTF sequence in the 4× mode at the 80 MHz bandwidth in 802.11ax, so that the PAPR of the first sequence is low.

In Manner 1 to Manner 6, c₁=[1j,1j,1j,−1j,−1j,−1j,1j,1j,−1j]; c₂=[−1,−1,−1,−1j,−1j,−1j,1j,1j,−1j]; c₃=[1,−1,−1,1,1,−1j,1j,1j,−1j]; c₄=[−1,−1,−1,1,1,1,1j,1j,−1j]; c₅=[−1,−1,−1,1,1,1,−1,1j,−1j]; c₆=[−1,−1,−1,1,1,1,−1,−1,−1j]; and c₇=[−1,−1,−1,1,1,1,−1,−1,1]. That is, cᵢ is one of the 490^{th} to 498^{th} elements in the first sequence.

Optionally, in Manner 7 to Manner 12, b₀ and b₁ are subsequences in the EHT-LTF sequence, and j an imaginary unit. For example, b₀ is one of the first to 492^{nd} elements in the EHT-LTF sequence, and b₁ is one of the 504^{th} to 1001^{st} elements in the EHT-LTF sequence. That is, the first sequence is generated based on the EHT-LTF sequence in the 4× mode at the 80 MHz bandwidth in 802.11be, so that the PAPR of the first sequence is low.

In Manner 7 to Manner 12, d₁=[1j,1j,1j,−1j,1j, 1j]; d₂=[−1,1j,1j,−1j,1j,1j]; d₃=[−1,−1,−1,−1j,1j,1j]; d₄=[−1,−1,−1,1,−1,1j] ; and d₅=[−1,−1,−1,1,−1,−1]. That is, dᵤ, is one of the 493^{rd} to 498^{th} elements in the first sequence.

Optionally, for Manner 1, it is assumed that the second sequence is s=HE−LTF_{4×}(−500: 500), a transformed position is pos, and the first sequence is ŝ, that is, ŝ(pos)=s(pos)*(−1j). For example, when the second sequence is divided into a plurality of subsequences, the second sequence may be denoted as s=[a₀, c, 0,0,0,0,0, a₁], and c is one of the 490^{th} to 498^{th} elements in the second sequence. For example, the first sequence is s₁. That is, it may be understood as that s₁ is obtained after one of the 490^{th} to 498^{th} elements in s and one of the 504^{th} to 1001^{st} elements in s are transformed. For another example, the first sequence is s₇. That is, it may be understood as that s₇ is obtained after one of the 504^{th} to the 1001^{st} elements in s is transformed.

In addition, the first sequence in any one of Manner 2 to Manner 6 may be understood as being generated based on the first sequence in Manner 1. For example, Manner 1 relates to seven sequences obtained after the second sequence is modulated by using QPSK, that is, s₁ to s₇. A case in which k1 is 1 and k2 is 7 in Manner 2, that is,

$${q}_{1} = \frac{2}{\sqrt{5}} {e}^{\frac{j π}{4}} {s}_{1} + \frac{1}{\sqrt{5}} {e}^{\frac{j π}{4}} {s}_{7} ,$$

may be understood as that q₁ is obtained by using s₁ and s₇ in Manner 1. Similarly, a case in which k3 is 1, k4 is 6, and k5 is 7 in Manner 3, that is,

$${q}_{2} = \frac{4}{\sqrt{21}} {e}^{\frac{j π}{4}} {s}_{1} + \frac{2}{\sqrt{21}} {e}^{\frac{j π}{4}} {s}_{6} + \frac{1}{\sqrt{21}} {e}^{\frac{j π}{4}} {s}_{7} ,$$

may be understood as that q₂ is obtained by using s₁, s₆, and s₇ in the manner.

Optionally, for Manner 7, it is assumed that the second sequence is p=EHT−LTF_{4×}(−500: 500), a transformed position is pos, and the first sequence is \hat{p}, that is, \hat{p}(pos)=p(pos)*(−1j) . A sequence length of the second sequence occupied by the transformed position is about 0.5. For example, when the second sequence is divided into a plurality of subsequences, the second sequence may be denoted as p=[b₀, d, 0,0,0,0,0, b₁], and d is one of the 493^{rd} to 498^{th} elements in the second sequence. For example, the first sequence is pᵢ. That is, it may be understood as that p i is obtained after one of the 493^{rd} to 498^{th} elements in p and one of the 504^{th} to 1001^{st} elements in p are transformed. For another example, the first sequence is p₅. That is, it may be understood as that p₅ is obtained after one of the 504^{th} to the 1001^{st} elements in p is transformed.

In addition, the first sequence in any one of Manner 8 to Manner 12 may be understood as being generated based on the first sequence in Manner 1. For example, Manner 7 relates to five sequences obtained after the second sequence is modulated by using QPSK, that is, p₁ to p₅. A case in which t1 is 5 and t2 is 1 in Manner 2, that is,

$${q}_{6} = \frac{2}{\sqrt{5}} {e}^{\frac{j π}{4}} {p}_{5} + \frac{1}{\sqrt{5}} {e}^{\frac{j π}{4}} {p}_{1} ,$$

may be understood as that q₆ is obtained by using p₁ and p₅ in Manner 1. Similarly, a case in which t3 is 5, t4 is 5, and t5 is 1 in Manner 9, that is,

$${q}_{7} = \frac{4}{\sqrt{21}} {e}^{\frac{j π}{4}} {p}_{5} + \frac{2}{\sqrt{21}} {e}^{\frac{j π}{4}} {p}_{5} + \frac{1}{\sqrt{21}} {e}^{\frac{j π}{4}} {p}_{1} ,$$

may be understood as that q₇ is obtained by using p₅, p₅, and p₁ in the manner.

602: The second device receives the sounding frame.

Correspondingly, the first device sends the sounding frame.

For example, operation 602 may include: The second device receives the sounding frame from the first device. Correspondingly, the first device sends the sounding frame to the second device.

603: The second device performs channel measurement based on the first sequence.

It can be learned that, in the foregoing technical solution, the first device sends the sounding frame. The sounding frame includes the first field, the first field includes the predefined first sequence, the first sequence includes the sequence obtained after the second sequence is modulated by using at least one of the following modulation modes, and the modulation modes include: QPSK, 16-QAM, 64-QAM, 256-QAM, 1024-QAM, and 4096-QAM. Therefore, after receiving the sounding frame, the second device may perform channel measurement based on the first sequence. Therefore, the second device may measure channel quality of a communication link in at least one of the modulation modes of QPSK, 16-QAM, 64-QAM, 256-QAM, 1024-QAM, and 4096-QAM when performing channel measurement by using the first sequence, thereby enriching application scenarios of the HE-LTF sequence or the EHT-LTF sequence. In addition, because the PAPR of the first sequence is low, distortion of the first sequence is small, so that the second device can accurately measure the channel quality of the communication link in at least one of the modulation modes of QPSK, 16-QAM, 64-QAM, 256-QAM, 1024-QAM, and 4096-QAM when performing channel measurement by using the first sequence.

In addition, based on the 80 MHz tone design shown in FIG. 3, a corresponding sounding frame format is defined in this application. FIG. 7 is a schematic diagram of a frame structure of a sounding frame according to an embodiment of this application. As shown in FIG. 7, the sounding frame includes an L-STF, an L-LTF, an L-SIG, a repeated legacy short training field (RL-STF), a universal signal (U-SIG) field, an extremely high throughput signal (EHT-SIG) field, an extremely high throughput short training field (EHT-STF), a long training field (L-LTF), and a PE field. The LTF field includes binary phase shift keying long training fields (BPSK LTFs) and 4^{q}-QAM-LTFs fields. It may be understood that the BPSK LTFs may include at least one extremely high throughput long training field (EHT-LTF). The 4^{q}-QAM-LTFs fields may include at least one 4^{q}-QAM-LTF field.

It should be noted that in this application, in a case in which the second sequence is the EHT-LTF sequence in the 4× mode at the 80 MHz bandwidth in 802.11be, and the first sequence may be included in the 4^{q}-QAM-LTFs fields. For example, a sequence obtained after the second sequence is modulated by using 16-QAM may be included in a 4²-QAM-LTF field, and a sequence obtained after the second sequence is modulated by using 64-QAM may be included in a 4³-QAM-LTF field.

It should be noted that in this application, a sum of differences between a peak to average power ratio (PAPR) of a first subsequence corresponding to each of at least one RU in any sequence included in the first sequence and a PAPR of a corresponding RU in the second sequence is less than or equal to a preset threshold. One RU may include one of the following: a 26-tone RU, a 52-tone RU, a 106-tone RU, a 242-tone RU, a 484-tone RU, and a 996-tone RU. The first subsequence is a subsequence with a maximum PAPR in subsequences corresponding to one RU. For example, in a case in which a transmission bandwidth is 80 MHz, 36 26-tone RUs are distributed on the transmission bandwidth, a subsequence corresponding to each 26-tone RU corresponds to one PAPR, and a first subsequence is a subsequence with a maximum PAPR in the 36 26-tone RUs. For example, in a case in which a transmission bandwidth is 80 MHz, 18 52-tone RUs are distributed on the transmission bandwidth, a subsequence corresponding to each 52-tone RU corresponds to one PAPR, and a first subsequence is a subsequence with a maximum PAPR in the 18 52-tone RUs. It may be understood that, in this embodiment of this application, an RU including K tones is referred to as a K-tone RU. For example, a 26-tone RU is an RU including 26 tones. That is, a concept of the K-tone RU is the same as that of a K-tone RU in the existing 802.11ax standard.

In addition, the preset threshold is a value predefined in a protocol. This is not limited in this application.

In this application, the sum of the differences between the PAPR of the first subsequence corresponding to each of at least one RU in any sequence included in the first sequence and the PAPR of the corresponding RU in the second sequence is less than or equal to the preset threshold. That is, it means that the PAPR of the first subsequence corresponding to each of at least one RU in any sequence included in the first sequence is close to the PAPR of the corresponding RU in the second sequence. The second sequence can support an AP or a STA in performing channel measurement, and a transmit power of the second sequence has relatively high power efficiency. Therefore, a transmit power of a first sequence having a PAPR close to that of the second sequence also has relatively high power efficiency. That is, the first sequence whose PAPR is close to that of the second sequence can also relatively well support the AP or the STA in performing channel measurement.

For example, it is assumed that the sum of the differences between the PAPR of the first subsequence corresponding to each of at least one RU in any sequence included in the first sequence and the PAPR of the corresponding RU in the second sequence is δ. For Manner 1, it may be set that δ=Σₓ₌₁⁶|PAPRₛ(x)−PAPR_{ŝ}(x)|. PAPRₛ(x) is a PAPR corresponding to an RU in the second sequence, and PAPR_{ŝ}(x) may be a PAPR of a subsequence with a maximum PAPR in subsequences corresponding to the RU in any sequence included in the first sequence. For example, PAPRₛ(1) may be a PAPR corresponding to a 26-tone RU in the second sequence, and PAPR_{ŝ}(1) may be a PAPR of a subsequence with a maximum PAPR in subsequences corresponding to the 26-tone RU in any sequence included in the first sequence. PAPRₛ(2) is a PAPR corresponding to a 52-tone RU in the second sequence, and PAPR_{ŝ}(2) is a PAPR of a subsequence with a maximum PAPR in subsequences corresponding to the 52-tone RU in any sequence included in the first sequence. PAPRₛ(3) is a PAPR corresponding to a 106-tone RU in the second sequence, and PAPR_{ŝ}(3) is a PAPR of a subsequence with a maximum PAPR in subsequences corresponding to the 106-tone RU in any sequence included in the first sequence. PAPRₛ(4) is a PAPR corresponding to a 242-tone RU in the second sequence, and PAPR_{ŝ}(4) is a PAPR of a subsequence with a maximum PAPR in subsequences corresponding to the 242-tone RU in any sequence included in the first sequence. PAPRₛ(5) is a PAPR corresponding to a 484-tone RU in the second sequence, and PAPR_{ŝ}(5) is a PAPR of a subsequence with a maximum PAPR in subsequences corresponding to the 484-tone RU in any sequence included in the first sequence. PAPRₛ(6) is a PAPR corresponding to a 996-tone RU in the second sequence, and PAPR_{ŝ}(6) is a PAPR of a subsequence with a maximum PAPR in subsequences corresponding to the 996-tone RU in any sequence included in the first sequence. It may be understood that the foregoing descriptions of PAPRₛ(1) to PAPRₛ(6) and PAPR_{ŝ}(1) to PAPR_{ŝ}(6) are merely examples, and there may be other cases. Details are not described herein again. It should be noted that, PAPRₛ(1) to PAPRₛ(6) should be PAPRs corresponding to different RUs in the second sequence, and PAPR_{ŝ}(1) to PAPR_{ŝ}(6) are also PAPRs of subsequences with maximum PAPRs in subsequences corresponding to different RUs in any sequence included in the first sequence. In addition, PAPRₛ(x) and PAPR_{ŝ}(x) correspond to a same RU when a value of x is the same. For Manner 7, it may be set that δ=Σₓ₌₁⁶|PAPRₚ(x)−PAPR_{\hat{p}}(x)|. PAPRₚ(x) is a PAPR corresponding to an RU in the second sequence, and PAPR_{\hat{p}}(x) may be a PAPR of a subsequence with a maximum PAPR in subsequences corresponding to the RU in any sequence included in the first sequence. In addition, when a value of x is different, for meanings represented by PAPRₚ(x) and PAPR_{\hat{p}}(x), refer to PAPRₛ(x) and PAPR_{ŝ}(x) respectively. Details are not described herein again. It should be noted that, in this application, δ in Table 1 to Table 12 is less than or equal to the preset threshold, and a PAPR of the first sequence in Table 1 to Table 12 is close to a PAPR of the second sequence. The second sequence can support an AP or a STA in performing channel measurement, and a transmit power of the second sequence has relatively high power efficiency. Therefore, in Table 1 to Table 12, a transmit power of a first sequence having a PAPR close to that of the second sequence also has relatively high power efficiency. That is, the first sequence whose PAPR is close to that of the second sequence can also relatively well support the AP or the STA in performing channel measurement.

In a case in which the second sequence is the HE-LTF sequence in the 4× mode at the 80 MHz bandwidth in 802.11ax, for PAPRs of the first sequence and the second sequence under different RUs in Manner 1, refer to Table 1. With reference to Table 1, it can be learned that, when i=1 in Manner 1, a PAPR of a subsequence with a maximum PAPR in subsequences corresponding to the 26-tone RU in s₁ is 7.0810 dB, a PAPR of a subsequence with a maximum PAPR in subsequences corresponding to the 52-tone RU in s₁ is 7.6445 dB, a PAPR of a subsequence with a maximum PAPR in subsequences corresponding to the 106-tone RU in s₁ is 6.6954 dB, a PAPR of a subsequence with a maximum PAPR in subsequences corresponding to the 242-tone RU in s₁ is 6.9515 dB, a PAPR of a subsequence with a maximum PAPR in subsequences corresponding to the 484-tone RU in s₁ is 6.5287 dB, and a PAPR of a subsequence with a maximum PAPR in subsequences corresponding to the 996-tone RU in s₁ is 7.4502 dB. Therefore, δ corresponding to s₁ is 0.1551, and 0.1551 is less than the preset threshold. That is, it means that a PAPR of s₁ is close to that of the second sequence. Therefore, it indicates that a transmit power of s₁ also has relatively high power efficiency, and can well support the AP or the STA in performing channel measurement. Similarly, when i=2 in Manner 1, for PAPRs of s₂ under different RUs, refer to Table 1, and 6 corresponding to s₂ is 0.2086. When i=3 in Manner 1, for PAPRs of s₃ under different RUs, refer to Table 1, and 6 corresponding to s₃ is 0.1144. When i=4 in Manner 1, for PAPRs of s₄ under different RUs, refer to Table 1, and 6 corresponding to s₄ is 0.0507. When i=5 in Manner 1, for PAPRs of s₅ under different RUs, refer to Table 1, and 6 corresponding to s₅ is 0.1046. When i=6 in Manner 1, for PAPRs of s₆ under different RUs, refer to Table 1, and 6 corresponding to s₆ is 0.1519. When i=7 in Manner 1, for PAPRs of s₇ under different RUs, refer to Table 1, and 6 corresponding to s₇ is 0.0669. That is, 0.2086, 0.1144, 0.0507, and the like are all less than the preset threshold. That is, it means that PAPRs of s₂, s₃, s₄, and the like are close to that of the second sequence, thereby indicating that transmit powers of s₂, s₃, s₄, and the like also have relatively high power efficiency, and can well support the AP or the STA in performing channel measurement. In addition, in Table 1 to Table 6, a PAPR corresponding to the 26-tone RU in the second sequence is 7.0810 dB, a PAPR corresponding to the 52-tone RU in the second sequence is 7.6445 dB, a PAPR corresponding to the 106-tone RU in the second sequence is 6.6954 dB, a PAPR corresponding to the 242-tone RU in the second sequence is 6.9515 dB, a PAPR corresponding to the 484-tone RU in the second sequence is 6.5287 dB, and a PAPR corresponding to the 996-tone RU in the second sequence is 7.2951 dB. Details are not described subsequently.

TABLE 1
PAPRs of the first sequence and the second sequence under different RUs in
Manner 1

| | 26-tone | 52-tone | 106-tone | 242-tone | 484-tone | 996-tone |
|---|---|---|---|---|---|---|
| | RU | RU | RU | RU | RU | RU |
| PAPRs of s₁ under | 7.0810 dB | 7.6445 dB | 6.6954 dB | 6.9515 dB | 6.5287 dB | 7.4502 dB |
| different RUs | | | | | | |
| PAPRs of s₂ under | 7.0810 dB | 7.6445 dB | 6.6954 dB | 6.9515 dB | 6.5287 dB | 7.5037 dB |
| different RUs | | | | | | |
| PAPRs of s₃ under | 7.0810 dB | 7.6445 dB | 6.6954 dB | 6.9515 dB | 6.5287 dB | 7.4095 dB |
| different RUs | | | | | | |
| PAPRs of s₄ under | 7.0810 dB | 7.6445 dB | 6.6954 dB | 6.9515 dB | 6.5287 dB | 7.3458 dB |
| different RUs | | | | | | |
| PAPRs of s₅ under | 7.0810 dB | 7.6445 dB | 6.6954 dB | 6.9515 dB | 6.5287 dB | 7.1905 dB |
| different RUs | | | | | | |
| PAPRs of s₆ under | 7.0810 dB | 7.6445 dB | 6.6954 dB | 6.9515 dB | 6.5287 dB | 7.1432 dB |
| different RUs | | | | | | |
| PAPRs of s₇ under | 7.0810 dB | 7.6445 dB | 6.6954 dB | 6.9515 dB | 6.5287 dB | 7.2282 dB |
| different RUs | | | | | | |
| PAPRs of the second | 7.0810 dB | 7.6445 dB | 6.6954 dB | 6.9515 dB | 6.5287 dB | 7.2951 dB |
| sequence under | | | | | | |
| different RUs | | | | | | |

In a case in which the second sequence is the HE-LTF sequence in the 4× mode at the 80 MHz bandwidth in 802.11ax, for PAPRs of the first sequence and the second sequence under different RUs in Manner 2, refer to Table 2. It may be understood that, in this application, q₁ (1,7) may be understood as that

$${q}_{1} = \frac{2}{\sqrt{5}} {e}^{\frac{j π}{4}} {s}_{1} + \frac{1}{\sqrt{5}} {e}^{\frac{j π}{4}} {s}_{7} .$$

That is, k1 is 1, and k2 is 7. Similarly, q₁ (4,5) may be understood as that

$${q}_{1} = \frac{2}{\sqrt{5}} {e}^{\frac{j π}{4}} {s}_{4} + \frac{1}{\sqrt{5}} {e}^{\frac{j π}{4}} {s}_{5} .$$

That is, k1 is 4, and k2 is 5. For others such as q₁ (4,6) in Table 2, refer to an understanding manner of q₁ (1,7), and details are not described herein again. In addition, with reference to Table 2, when

$${q}_{1} = \frac{2}{\sqrt{5}} {e}^{\frac{j π}{4}} {s}_{1} + \frac{1}{\sqrt{5}} {e}^{\frac{j π}{4}} {s}_{7} ,$$

a PAPR of a subsequence with a maximum PAPR in subsequences corresponding to the 26-tone RU in q₁ is 7.0810 dB, a PAPR of a subsequence with a maximum PAPR in subsequences corresponding to the 52-tone RU in q₁ is 7.6445 dB, a PAPR of a subsequence with a maximum PAPR in subsequences corresponding to the 106-tone RU in q₁ is 6.6954 dB, a PAPR of a subsequence with a maximum PAPR in subsequences corresponding to the 242-tone RU in q₁ is 6.9515 dB, a PAPR of a subsequence with a maximum PAPR in subsequences corresponding to the 484-tone RU in q₁ is 6.5287 dB, and a PAPR of a subsequence with a maximum PAPR in subsequences corresponding to the 996-tone RU in q₁ is 7.3083 dB. Therefore, when

$${q}_{1} = \frac{2}{\sqrt{5}} {e}^{\frac{j π}{4}} {s}_{1} + \frac{1}{\sqrt{5}} {e}^{\frac{j π}{4}} {s}_{7} ,$$

δ is 0.0132. Similarly, when

$${q}_{1} = \frac{2}{\sqrt{5}} {e}^{\frac{j π}{4}} {s}_{4} + \frac{1}{\sqrt{5}} {e}^{\frac{j π}{4}} {s}_{5} ,$$

for PAPRs of q₁ under different RUs, refer to Table 2, and δ is 0.0011. When

$${q}_{1} = \frac{2}{\sqrt{5}} {e}^{\frac{j π}{4}} {s}_{4} + \frac{1}{\sqrt{5}} {e}^{\frac{j π}{4}} {s}_{6} ,$$

for PAPRs of q₁ under different RUs, refer to Table 2, and δ is 0.0191. When

$${q}_{1} = \frac{2}{\sqrt{5}} {e}^{\frac{j π}{4}} {s}_{5} + \frac{1}{\sqrt{5}} {e}^{\frac{j π}{4}} {s}_{1} ,$$

for PAPRs of q₁ under different RUs, refer to Table 2, and δ is 0.0047. When

$${q}_{1} = \frac{2}{\sqrt{5}} {e}^{\frac{j π}{4}} {s}_{5} + \frac{1}{\sqrt{5}} {e}^{\frac{j π}{4}} {s}_{2} ,$$

for PAPRs of q₁ under different RUs, refer to Table 2, and δ is 0.0086.

TABLE 2
PAPRs of the first sequence and the second sequence under different RUs in
Manner 2

| | 26-tone | 52-tone | 106-tone | 242-tone | 484-tone | 996-tone |
|---|---|---|---|---|---|---|
| | RU | RU | RU | RU | RU | RU |
| PAPRs of q₁(1, 7) | 7.0810 dB | 7.6445 dB | 6.6954 dB | 6.9515 dB | 6.5287 dB | 7.3083 dB |
| under different RUs | | | | | | |
| PAPRs of q₁(4, 5) | 7.0810 dB | 7.6445 dB | 6.6954 dB | 6.9515 dB | 6.5287 dB | 7.2962 dB |
| under different RUs | | | | | | |
| PAPRs of q₁(4, 6) | 7.0810 dB | 7.6445 dB | 6.6954 dB | 6.9515 dB | 6.5287 dB | 7.2761 dB |
| under different RUs | | | | | | |
| PAPRs of q₁(5, 1) | 7.0810 dB | 7.6445 dB | 6.6954 dB | 6.9515 dB | 6.5287 dB | 7.2905 dB |
| under different RUs | | | | | | |
| PAPRs of q₁(5, 2) | 7.0810 dB | 7.6445 dB | 6.6954 dB | 6.9515 dB | 6.5287 dB | 7.6037 dB |
| under different RUs | | | | | | |
| PAPRs of the | 7.0810 dB | 7.6445 dB | 6.6954 dB | 6.9515 dB | 6.5287 dB | 7.2951 dB |
| second sequence | | | | | | |
| under different RUs | | | | | | |

In a case in which the second sequence is the HE-LTF sequence in the 4× mode at the 80 MHz bandwidth in 802.11ax, for PAPRs of the first sequence and the second sequence under different RUs in Manner 3, refer to Table 3. It may be understood that, in this application, q₂ (1,6,7) may be understood as that

$${q}_{2} = \frac{4}{\sqrt{21}} {e}^{\frac{j π}{4}} {s}_{1} + \frac{2}{\sqrt{21}} {e}^{\frac{j π}{4}} {s}_{6} + \frac{1}{\sqrt{21}} {e}^{\frac{j π}{4}} {s}_{7} .$$

That is, k3 is 1, k4 is 6, and k5 is 7. Similarly, q₂ (1,7,5) may be understood as that

$${q}_{2} = \frac{4}{\sqrt{21}} {e}^{\frac{j π}{4}} {s}_{1} + \frac{2}{\sqrt{21}} {e}^{\frac{j π}{4}} {s}_{7} + \frac{1}{\sqrt{21}} {e}^{\frac{j π}{4}} {s}_{5} .$$

That is, k3 is 1, k4 is 7, and k5 is 5. For others such as q₂ (1,7,6) in Table 3, refer to an understanding manner of q₂ (1,6,7), and details are not described herein again. In addition, with reference to Table 3, when

$${q}_{2} = \frac{4}{\sqrt{21}} {e}^{\frac{j π}{4}} {s}_{1} + \frac{2}{\sqrt{21}} {e}^{\frac{j π}{4}} {s}_{6} + \frac{1}{\sqrt{21}} {e}^{\frac{j π}{4}} {s}_{7} ,$$

a PAPR of a subsequence with a maximum PAPR in subsequences corresponding to the 26-tone RU in q₂ is 7.0810 dB, a PAPR of a subsequence with a maximum PAPR in subsequences corresponding to the 52-tone RU in q₂ is 7.6445 dB, a PAPR of a subsequence with a maximum PAPR in subsequences corresponding to the 106-tone RU in q₂ is 6.6954 dB, a PAPR of a subsequence with a maximum PAPR in subsequences corresponding to the 242-tone RU in q₂ is 6.9515 dB, a PAPR of a subsequence with a maximum PAPR in subsequences corresponding to the 484-tone RU in q₂ is 6.5287 dB, and a PAPR of a subsequence with a maximum PAPR in subsequences corresponding to the 996-tone RU in q₂ is 7.3074 dB. Therefore, when

$${q}_{2} = \frac{4}{\sqrt{21}} {e}^{\frac{j π}{4}} {s}_{1} + \frac{2}{\sqrt{21}} {e}^{\frac{j π}{4}} {s}_{6} + \frac{1}{\sqrt{21}} {e}^{\frac{j π}{4}} {s}_{7} ,$$

δ is 0.0123. Similarly, when

$${q}_{2} = \frac{4}{\sqrt{21}} {e}^{\frac{j π}{4}} {s}_{1} + \frac{2}{\sqrt{21}} {e}^{\frac{j π}{4}} {s}_{7} + \frac{1}{\sqrt{21}} {e}^{\frac{j π}{4}} {s}_{5} ,$$

for PAPRs of q₂ under different RUs, refer to Table 3, and δ is 0.0003. In addition, for remaining cases in Table 3, δ is successively 0.0091, 0.0161, 0.0056, 0.0167, 0.0041, 0.0077, 0.0015, 0.0069, 0.0121, 0.0036, 0.0125, 0.0005, 0.0185, 0.0083, 0.0135, 0.0124, 0.0173, 0.0012, 0.0088, 0.0138, 0.0044, 0.0181, 0.0154, 0.0071, 0.0156, 0.0046, 0.0098, 0.0059, 0.0155, 0.0146, 0.0096, 0.0133, 0.0066, 0.0008, 0.0039, and 0.0109 from top to bottom.

TABLE 3
PAPRs of the first sequence and the second sequence under different RUs in
Manner 3

| | 26-tone | 52-tone | 106-tone | 242-tone | 484-tone | 996-tone |
|---|---|---|---|---|---|---|
| | RU | RU | RU | RU | RU | RU |
| PAPRs of q₂(1, 6, 7) | 7.0810 dB | 7.6445 dB | 6.6954 dB | 6.9515 dB | 6.5287 dB | 7.3074 dB |
| under different RUs | | | | | | |
| PAPRs of q₂(1, 7, 5) | 7.0810 dB | 7.6445 dB | 6.6954 dB | 6.9515 dB | 6.5287 dB | 7.2948 dB |
| under different RUs | | | | | | |
| PAPRs of q₂(1, 7, 6) | 7.0810 dB | 7.6445 dB | 6.6954 dB | 6.9515 dB | 6.5287 dB | 7.2860 dB |
| under different RUs | | | | | | |
| PAPRs of q₂(2, 7, 6) | 7.0810 dB | 7.6445 dB | 6.6954 dB | 6.9515 dB | 6.5287 dB | 7.3112 dB |
| under different RUs | | | | | | |
| PAPRs of q₂(2, 7, 7) | 7.0810 dB | 7.6445 dB | 6.6954 dB | 6.9515 dB | 6.5287 dB | 7.2896 dB |
| under different RUs | | | | | | |
| PAPRs of q₂(3, 5, 6) | 7.0810 dB | 7.6445 dB | 6.6954 dB | 6.9515 dB | 6.5287 dB | 7.3118 dB |
| under different RUs | | | | | | |
| PAPRs of q₂(3, 5, 7) | 7.0810 dB | 7.6445 dB | 6.6954 dB | 6.9515 dB | 6.5287 dB | 7.2911 dB |
| under different RUs | | | | | | |
| PAPRs of q₂(3, 6, 5) | 7.0810 dB | 7.6445 dB | 6.6954 dB | 6.9515 dB | 6.5287 dB | 7.6029 dB |
| under different RUs | | | | | | |
| PAPRs of q₂(3, 6, 6) | 7.0810 dB | 7.6445 dB | 6.6954 dB | 6.9515 dB | 6.5287 dB | 7.2936 dB |
| under different RUs | | | | | | |
| PAPRs of q₂(3, 7, 1) | 7.0810 dB | 7.6445 dB | 6.6954 dB | 6.9515 dB | 6.5287 dB | 7.6021 dB |
| under different RUs | | | | | | |
| PAPRs of q₂(3, 7, 2) | 7.0810 dB | 7.6445 dB | 6.6954 dB | 6.9515 dB | 6.5287 dB | 7.3072 dB |
| under different RUs | | | | | | |
| PAPRs of q₂(3, 7, 3) | 7.0810 dB | 7.6445 dB | 6.6954 dB | 6.9515 dB | 6.5287 dB | 7.2915 dB |
| under different RUs | | | | | | |
| PAPRs of q₂(3, 7, 4) | 7.0810 dB | 7.6445 dB | 6.6954 dB | 6.9515 dB | 6.5287 dB | 7.2826 dB |
| under different RUs | | | | | | |
| PAPRs of q₂(4, 4, 7) | 7.0810 dB | 7.6445 dB | 6.6954 dB | 6.9515 dB | 6.5287 dB | 7.2956 dB |
| under different RUs | | | | | | |
| PAPRs of q₂(4, 5, 3) | 7.0810 dB | 7.6445 dB | 6.6954 dB | 6.9515 dB | 6.5287 dB | 7.3136 dB |
| under different RUs | | | | | | |
| PAPRs of q₂(4, 5, 4) | 7.0810 dB | 7.6445 dB | 6.6954 dB | 6.9515 dB | 6.5287 dB | 7.6035 dB |
| under different RUs | | | | | | |
| PAPRs of q₂(4, 5, 5) | 7.0810 dB | 7.6445 dB | 6.6954 dB | 6.9515 dB | 6.5287 dB | 7.2817 dB |
| under different RUs | | | | | | |
| PAPRs of q₂(4, 6, 1) | 7.0810 dB | 7.6445 dB | 6.6954 dB | 6.9515 dB | 6.5287 dB | 7.3076 dB |
| under different RUs | | | | | | |
| PAPRs of q₂(4, 6, 2) | 7.0810 dB | 7.6445 dB | 6.6954 dB | 6.9515 dB | 6.5287 dB | 7.3124 dB |
| under different RUs | | | | | | |
| PAPRs of q₂(4, 6, 3) | 7.0810 dB | 7.6445 dB | 6.6954 dB | 6.9515 dB | 6.5287 dB | 7.2963 dB |
| under different RUs | | | | | | |
| PAPRs of q₂(4, 6, 4) | 7.0810 dB | 7.6445 dB | 6.6954 dB | 6.9515 dB | 6.5287 dB | 7.2863 dB |
| under different RUs | | | | | | |
| PAPRs of q₂(5, 1, 3) | 7.0810 dB | 7.6445 dB | 6.6954 dB | 6.9515 dB | 6.5287 dB | 7.3089 dB |
| under different RUs | | | | | | |
| PAPRs of q₂(5, 1, 4) | 7.0810 dB | 7.6445 dB | 6.6954 dB | 6.9515 dB | 6.5287 dB | 7.2996 dB |
| under different RUs | | | | | | |
| PAPRs of q₂(5, 1, 5) | 7.0810 dB | 7.6445 dB | 6.6954 dB | 6.9515 dB | 6.5287 dB | 7.2770 dB |
| under different RUs | | | | | | |
| PAPRs of q₂(5, 2, 4) | 7.0810 dB | 7.6445 dB | 6.6954 dB | 6.9515 dB | 6.5287 dB | 7.3106 dB |
| under different RUs | | | | | | |
| PAPRs of q₂(5, 2, 5) | 7.0810 dB | 7.6445 dB | 6.6954 dB | 6.9515 dB | 6.5287 dB | 7.2881 dB |
| under different RUs | | | | | | |
| PAPRs of q₂(5, 2, 6) | 7.0810 dB | 7.6445 dB | 6.6954 dB | 6.9515 dB | 6.5287 dB | 7.2796 dB |
| under different RUs | | | | | | |
| PAPRs of q₂(5, 3, 1) | 7.0810 dB | 7.6445 dB | 6.6954 dB | 6.9515 dB | 6.5287 dB | 7.2998 dB |
| under different RUs | | | | | | |
| PAPRs of q₂(5, 3, 2) | 7.0810 dB | 7.6445 dB | 6.6954 dB | 6.9515 dB | 6.5287 dB | 7.3049 dB |
| under different RUs | | | | | | |
| PAPRs of q₂(5, 3, 3) | 7.0810 dB | 7.6445 dB | 6.6954 dB | 6.9515 dB | 6.5287 dB | 7.2892 dB |
| under different RUs | | | | | | |
| PAPRs of q₂(5, 3, 4) | 7.0810 dB | 7.6445 dB | 6.6954 dB | 6.9515 dB | 6.5287 dB | 7.2796 dB |
| under different RUs | | | | | | |
| PAPRs of q₂(5, 4, 1) | 7.0810 dB | 7.6445 dB | 6.6954 dB | 6.9515 dB | 6.5287 dB | 7.2805 dB |
| under different RUs | | | | | | |
| PAPRs of q₂(5, 4, 2) | 7.0810 dB | 7.6445 dB | 6.6954 dB | 6.9515 dB | 6.5287 dB | 7.2856 dB |
| under different RUs | | | | | | |
| PAPRs of q₂(6, 1, 1) | 7.0810 dB | 7.6445 dB | 6.6954 dB | 6.9515 dB | 6.5287 dB | 7.2818 dB |
| under different RUs | | | | | | |
| PAPRs of q₂(6, 1, 2) | 7.0810 dB | 7.6445 dB | 6.6954 dB | 6.9515 dB | 6.5287 dB | 7.2886 dB |
| under different RUs | | | | | | |
| PAPRs of q₂(6, 2, 1) | 7.0810 dB | 7.6445 dB | 6.6954 dB | 6.9515 dB | 6.5287 dB | 7.2943 dB |
| under different RUs | | | | | | |
| PAPRs of q₂(6, 2, 2) | 7.0810 dB | 7.6445 dB | 6.6954 dB | 6.9515 dB | 6.5287 dB | 7.2990 dB |
| under different RUs | | | | | | |
| PAPRs of q₂(6, 2, 3) | 7.0810 dB | 7.6445 dB | 6.6954 dB | 6.9515 dB | 6.5287 dB | 7.2842 dB |
| under different RUs | | | | | | |
| PAPRs of the second | 7.0810 dB | 7.6445 dB | 6.6954 dB | 6.9515 dB | 6.5287 dB | 7.2951 dB |
| sequence under | | | | | | |
| different RUs | | | | | | |

In a case in which the second sequence is the HE-LTF sequence in the 4× mode at the 80 MHz bandwidth in 802.11ax, for PAPRs of the first sequence and the second sequence under different RUs in Manner 4, refer to Table 4. It may be understood that, in this application,

q₃ (1,7,4,7) may be understood as that That

$${q}_{3} = \frac{8}{\sqrt{85}} {e}^{\frac{j π}{4}} {s}_{1} + \frac{4}{\sqrt{85}} {e}^{\frac{j π}{4}} {s}_{7} + \frac{2}{\sqrt{85}} {e}^{\frac{j π}{4}} {s}_{4} + \frac{1}{\sqrt{85}} {e}^{\frac{j π}{4}} {s}_{7} .$$

is, k6 is 1, k7 is 7, k8 is 4, and k9 is 7. Similarly, q₃ (1,7,6,3) may be understood as that

$${q}_{3} = \frac{8}{\sqrt{85}} {e}^{\frac{j π}{4}} {s}_{1} + \frac{4}{\sqrt{85}} {e}^{\frac{j π}{4}} {s}_{7} + \frac{2}{\sqrt{85}} {e}^{\frac{j π}{4}} {s}_{6} + \frac{1}{\sqrt{85}} {e}^{\frac{j π}{4}} {s}_{3} .$$

That is, k6 is 1, k7 is 7, k8 is 6, and k9 is 3. For others such as q₃ (2,7,7,4) in Table 4, refer to an understanding manner of q₃ (1,7,4,7), and details are not described herein again. In addition, with reference to Table 4, when

$${q}_{3} = \frac{8}{\sqrt{85}} {e}^{\frac{j π}{4}} {s}_{1} + \frac{4}{\sqrt{85}} {e}^{\frac{j π}{4}} {s}_{7} + \frac{2}{\sqrt{85}} {e}^{\frac{j π}{4}} {s}_{4} + \frac{1}{\sqrt{85}} {e}^{\frac{j π}{4}} {s}_{7} ,$$

a PAPR of a subsequence with a maximum PAPR in subsequences corresponding to the 26-tone RU in q₃ is 7.0810 dB, a PAPR of a subsequence with a maximum PAPR in subsequences corresponding to the 52-tone RU in q₃ is 7.6445 dB, a PAPR of a subsequence with a maximum PAPR in subsequences corresponding to the 106-tone RU in q₃ is 6.6954 dB, a PAPR of a subsequence with a maximum PAPR in subsequences corresponding to the 242-tone RU in q₃ is 6.9515 dB, a PAPR of a subsequence with a maximum PAPR in subsequences corresponding to the 484-tone RU in q₃ is 6.5287 dB, and a PAPR of a subsequence with a maximum PAPR in subsequences corresponding to the 996-tone RU in q₃ is 7.2955 dB. Therefore, when

$${q}_{3} = \frac{8}{\sqrt{85}} {e}^{\frac{j π}{4}} {s}_{1} + \frac{4}{\sqrt{85}} {e}^{\frac{j π}{4}} {s}_{7} + \frac{2}{\sqrt{85}} {e}^{\frac{j π}{4}} {s}_{4} + \frac{1}{\sqrt{85}} {e}^{\frac{j π}{4}} {s}_{7} ,$$

δ is 0.0004. Similarly, when

$${q}_{3} = \frac{8}{\sqrt{85}} {e}^{\frac{j π}{4}} {s}_{1} + \frac{4}{\sqrt{85}} {e}^{\frac{j π}{4}} {s}_{7} + \frac{2}{\sqrt{85}} {e}^{\frac{j π}{4}} {s}_{6} + \frac{1}{\sqrt{85}} {e}^{\frac{j π}{4}} {s}_{3} ,$$

for PAPRs of q₃ under different RUs, refer to Table 4, and δ is 0.0001. In addition, for remaining cases in Table 4, δ is successively 0.0010, 0.0001, 0.0007, 0.0002, 0.0007, 0.0004, 0.0003, 0.0009, 0.0000, 0.0002, 0.0007, 0.0008, 0.0007, and 0.0006 from top to bottom.

TABLE 4
PAPRs of the first sequence and the second sequence under different RUs in
Manner 4

| | 26-tone | 52-tone | 106-tone | 242-tone | 484-tone | 996-tone |
|---|---|---|---|---|---|---|
| | RU | RU | RU | RU | RU | RU |
| PAPRs of q₃(1, 7, 4, 7) | 7.0810 dB | 7.6445 dB | 6.6954 dB | 6.9515 dB | 6.5287 dB | 7.2955 dB |
| under different RUs | | | | | | |
| PAPRs of q₃(1, 7, 6, 3) | 7.0810 dB | 7.6445 dB | 6.6954 dB | 6.9515 dB | 6.5287 dB | 7.2952 dB |
| under different RUs | | | | | | |
| PAPRs of q₃(2, 7, 7, 4) | 7.0810 dB | 7.6445 dB | 6.6954 dB | 6.9515 dB | 6.5287 dB | 7.2942 dB |
| under different RUs | | | | | | |
| PAPRs of q₃(3, 5, 7, 4) | 7.0810 dB | 7.6445 dB | 6.6954 dB | 6.9515 dB | 6.5287 dB | 7.2950 dB |
| under different RUs | | | | | | |
| PAPRs of q₃(3, 6, 5, 5) | 7.0810 dB | 7.6445 dB | 6.6954 dB | 6.9515 dB | 6.5287 dB | 7.2958 dB |
| under different RUs | | | | | | |
| PAPRs of q₃(3, 7, 1, 5) | 7.0810 dB | 7.6445 dB | 6.6954 dB | 6.9515 dB | 6.5287 dB | 7.2954 dB |
| under different RUs | | | | | | |
| PAPRs of q₃(3, 7, 2, 6) | 7.0810 dB | 7.6445 dB | 6.6954 dB | 6.9515 dB | 6.5287 dB | 7.2958 dB |
| under different RUs | | | | | | |
| PAPRs of q₃(3, 7, 3, 4) | 7.0810 dB | 7.6445 dB | 6.6954 dB | 6.9515 dB | 6.5287 dB | 7.2955 dB |
| under different RUs | | | | | | |
| PAPRs of q₃(4, 4, 6, 7) | 7.0810 dB | 7.6445 dB | 6.6954 dB | 6.9515 dB | 6.5287 dB | 7.2948 dB |
| under different RUs | | | | | | |
| PAPRs of q₃(4, 6, 1, 6) | 7.0810 dB | 7.6445 dB | 6.6954 dB | 6.9515 dB | 6.5287 dB | 7.2960 dB |
| under different RUs | | | | | | |
| PAPRs of q₃(4, 6, 4, 3) | 7.0810 dB | 7.6445 dB | 6.6954 dB | 6.9515 dB | 6.5287 dB | 7.2951 dB |
| under different RUs | | | | | | |
| PAPRs of q₃(5, 1, 1, 7) | 7.0810 dB | 7.6445 dB | 6.6954 dB | 6.9515 dB | 6.5287 dB | 7.2953 dB |
| under different RUs | | | | | | |
| PAPRs of q₃(5, 2, 6, 2) | 7.0810 dB | 7.6445 dB | 6.6954 dB | 6.9515 dB | 6.5287 dB | 7.2958 dB |
| under different RUs | | | | | | |
| PAPRs of q₃(5, 4, 1, 1) | 7.0810 dB | 7.6445 dB | 6.6954 dB | 6.9515 dB | 6.5287 dB | 7.2944 dB |
| under different RUs | | | | | | |
| PAPRs of q₃(5, 4, 2, 3) | 7.0810 dB | 7.6445 dB | 6.6954 dB | 6.9515 dB | 6.5287 dB | 7.2944 dB |
| under different RUs | | | | | | |
| PAPRs of q₃(6, 1, 1, 1) | 7.0810 dB | 7.6445 dB | 6.6954 dB | 6.9515 dB | 6.5287 dB | 7.2945 dB |
| under different RUs | | | | | | |
| PAPRs of the second | 7.0810 dB | 7.6445 dB | 6.6954 dB | 6.9515 dB | 6.5287 dB | 7.2951 dB |
| sequence under different | | | | | | |
| RUs | | | | | | |

In a case in which the second sequence is the HE-LTF sequence in the 4× mode at the 80 MHz bandwidth in 802.11ax, for PAPRs of the first sequence and the second sequence under different RUs in Manner 5, refer to Table 5. It may be understood that, in this application, q₄ (1,7,6,1,5) may be understood as that

$${q}_{4} = \text{} \frac{16}{\sqrt{341}} {e}^{\frac{j π}{4}} {s}_{1} + \frac{8}{\sqrt{341}} {e}^{\frac{j π}{4}} {s}_{7} + \frac{4}{\sqrt{341}} {e}^{\frac{j π}{4}} {s}_{6} + \frac{2}{\sqrt{341}} {e}^{\frac{j π}{4}} {s}_{1} + \frac{1}{\sqrt{345}} {e}^{\frac{j π}{4}} {s}_{5} .$$

That is, k10 is 1 k11 is 7, k12 is 6, k13 is 1, and k14 is 5. Similarly, q₄ (2,7,5,7,5) may be understood as that

$${q}_{4} = \text{} \frac{16}{\sqrt{341}} {e}^{\frac{j π}{4}} {s}_{2} + \frac{8}{\sqrt{341}} {e}^{\frac{j π}{4}} {s}_{7} + \frac{4}{\sqrt{341}} {e}^{\frac{j π}{4}} {s}_{5} + \frac{2}{\sqrt{341}} {e}^{\frac{j π}{4}} {s}_{7} + \frac{1}{\sqrt{345}} {e}^{\frac{j π}{4}} {s}_{5} .$$

That is, k10 is 2, k11 is 7, k12 is 5, k13 is 7, and k14 is 5. For others such as q₄ (6,1,2,4,4) in Table 5, refer to an understanding manner of q₄ (1,7,6,1,5), and details are not described herein again. In addition, with reference to Table 5, when

$${q}_{4} = \text{} \frac{16}{\sqrt{341}} {e}^{\frac{j π}{4}} {s}_{1} + \frac{8}{\sqrt{341}} {e}^{\frac{j π}{4}} {s}_{7} + \frac{4}{\sqrt{341}} {e}^{\frac{j π}{4}} {s}_{6} + \frac{2}{\sqrt{341}} {e}^{\frac{j π}{4}} {s}_{1} + \frac{1}{\sqrt{345}} {e}^{\frac{j π}{4}} {s}_{5} ,$$

a PAPR of a subsequence with a maximum

PAPR in subsequences corresponding to the 26-tone RU in q₄ is 7.0810 dB, a PAPR of a subsequence with a maximum PAPR in subsequences corresponding to the 52-tone RU in q₄ is 7.6445 dB, a PAPR of a subsequence with a maximum PAPR in subsequences corresponding to the 106-tone RU in q₄ is 6.6954 dB, a PAPR of a subsequence with a maximum PAPR in subsequences corresponding to the 242-tone RU in q₄ is 6.9515 dB, a PAPR of a subsequence with a maximum PAPR in subsequences corresponding to the 484-tone RU in q₄ is 6.5287 dB, and a PAPR of a subsequence with a maximum PAPR in subsequences corresponding to the 996-tone RU in q₄ is 7.2951 dB. Therefore, when

$${q}_{4} = \text{} \frac{16}{\sqrt{341}} {e}^{\frac{j π}{4}} {s}_{1} + \frac{8}{\sqrt{341}} {e}^{\frac{j π}{4}} {s}_{7} + \frac{4}{\sqrt{341}} {e}^{\frac{j π}{4}} {s}_{6} + \frac{2}{\sqrt{341}} {e}^{\frac{j π}{4}} {s}_{1} + \frac{1}{\sqrt{345}} {e}^{\frac{j π}{4}} {s}_{5} ,$$

δ is 2.16×10⁻⁵. Similarly, when

$${q}_{4} = \text{} \frac{16}{\sqrt{341}} {e}^{\frac{j π}{4}} {s}_{2} + \frac{8}{\sqrt{341}} {e}^{\frac{j π}{4}} {s}_{7} + \frac{4}{\sqrt{341}} {e}^{\frac{j π}{4}} {s}_{5} + \frac{2}{\sqrt{341}} {e}^{\frac{j π}{4}} {s}_{7} + \frac{1}{\sqrt{345}} {e}^{\frac{j π}{4}} {s}_{5} ,$$

for PAPRs of q₄ under different RUs, refer to Table 5, and δ is 2.45×10⁻⁵. In addition, for remaining cases in Table 5, δ is successively 2.51×10⁻⁵, 4.06×10⁻⁵, 4.58×10⁻⁵, 5.26×10⁻⁵, 5.43×10⁻⁵, and 5.71×10⁻⁵ from top to bottom.

TABLE 5
PAPRs of the first sequence and the second sequence under different RUs in
Manner 5

| | 26-tone | 52-tone | 106-tone | 242-tone | 484-tone | 996-tone |
|---|---|---|---|---|---|---|
| | RU | RU | RU | RU | RU | RU |
| PAPRs of q₄(1, 7, 6, 1, 5) | 7.0810 dB | 7.6445 dB | 6.6954 dB | 6.9515 dB | 6.5287 dB | 7.2951 dB |
| under different RUs | | | | | | |
| PAPRs of q₄(2, 7, 5, 7, 5) | 7.0810 dB | 7.6445 dB | 6.6954 dB | 6.9515 dB | 6.5287 dB | 7.2951 dB |
| under different RUs | | | | | | |
| PAPRs of q₄(6, 1, 2, 4, 4) | 7.0810 dB | 7.6445 dB | 6.6954 dB | 6.9515 dB | 6.5287 dB | 7.2952 dB |
| under different RUs | | | | | | |
| PAPRs of q₄(4, 6, 4, 1, 6) | 7.0810 dB | 7.6445 dB | 6.6954 dB | 6.9515 dB | 6.5287 dB | 7.2952 dB |
| under different RUs | | | | | | |
| PAPRs of q₄(6, 2, 1, 4, 5) | 7.0810 dB | 7.6445 dB | 6.6954 dB | 6.9515 dB | 6.5287 dB | 7.2952 dB |
| under different RUs | | | | | | |
| PAPRs of q₄(3, 6, 7, 1, 2) | 7.0810 dB | 7.6445 dB | 6.6954 dB | 6.9515 dB | 6.5287 dB | 7.2951 dB |
| under different RUs | | | | | | |
| PAPRs of q₄(5, 3, 1, 6, 1) | 7.0810 dB | 7.6445 dB | 6.6954 dB | 6.9515 dB | 6.5287 dB | 7.2952 dB |
| under different RUs | | | | | | |
| PAPRs of q₄(4, 6, 2, 6, 6) | 7.0810 dB | 7.6445 dB | 6.6954 dB | 6.9515 dB | 6.5287 dB | 7.2951 dB |
| under different RUs | | | | | | |
| PAPRs of the second | 7.0810 dB | 7.6445 dB | 6.6954 dB | 6.9515 dB | 6.5287 dB | 7.2951 dB |
| sequence under different | | | | | | |
| RUs | | | | | | |

In a case in which the second sequence is the HE-LTF sequence in the 4× mode at the 80 MHz bandwidth in 802.11ax, for PAPRs of the first sequence and the second sequence under different RUs in Manner 6, refer to Table 6. It may be understood that, in this application, q₅ (5,2,4,7,2,5) may be understood as that

$${q}_{5} = \frac{16}{\sqrt{1365}} {e}^{\frac{j π}{4}} {s}_{5} + \frac{16}{\sqrt{1365}} {e}^{\frac{j π}{4}} {s}_{2} + \frac{8}{\sqrt{1365}} {e}^{\frac{j π}{4}} {s}_{4} + \frac{4}{\sqrt{1365}} {e}^{\frac{j π}{4}} {s}_{7} + \frac{2}{\sqrt{1365}} {e}^{\frac{j π}{4}} {s}_{2} + \frac{1}{\sqrt{1365}} {e}^{\frac{j π}{4}} {s}_{5} .$$

That is, k15 is 5, k16 is 2, k17 is 4, k18 is 7, k19 is 2, and k20 is 5. Similarly, q₅ (5,2,5,1,7,2) may be understood as that

$${q}_{5} = \frac{16}{\sqrt{1365}} {e}^{\frac{j π}{4}} {s}_{5} + \frac{16}{\sqrt{1365}} {e}^{\frac{j π}{4}} {s}_{2} + \frac{8}{\sqrt{1365}} {e}^{\frac{j π}{4}} {s}_{5} + \frac{4}{\sqrt{1365}} {e}^{\frac{j π}{4}} {s}_{1} + \frac{2}{\sqrt{1365}} {e}^{\frac{j π}{4}} {s}_{7} + \frac{1}{\sqrt{1365}} {e}^{\frac{j π}{4}} {s}_{2}$$

That is, k15 is 5, k16 is 2, k17 is 5, k18 is 1, k19 is 7, and k20 is 2. For others such as q₅ (6,2,2,3,7,5) in Table 6, refer to an understanding manner of q₅ (5,2,4,7,2,5), and details are not described herein again. In addition, with reference to Table 6, when

$${q}_{5} = \frac{16}{\sqrt{1365}} {e}^{\frac{j π}{4}} {s}_{5} + \frac{16}{\sqrt{1365}} {e}^{\frac{j π}{4}} {s}_{2} + \frac{8}{\sqrt{1365}} {e}^{\frac{j π}{4}} {s}_{4} + \frac{4}{\sqrt{1365}} {e}^{\frac{j π}{4}} {s}_{7} + \frac{2}{\sqrt{1365}} {e}^{\frac{j π}{4}} {s}_{2} + \frac{1}{\sqrt{1365}} {e}^{\frac{j π}{4}} {s}_{5} ,$$

a PAPR of a subsequence with a maximum PAPR in subsequences corresponding to the 26-tone RU in q₅ is 7.0810 dB, a PAPR of a subsequence with a maximum PAPR in subsequences corresponding to the 52-tone RU in q₅ is 7.6445 dB, a PAPR of a subsequence with a maximum PAPR in subsequences corresponding to the 106-tone RU in q₅ is 6.6954 dB, a PAPR of a subsequence with a maximum PAPR in subsequences corresponding to the 242-tone RU in q₅ is 6.9515 dB, a PAPR of a subsequence with a maximum PAPR in subsequences corresponding to the 484-tone RU in q₅ is 6.5287 dB, and a PAPR of a subsequence with a maximum PAPR in subsequences corresponding to the 996-tone RU in q₅ is 7.2951 dB. Therefore, when

$${q}_{5} = \frac{16}{\sqrt{1365}} {e}^{\frac{j π}{4}} {s}_{5} + \frac{16}{\sqrt{1365}} {e}^{\frac{j π}{4}} {s}_{2} + \frac{8}{\sqrt{1365}} {e}^{\frac{j π}{4}} {s}_{4} + \frac{4}{\sqrt{1365}} {e}^{\frac{j π}{4}} {s}_{7} + \frac{2}{\sqrt{1365}} {e}^{\frac{j π}{4}} {s}_{2} + \frac{1}{\sqrt{1365}} {e}^{\frac{j π}{4}} {s}_{5} ,$$

δ is 1.09×10⁻⁶. Similarly, when

$${q}_{5} = \frac{16}{\sqrt{1365}} {e}^{\frac{j π}{4}} {s}_{5} + \frac{16}{\sqrt{1365}} {e}^{\frac{j π}{4}} {s}_{2} + \frac{8}{\sqrt{1365}} {e}^{\frac{j π}{4}} {s}_{5} + \frac{4}{\sqrt{1365}} {e}^{\frac{j π}{4}} {s}_{1} + \frac{2}{\sqrt{1365}} {e}^{\frac{j π}{4}} {s}_{7} + \frac{1}{\sqrt{1365}} {e}^{\frac{j π}{4}} {s}_{2} ,$$

for PAPRs of q₅ under different RUs, refer to Table 6, and δ is 4.07×10⁻⁶. In addition, for remaining cases in Table 6, δ is successively 5.02×10⁻⁶, 5.45×10⁻⁶, 7.14×10⁻⁶, 8.36×10⁻⁶, 8.95×10⁻⁶, and 9.02×10⁻⁶ from top to bottom.

TABLE 6
PAPRs of the first sequence and the second sequence under different RUs in
Manner 6

| | 26-tone | 52-tone | 106-tone | 242-tone | 484-tone | 996-tone |
|---|---|---|---|---|---|---|
| | RU | RU | RU | RU | RU | RU |
| PAPRs of | 7.0810 dB | 7.6445 dB | 6.6954 dB | 6.9515 dB | 6.5287 dB | 7.2951 dB |
| q₅(5, 2, 4, 7, 2, 5) | | | | | | |
| under different | | | | | | |
| RUs | | | | | | |
| PAPRs of | 7.0810 dB | 7.6445 dB | 6.6954 dB | 6.9515 dB | 6.5287 dB | 7.2951 dB |
| q₅(5, 2, 5, 1, 7, 2) | | | | | | |
| under different | | | | | | |
| RUs | | | | | | |
| PAPRs of | 7.0810 dB | 7.6445 dB | 6.6954 dB | 6.9515 dB | 6.5287 dB | 7.2951 dB |
| q₅(6, 2, 2, 3, 7, 5) | | | | | | |
| under different | | | | | | |
| RUs | | | | | | |
| PAPRs of | 7.0810 dB | 7.6445 dB | 6.6954 dB | 6.9515 dB | 6.5287 dB | 7.2951 dB |
| q₅(3, 6, 6, 4, 5, 4) | | | | | | |
| under different | | | | | | |
| RUs | | | | | | |
| PAPRs of | 7.0810 dB | 7.6445 dB | 6.6954 dB | 6.9515 dB | 6.5287 dB | 7.2951 dB |
| q₅(4, 7, 2, 2, 3, 2) | | | | | | |
| under different | | | | | | |
| RUs | | | | | | |
| PAPRs of | 7.0810 dB | 7.6445 dB | 6.6954 dB | 6.9515 dB | 6.5287 dB | 7.2951 dB |
| q₅(6, 1, 2, 3, 5, 4) | | | | | | |
| under different | | | | | | |
| RUs | | | | | | |
| PAPRs of | 7.0810 dB | 7.6445 dB | 6.6954 dB | 6.9515 dB | 6.5287 dB | 7.2951 dB |
| q₅(2, 7, 7, 3, 6, 3) | | | | | | |
| under different | | | | | | |
| RUs | | | | | | |
| PAPRs of | 7.0810 dB | 7.6445 dB | 6.6954 dB | 6.9515 dB | 6.5287 dB | 7.2951 dB |
| q₅(1, 7, 5, 5, 4, 2) | | | | | | |
| under different | | | | | | |
| RUs | | | | | | |
| PAPRs of the | 7.0810 dB | 7.6445 dB | 6.6954 dB | 6.9515 dB | 6.5287 dB | 7.2951 dB |
| second sequence | | | | | | |
| under different | | | | | | |
| RUs | | | | | | |

In a case in which the second sequence is the EHT-LTF sequence in the 4× mode at the 80 MHz bandwidth in 802.11be, for PAPRs of the first sequence and the second sequence under different RUs in Manner 7, refer to Table 7. With reference to Table 7, it can be learned that, when u=1 in Manner 7, a PAPR of a subsequence with a maximum PAPR in subsequences corresponding to the 26-tone RU in p₁ is 4.1824 dB, a PAPR of a subsequence with a maximum PAPR in subsequences corresponding to the 52-tone RU in p₁ is 4.1720 dB, a PAPR of a subsequence with a maximum PAPR in subsequences corresponding to the 106-tone RU in p₁ is 4.7226 dB, a PAPR of a subsequence with a maximum PAPR in subsequences corresponding to the 242-tone RU in p₁ is 5.2664 dB, a PAPR of a subsequence with a maximum PAPR in subsequences corresponding to the 484-tone RU in p₁ is 5.6165 dB, and a PAPR of a subsequence with a maximum PAPR in subsequences corresponding to the 996-tone RU in p₁ is 6.0614 dB. Therefore, δ corresponding to p₁ is 0.2422. Similarly, when u=2 in Manner 7, for PAPRs of p₂ under different RUs, refer to Table 7, and δ corresponding to p₂ is 0.1989. When u=3 in Manner 7, for PAPRs of s₃ under different RUs, refer to Table 7, and δ corresponding to p₃ is 0.2461. When u=4 in Manner 7, for PAPRs of p₄ under different RUs, refer to Table 7, and δ corresponding to p₄ is 0.1821. When u=5 in Manner 7, for PAPRs of p₅ under different RUs, refer to Table 7, and δ corresponding to p₅ is 0.014. In addition, in Table 7 to Table 12, a PAPR corresponding to the 26-tone RU in the second sequence is 4.1824 dB, a PAPR corresponding to the 52-tone RU in the second sequence is 4.1720 dB, a PAPR corresponding to the 106-tone RU in the second sequence is 4.7226 dB, a PAPR corresponding to the 242-tone RU in the second sequence is 5.2664 dB, a PAPR corresponding to the 484-tone RU in the second sequence is 5.6165 dB, and a PAPR corresponding to the 996-tone RU in the second sequence is 5.8192 dB. Details are not described subsequently.

TABLE 7
PAPRs of the first sequence and the second sequence under different RUs in Manner 7

| | 26-tone | 52-tone | 106-tone | 242-tone | 484-tone | 996-tone |
|---|---|---|---|---|---|---|
| | RU | RU | RU | RU | RU | RU |
| PAPRs of p₁ | 4.1824 dB | 4.1720 dB | 4.7226 dB | 5.2664 dB | 5.6165 dB | 6.0614 dB |
| under different | | | | | | |
| RUs | | | | | | |
| PAPRs of p₂ | 4.1824 dB | 4.1720 dB | 4.7226 dB | 5.2664 dB | 5.6165 dB | 6.0181 dB |
| under different | | | | | | |
| RUs | | | | | | |
| PAPRs of p₃ | 4.1824 dB | 4.1720 dB | 4.7226 dB | 5.2664 dB | 5.6165 dB | 6.0653 dB |
| under different | | | | | | |
| RUs | | | | | | |
| PAPRs of p₄ | 4.1824 dB | 4.1720 dB | 4.7226 dB | 5.2664 dB | 5.6165 dB | 6.0013 dB |
| under different | | | | | | |
| RUs | | | | | | |
| PAPRs of p₅ | 4.1824 dB | 4.1720 dB | 4.7226 dB | 5.2664 dB | 5.6165 dB | 5.8052 dB |
| under different | | | | | | |
| RUs | | | | | | |
| PAPRs of the | 4.1824 dB | 4.1720 dB | 4.7226 dB | 5.2664 dB | 5.6165 dB | 5.8192 dB |
| second sequence | | | | | | |
| under different | | | | | | |
| RUs | | | | | | |

In a case in which the second sequence is the EHT-LTF sequence in the 4× mode at the 80 MHz bandwidth in 802.11be, for PAPRs of the first sequence and the second sequence under different RUs in Manner 8, refer to Table 8. It may be understood that, in this application, q₆ (5,5) may be understood as that

$${q}_{6} = \frac{2}{\sqrt{5}} {e}^{\frac{j π}{4}} {p}_{5} + \frac{1}{\sqrt{5}} {e}^{\frac{j π}{4}} {p}_{5} .$$

That is, t1 is 5, and t2 is 5. Similarly, q₆ (5,1) may be understood as that

$${q}_{6} = \frac{2}{\sqrt{5}} {e}^{\frac{j π}{4}} {p}_{5} + \frac{1}{\sqrt{5}} {e}^{\frac{j π}{4}} {p}_{1} .$$

That is, t1 is 5, and t2 is 1. For others such as q₆ (5,4) in Table 8, refer to an understanding manner of q₆ (5,5), and details are not described herein again. In addition, with reference to Table 8, when

$${q}_{6} = \frac{2}{\sqrt{5}} {e}^{\frac{j π}{4}} {p}_{5} + \frac{1}{\sqrt{5}} {e}^{\frac{j π}{4}} {p}_{5} ,$$

a PAPR of a subsequence with a maximum PAPR in subsequences corresponding to the 26-tone RU in q₆ is 4.1824 dB, a PAPR of a subsequence with a maximum PAPR in subsequences corresponding to the 52-tone RU in q₆ is 4.1720 dB, a PAPR of a subsequence with a maximum PAPR in subsequences corresponding to the 106-tone RU in q₆ is 4.7226 dB, a PAPR of a subsequence with a maximum PAPR in subsequences corresponding to the 242-tone RU in q₆ is 5.2664 dB, a PAPR of a subsequence with a maximum PAPR in subsequences corresponding to the 484-tone RU in q₆ is 5.6165 dB, and a PAPR of a subsequence with a maximum PAPR in subsequences corresponding to the 996-tone RU in q₆ is 5.8052 dB. Therefor, when

$${q}_{6} = \frac{2}{\sqrt{5}} {e}^{\frac{j π}{4}} {p}_{5} + \frac{1}{\sqrt{5}} {e}^{\frac{j π}{4}} {p}_{5} ,$$

δ is 0.0140. Similarly, when

$${q}_{6} = \frac{2}{\sqrt{5}} {e}^{\frac{j π}{4}} {p}_{5} + \frac{1}{\sqrt{5}} {e}^{\frac{j π}{4}} {p}_{1} ,$$

for PAPRs of q₆ under different RUs, refer to Table 8, and δ is 0.0170. In addition, for remaining cases in Table 8, δ is successively 0.0538, 0.064, 0.0783, 0.0794, and 0.1191 from top to bottom.

TABLE 8
PAPRs of the first sequence and the second sequence under different RUs in Manner 8

| | 26-tone | 52-tone | 106-tone | 242-tone | 484-tone | 996-tone |
|---|---|---|---|---|---|---|
| | RU | RU | RU | RU | RU | RU |
| PAPRs of | 4.1824 dB | 4.1720 dB | 4.7226 dB | 5.2664 dB | 5.6165 dB | 5.8052 dB |
| q₆(5, 5) under | | | | | | |
| different RUs | | | | | | |
| PAPRs of | 4.1824 dB | 4.1720 dB | 4.7226 dB | 5.2664 dB | 5.6165 dB | 5.8362 dB |
| q₆(5, 1) under | | | | | | |
| different RUs | | | | | | |
| PAPRs of | 4.1824 dB | 4.1720 dB | 4.7226 dB | 5.2664 dB | 5.6165 dB | 5.8730 dB |
| q₆(5, 4) under | | | | | | |
| different RUs | | | | | | |
| PAPRs of | 4.1824 dB | 4.1720 dB | 4.7226 dB | 5.2664 dB | 5.6165 dB | 5.8832 dB |
| q₆(5, 2) under | | | | | | |
| different RUs | | | | | | |
| PAPRs of | 4.1824 dB | 4.1720 dB | 4.7226 dB | 5.2664 dB | 5.6165 dB | 5.8975 dB |
| q₆(1, 5) under | | | | | | |
| different RUs | | | | | | |
| PAPRs of | 4.1824 dB | 4.1720 dB | 4.7226 dB | 5.2664 dB | 5.6165 dB | 5.8986 dB |
| q₆(5, 3) under | | | | | | |
| different RUs | | | | | | |
| PAPRs of | 4.1824 dB | 4.1720 dB | 4.7226 dB | 5.2664 dB | 5.6165 dB | 5.9383 dB |
| q₆(4, 5) under | | | | | | |
| different RUs | | | | | | |
| PAPRs of the | 4.1824 dB | 4.1720 dB | 4.7226 dB | 5.2664 dB | 5.6165 dB | 5.8192 dB |
| second | | | | | | |
| sequence under | | | | | | |
| different RUs | | | | | | |

In a case in which the second sequence is the EHT-LTF sequence in the 4× mode at the 80 MHz bandwidth in 802.11be, for PAPRs of the first sequence and the second sequence under different RUs in Manner 9, refer to Table 9. It may be understood that, in this application, q₇ (5,5,1) may be understood as that

$${q}_{7} = \frac{4}{\sqrt{21}} {e}^{\frac{j π}{4}} {p}_{5} + \frac{2}{\sqrt{21}} {e}^{\frac{j π}{4}} {p}_{5} + \frac{1}{\sqrt{21}} {e}^{\frac{j π}{4}} {p}_{1} .$$

That is, t3 is 5, t4 is 5, and t5 is 1. Similarly, q₇ (5,1,5) may be understood as that

$${q}_{7} = \frac{4}{\sqrt{21}} {e}^{\frac{j π}{4}} {p}_{5} + \frac{2}{\sqrt{21}} {e}^{\frac{j π}{4}} {p}_{1} + \frac{1}{\sqrt{21}} {e}^{\frac{j π}{4}} {p}_{5} .$$

That is, t3 is 5, t4 is 1, and t5 is 5. For others such as q₇ (1,7,6) in Table 9, refer to an understanding manner of q₇ (1,6,7), and details are not described herein again. In addition, with reference to Table 9, when

$${q}_{7} = \frac{4}{\sqrt{21}} {e}^{\frac{j π}{4}} {p}_{5} + \frac{2}{\sqrt{21}} {e}^{\frac{j π}{4}} {p}_{5} + \frac{1}{\sqrt{21}} {e}^{\frac{j π}{4}} {p}_{1} ,$$

a PAPR of a subsequence with a maximum PAPR in subsequences corresponding to the 26-tone RU in q₇ is 4.1824 dB, a PAPR of a subsequence with a maximum PAPR in subsequences corresponding to the 52-tone RU in q₇ is 4.1720 dB, a PAPR of a subsequence with a maximum PAPR in subsequences corresponding to the 106-tone RU in q₇ is 4.7226 dB, a PAPR of a subsequence with a maximum PAPR in subsequences corresponding to the 242-tone RU in q₇ is 5.2664 dB, a PAPR of a subsequence with a maximum PAPR in subsequences corresponding to the 484-tone RU in q₇ is 5.6165 dB, and a PAPR of a subsequence with a maximum PAPR in subsequences corresponding to the 996-tone RU in q₇ is 5.8195 dB. Therefore, when

$${q}_{7} = \frac{4}{\sqrt{21}} {e}^{\frac{j π}{4}} {p}_{5} + \frac{2}{\sqrt{21}} {e}^{\frac{j π}{4}} {p}_{5} + \frac{1}{\sqrt{21}} {e}^{\frac{j π}{4}} {p}_{1} ,$$

δ is 0.0003. Similarly, when

$${q}_{7} = \frac{4}{\sqrt{21}} {e}^{\frac{j π}{4}} {p}_{5} + \frac{2}{\sqrt{21}} {e}^{\frac{j π}{4}} {p}_{1} + \frac{1}{\sqrt{21}} {e}^{\frac{j π}{4}} {p}_{5} ,$$

for PAPRs of q₇ under different RUs, refer to Table 9, and δ is 0.0131. In addition, for remaining cases in Table 9, δ is successively 0.0140, 0.0153, 0.6005, 0.0243, and 0.0268 from top to bottom.

TABLE 9
PAPRs of the first sequence and the second sequence under different RUs in
Manner 9

| | 26-tone | 52-tone | 106-tone | 242-tone | 484-tone | 996-tone |
|---|---|---|---|---|---|---|
| | RU | RU | RU | RU | RU | RU |
| PAPRs of q₇(5, 5, 1) | 4.1824 dB | 4.1720 dB | 4.7226 dB | 5.2664 dB | 5.6165 dB | 5.8195 dB |
| under different RUs | | | | | | |
| PAPRs of q₇(5, 1, 5) | 4.1824 dB | 4.1720 dB | 4.7226 dB | 5.2664 dB | 5.6165 dB | 5.8323 dB |
| under different RUs | | | | | | |
| PAPRs of q₇(5, 5, 5) | 4.1824 dB | 4.1720 dB | 4.7226 dB | 5.2664 dB | 5.6165 dB | 5.8052 dB |
| under different RUs | | | | | | |
| PAPRs of q₇(5, 5, 4) | 4.1824 dB | 4.1720 dB | 4.7226 dB | 5.2664 dB | 5.6165 dB | 5.8345 dB |
| under different RUs | | | | | | |
| PAPRs of q₇(5, 5, 2) | 4.1824 dB | 4.1720 dB | 4.7226 dB | 5.2664 dB | 5.6165 dB | 5.8397 dB |
| under different RUs | | | | | | |
| PAPRs of q₇(5, 1, 1) | 4.1824 dB | 4.1720 dB | 4.7226 dB | 5.2664 dB | 5.6165 dB | 5.8435 dB |
| under different RUs | | | | | | |
| PAPRs of q₇(5, 5, 3) | 4.1824 dB | 4.1720 dB | 4.7226 dB | 5.2664 dB | 5.6165 dB | 5.8460 dB |
| under different RUs | | | | | | |
| PAPRs of the second | 4.1824 dB | 4.1720 dB | 4.7226 dB | 5.2664 dB | 5.6165 dB | 5.8192 dB |
| sequence under | | | | | | |
| different RUs | | | | | | |

In a case in which the second sequence is the EHT-LTF sequence in the 4× mode at the 80 MHz bandwidth in 802.11be, for PAPRs of the first sequence and the second sequence under different RUs in Manner 10, refer to Table 10. It may be understood that, in this application, q₈ (5,5,5,4) may be understood as that

$${q}_{8} = \frac{8}{\sqrt{85}} {e}^{\frac{j π}{4}} {p}_{5} + \frac{4}{\sqrt{85}} {e}^{\frac{j π}{4}} {p}_{5} + \frac{3}{\sqrt{85}} {e}^{\frac{j π}{4}} {p}_{5} + \frac{1}{\sqrt{85}} {e}^{\frac{j π}{4}} {p}_{4} .$$

That is, t6 is 5, t7 is 5, t8 is 5, and t9 is 4. Similarly, q₈ (5,5,1,5) may be understood as that

$${q}_{8} = \frac{8}{\sqrt{85}} {e}^{\frac{j π}{4}} {p}_{5} + \frac{4}{\sqrt{85}} {e}^{\frac{j π}{4}} {p}_{5} + \frac{2}{\sqrt{85}} {e}^{\frac{j π}{4}} {p}_{1} + \frac{1}{\sqrt{85}} {e}^{\frac{j π}{4}} {p}_{5} .$$

That is, t6 is 5, t7 is 5, t8 is 1, and t9 is 5. For others such as q₈ (5,5,5,2) in Table 10, refer to an understanding manner of q₈ (5,5,5,4), and details are not described herein again. In addition, with reference to Table 10, when

$${q}_{8} = \frac{8}{\sqrt{85}} {e}^{\frac{j π}{4}} {p}_{5} + \frac{4}{\sqrt{85}} {e}^{\frac{j π}{4}} {p}_{5} + \frac{2}{\sqrt{85}} {e}^{\frac{j π}{4}} {p}_{5} + \frac{1}{\sqrt{85}} {e}^{\frac{j π}{4}} {p}_{4} ,$$

a PAPR of a subsequence with a maximum PAPR in subsequences corresponding to the 26-tone RU in q₈ is 4.1824 dB, a PAPR of a subsequence with a maximum PAPR in subsequences corresponding to the 52-tone RU in q₈ is 4.1720 dB, a PAPR of a subsequence with a maximum PAPR in subsequences corresponding to the 106-tone RU in q₈ is 4.7226 dB, a PAPR of a subsequence with a maximum PAPR in subsequences corresponding to the 242-tone RU in q₈ is 5.2664 dB, a PAPR of a subsequence with a maximum PAPR in subsequences corresponding to the 484-tone RU in q₈ is 5.6165 dB, and a PAPR of a subsequence with a maximum PAPR in subsequences corresponding to the 996-tone RU in q₈ is 5.8189 dB. Therefore, when

$${q}_{8} = \frac{8}{\sqrt{85}} {e}^{\frac{j π}{4}} {p}_{5} + \frac{4}{\sqrt{85}} {e}^{\frac{j π}{4}} {p}_{5} + \frac{2}{\sqrt{85}} {e}^{\frac{j π}{4}} {p}_{5} + \frac{1}{\sqrt{85}} {e}^{\frac{j π}{4}} {p}_{4} ,$$

δ is 0.0003. Similarly, when

$${q}_{8} = \frac{8}{\sqrt{85}} {e}^{\frac{j π}{4}} {p}_{5} + \frac{4}{\sqrt{85}} {e}^{\frac{j π}{4}} {p}_{5} + \frac{2}{\sqrt{85}} {e}^{\frac{j π}{4}} {p}_{1} + \frac{1}{\sqrt{85}} {e}^{\frac{j π}{4}} {p}_{5} ,$$

for PAPRs of q₈ under different RUs, refer to Table 10, and δ is 0.0006. In addition, for remaining cases in Table 10, δ is successively 0.0023, 0.0052, 0.0057, 0.0071, 0.0115, and 0.0130 from top to bottom.

TABLE 10
PAPRs of the first sequence and the second sequence under different RUs in
Manner 10

| | 26-tone | 52-tone | 106-tone | 242-tone | 484-tone | 996-tone |
|---|---|---|---|---|---|---|
| | RU | RU | RU | RU | RU | RU |
| PAPRs of | 4.1824 dB | 4.1720 dB | 4.7226 dB | 5.2664 dB | 5.6165 dB | 5.8189 dB |
| q₈(5, 5, 5, 4) under | | | | | | |
| different RUs | | | | | | |
| PAPRs of | 4.1824 dB | 4.1720 dB | 4.7226 dB | 5.2664 dB | 5.6165 dB | 5.8186 dB |
| q₈(5, 5, 1, 5) under | | | | | | |
| different RUs | | | | | | |
| PAPRs of | 4.1824 dB | 4.1720 dB | 4.7226 dB | 5.2664 dB | 5.6165 dB | 5.8215 dB |
| q₈(5, 5, 5, 2) under | | | | | | |
| different RUs | | | | | | |
| PAPRs of | 4.1824 dB | 4.1720 dB | 4.7226 dB | 5.2664 dB | 5.6165 dB | 5.8244 dB |
| q₈(5, 5, 5, 3) under | | | | | | |
| different RUs | | | | | | |
| PAPRs of | 4.1824 dB | 4.1720 dB | 4.7226 dB | 5.2664 dB | 5.6165 dB | 5.8249 dB |
| q₈(5, 5, 1, 1) under | | | | | | |
| different RUs | | | | | | |
| PAPRs of | 4.1824 dB | 4.1720 dB | 4.7226 dB | 5.2664 dB | 5.6165 dB | 5.8121 dB |
| q₈(5, 5, 5, 1) under | | | | | | |
| different RUs | | | | | | |
| PAPRs of | 4.1824 dB | 4.1720 dB | 4.7226 dB | 5.2664 dB | 5.6165 dB | 5.8307 dB |
| q₈(5, 1, 5, 5) under | | | | | | |
| different RUs | | | | | | |
| PAPRs of | 4.1824 dB | 4.1720 dB | 4.7226 dB | 5.2664 dB | 5.6165 dB | 5.8322 dB |
| q₈(5, 5, 1, 4) under | | | | | | |
| different RUs | | | | | | |
| PAPRs of the | 4.1824 dB | 4.1720 dB | 4.7226 dB | 5.2664 dB | 5.6165 dB | 5.8192 dB |
| second sequence | | | | | | |
| under different | | | | | | |
| RUs | | | | | | |

In a case in which the second sequence is the EHT-LTF sequence in the 4× mode at the 80 MHz bandwidth in 802.11be, for PAPRs of the first sequence and the second sequence under different RUs in Manner 11, refer to Table 11. It may be understood that, in this application, q₉ (5,5,5,1,2) may be understood as that

$${q}_{9} = \frac{16}{\sqrt{341}} {e}^{\frac{j π}{4}} {p}_{5} + \frac{8}{\sqrt{341}} {e}^{\frac{j π}{4}} {p}_{5} + \frac{4}{\sqrt{341}} {e}^{\frac{j π}{4}} {p}_{5} + \frac{2}{\sqrt{341}} {e}^{\frac{j π}{4}} {p}_{1} + \frac{1}{\sqrt{341}} {e}^{\frac{j π}{4}} {p}_{2} .$$

That is, t10 is 5, t11 is 5, t12 is 5, t13 is 1, and t14 is 2. Similarly, q₉ (5,5,5,1,4) may be understood as that

$${q}_{9} = \frac{16}{\sqrt{341}} {e}^{\frac{j π}{4}} {p}_{5} + \frac{8}{\sqrt{341}} {e}^{\frac{j π}{4}} {p}_{5} + \frac{4}{\sqrt{341}} {e}^{\frac{j π}{4}} {p}_{5} + \frac{2}{\sqrt{341}} {e}^{\frac{j π}{4}} {p}_{1} + \frac{1}{\sqrt{341}} {e}^{\frac{j π}{4}} {p}_{4} .$$

That is, t10 is 5, t11 is 5, t12 is 5, t13 is 1, and t14 is 4. For others such as q₉ (5,5,5,4,5) in Table 11, refer to an understanding manner of q₉ (5,5,5,1,2), and details are not described herein again. In addition, with reference to Table 11, when

$${q}_{9} = \frac{16}{\sqrt{341}} {e}^{\frac{j π}{4}} {p}_{5} + \frac{8}{\sqrt{341}} {e}^{\frac{j π}{4}} {p}_{5} + \frac{4}{\sqrt{341}} {e}^{\frac{j π}{4}} {p}_{5} + \frac{2}{\sqrt{341}} {e}^{\frac{j π}{4}} {p}_{1} + \frac{1}{\sqrt{341}} {e}^{\frac{j π}{4}} {p}_{2} ,$$

a PAPR of a subsequence with a maximum PAPR in subsequences corresponding to the 26-tone RU in q₉ is 4.1824 dB, a PAPR of a subsequence with a maximum PAPR in subsequences corresponding to the 52-tone RU in q₉ is 4.1720 dB, a PAPR of a subsequence with a maximum PAPR in subsequences corresponding to the 106-tone RU in q₉ is 4.7226 dB, a PAPR of a subsequence with a maximum PAPR in subsequences corresponding to the 242-tone RU in q₉ is 5.2664 dB, a PAPR of a subsequence with a maximum PAPR in subsequences corresponding to the 484-tone RU in q₉ is 5.6165 dB, and a PAPR of a subsequence with a maximum PAPR in subsequences corresponding to the 996-tone RU in q₉ is 5.8197 dB. Therefore, when

$${q}_{9} = \frac{16}{\sqrt{341}} {e}^{\frac{j π}{4}} {p}_{5} + \frac{8}{\sqrt{341}} {e}^{\frac{j π}{4}} {p}_{5} + \frac{4}{\sqrt{341}} {e}^{\frac{j π}{4}} {p}_{5} + \frac{2}{\sqrt{341}} {e}^{\frac{j π}{4}} {p}_{1} + \frac{1}{\sqrt{341}} {e}^{\frac{j π}{4}} {p}_{2} ,$$

δ is 0.0002. Similarly, when

$${q}_{9} = \frac{16}{\sqrt{341}} {e}^{\frac{j π}{4}} {p}_{5} + \frac{8}{\sqrt{341}} {e}^{\frac{j π}{4}} {p}_{5} + \frac{4}{\sqrt{341}} {e}^{\frac{j π}{4}} {p}_{5} + \frac{2}{\sqrt{341}} {e}^{\frac{j π}{4}} {p}_{1} + \frac{1}{\sqrt{341}} {e}^{\frac{j π}{4}} {p}_{4} ,$$

for PAPRs of q₉ under different RUs, refer to Table 11, and δ is 0.0007. In addition, for remaining cases in Table 11, δ is successively 0.0008, 0.0010, 0.0017, 0.0018, 0.0020, and 0.0026 from top to bottom.

TABLE 11
PAPRs of the first sequence and the second sequence under different RUs in
Manner 11

| | 26-tone | 52-tone | 106-tone | 242-tone | 484-tone | 996-tone |
|---|---|---|---|---|---|---|
| | RU | RU | RU | RU | RU | RU |
| PAPRs of | 4.1824 dB | 4.1720 dB | 4.7226 dB | 5.2664 dB | 5.6165 dB | 5.8197 dB |
| q₉(5, 5, 5, 1, 2) under | | | | | | |
| different RUs | | | | | | |
| PAPRs of | 4.1824 dB | 4.1720 dB | 4.7226 dB | 5.2664 dB | 5.6165 dB | 5.8185 dB |
| q₉(5, 5, 5, 1, 4) under | | | | | | |
| different RUs | | | | | | |
| PAPRs of | 4.1824 dB | 4.1720 dB | 4.7226 dB | 5.2664 dB | 5.6165 dB | 5.8185 dB |
| q₉(5, 5, 5, 4, 5) under | | | | | | |
| different RUs | | | | | | |
| PAPRs of | 4.1824 dB | 4.1720 dB | 4.7226 dB | 5.2664 dB | 5.6165 dB | 5.8182 dB |
| q₉(5, 5, 1, 5, 5) under | | | | | | |
| different RUs | | | | | | |
| PAPRs of | 4.1824 dB | 4.1720 dB | 4.7226 dB | 5.2664 dB | 5.6165 dB | 5.8210 dB |
| q₉(5, 5, 5, 2, 5) under | | | | | | |
| different RUs | | | | | | |
| PAPRs of | 4.1824 dB | 4.1720 dB | 4.7226 dB | 5.2664 dB | 5.6165 dB | 5.8211 dB |
| q₉(5, 5, 5, 1, 3) under | | | | | | |
| different RUs | | | | | | |
| PAPRs of | 4.1824 dB | 4.1720 dB | 4.7226 dB | 5.2664 dB | 5.6165 dB | 5.8213 dB |
| q₉(5, 5, 1, 5, 1) under | | | | | | |
| different RUs | | | | | | |
| PAPRs of | 4.1824 dB | 4.1720 dB | 4.7226 dB | 5.2664 dB | 5.6165 dB | 5.8218 dB |
| q₉(5, 5, 5, 4, 1) under | | | | | | |
| different RUs | | | | | | |
| PAPRs of the | 4.1824 dB | 4.1720 dB | 4.7226 dB | 5.2664 dB | 5.6165 dB | 5.8192 dB |
| second sequence | | | | | | |
| under different RUs | | | | | | |

In a case in which the second sequence is the EHT-LTF sequence in the 4× mode at the 80 MHz bandwidth in 802.11be, for PAPRs of the first sequence and the second sequence under different RUs in Manner 12, refer to Table 12. It may be understood that, in this application, q₁₀ (5,5,5,1,2,5) may be understood as that

$${q}_{10} = \frac{16}{\sqrt{1365}} {e}^{\frac{j π}{4}} {p}_{5} + \frac{16}{\sqrt{1365}} {e}^{\frac{j π}{4}} {p}_{5} + \frac{8}{\sqrt{1365}} {e}^{\frac{j π}{4}} {p}_{5} + \frac{4}{\sqrt{1365}} {e}^{\frac{j π}{4}} {p}_{1} + \frac{2}{\sqrt{1365}} {e}^{\frac{j π}{4}} {p}_{2} + \frac{1}{\sqrt{1365}} {e}^{\frac{j π}{4}} {p}_{5} .$$

That is, t15 is 5, t16 is 5, t17 is 5, t18 is 1, t19 is 2, and t20 is 5. Similarly, q₁₀ (5,5,5,1,1,3) may be understood as that

$${q}_{10} = \frac{16}{\sqrt{1365}} {e}^{\frac{j π}{4}} {p}_{5} + \frac{16}{\sqrt{1365}} {e}^{\frac{j π}{4}} {p}_{5} + \frac{8}{\sqrt{1365}} {e}^{\frac{j π}{4}} {p}_{5} + \frac{4}{\sqrt{1365}} {e}^{\frac{j π}{4}} {p}_{1} + \frac{2}{\sqrt{1365}} {e}^{\frac{j π}{4}} {p}_{2} + \frac{1}{\sqrt{1365}} {e}^{\frac{j π}{4}} {p}_{3} .$$

That is, t15 is 5, t16 is 5, t17 is 5, t18 is 1, t19 is 1, and t20 is 3. For others such as q₁₀ (5,5,1,5,5,1) in Table 12, refer to an understanding manner of q₁₀ (5,5,5,1,2,5), and details are not described herein again. In addition, with reference to Table 12, it can be learned that, when

$${q}_{10} = \frac{16}{\sqrt{1365}} {e}^{\frac{j π}{4}} {p}_{5} + \frac{16}{\sqrt{1365}} {e}^{\frac{j π}{4}} {p}_{5} + \frac{8}{\sqrt{1365}} {e}^{\frac{j π}{4}} {p}_{5} + \frac{4}{\sqrt{1365}} {e}^{\frac{j π}{4}} {p}_{1} + \frac{2}{\sqrt{1365}} {e}^{\frac{j π}{4}} {p}_{2} + \frac{1}{\sqrt{1365}} {e}^{\frac{j π}{4}} {p}_{5} ,$$

a PAPR of a subsequence with a maximum PAPR in subsequences corresponding to the 26-tone RU in q₁₀ is 4.1824 dB, a PAPR of a subsequence with a maximum PAPR in subsequences corresponding to the 52-tone RU in q₁₀ is 4.1720 dB, a PAPR of a subsequence with a maximum PAPR in subsequences corresponding to the 106-tone RU in q₁₀ is 4.7226 dB, a PAPR of a subsequence with a maximum PAPR in subsequences corresponding to the 242-tone RU in q₁₀ is 5.2664 dB, a PAPR of a subsequence with a maximum PAPR in subsequences corresponding to the 484-tone RU in q₁₀ is 5.6165 dB, and a PAPR of a subsequence with a maximum PAPR in subsequences corresponding to the 996-tone RU in q₁₀ is 5.8194 dB. Therefore, when

$${q}_{10} = \frac{16}{\sqrt{1365}} {e}^{\frac{j π}{4}} {p}_{5} + \frac{16}{\sqrt{1365}} {e}^{\frac{j π}{4}} {p}_{5} + \frac{8}{\sqrt{1365}} {e}^{\frac{j π}{4}} {p}_{5} + \frac{4}{\sqrt{1365}} {e}^{\frac{j π}{4}} {p}_{1} + \frac{2}{\sqrt{1365}} {e}^{\frac{j π}{4}} {p}_{2} + \frac{1}{\sqrt{1365}} {e}^{\frac{j π}{4}} {p}_{5} ,$$

δ is 0.0002. Similarly, when

$${q}_{10} = \frac{16}{\sqrt{1365}} {e}^{\frac{j π}{4}} {p}_{5} + \frac{16}{\sqrt{1365}} {e}^{\frac{j π}{4}} {p}_{5} + \frac{8}{\sqrt{1365}} {e}^{\frac{j π}{4}} {p}_{5} + \frac{4}{\sqrt{1365}} {e}^{\frac{j π}{4}} {p}_{1} + \frac{2}{\sqrt{1365}} {e}^{\frac{j π}{4}} {p}_{1} + \frac{1}{\sqrt{1365}} {e}^{\frac{j π}{4}} {p}_{3} ,$$

for PAPRs of q₁₀ under different RUs, refer to Table 12, and δ is 0.0002. In addition, for remaining cases in Table 12, δ is successively 0.0003, 0.0003, 0.0005, 0.0006, 0.0007, and 0.0010 from top to bottom.

TABLE 12
PAPRs of the first sequence and the second sequence under different RUs in
Manner 12

| | 26-tone | 52-tone | 106-tone | 242-tone | 484-tone | 996-tone |
|---|---|---|---|---|---|---|
| | RU | RU | RU | RU | RU | RU |
| PAPRs of | 4.1824 dB | 4.1720 dB | 4.7226 dB | 5.2664 dB | 5.6165 dB | 5.8194 dB |
| q₁₀(5, 2, 4, 7, 2, 5) | | | | | | |
| under different | | | | | | |
| RUs | | | | | | |
| PAPRs of | 4.1824 dB | 4.1720 dB | 4.7226 dB | 5.2664 dB | 5.6165 dB | 5.8194 dB |
| q₁₀(5, 2, 5, 1, 7, 2) | | | | | | |
| under different | | | | | | |
| RUs | | | | | | |
| PAPRs of | 4.1824 dB | 4.1720 dB | 4.7226 dB | 5.2664 dB | 5.6165 dB | 5.8195 dB |
| q₁₀(6, 2, 2, 3, 7, 5) | | | | | | |
| under different | | | | | | |
| RUs | | | | | | |
| PAPRs of | 4.1824 dB | 4.1720 dB | 4.7226 dB | 5.2664 dB | 5.6165 dB | 5.8189 dB |
| q₁₀(3, 6, 6, 4, 5, 4) | | | | | | |
| under different | | | | | | |
| RUs | | | | | | |
| PAPRs of | 4.1824 dB | 4.1720 dB | 4.7226 dB | 5.2664 dB | 5.6165 dB | 5.8187 dB |
| q₁₀(4, 7, 2, 2, 3, 2) | | | | | | |
| under different | | | | | | |
| RUs | | | | | | |
| PAPRs of | 4.1824 dB | 4.1720 dB | 4.7226 dB | 5.2664 dB | 5.6165 dB | 5.8199 dB |
| q₁₀(6, 1, 2, 3, 5, 4) | | | | | | |
| under different | | | | | | |
| RUs | | | | | | |
| PAPRs of | 4.1824 dB | 4.1720 dB | 4.7226 dB | 5.2664 dB | 5.6165 dB | 5.8199 dB |
| q₁₀(2, 7, 7, 3, 6, 3) | | | | | | |
| under different | | | | | | |
| RUs | | | | | | |
| PAPRs of | 4.1824 dB | 4.1720 dB | 4.7226 dB | 5.2664 dB | 5.6165 dB | 5.8183 dB |
| q₁₀(1, 7, 5, 5, 4, 2) | | | | | | |
| under different | | | | | | |
| RUs | | | | | | |
| PAPRs of the | 4.1824 dB | 4.1720 dB | 4.7226 dB | 5.2664 dB | 5.6165 dB | 5.8192 dB |
| second sequence | | | | | | |
| under different | | | | | | |
| RUs | | | | | | |

The foregoing mainly describes the solutions provided in this application from the perspective of interaction between devices. It may be understood that, to implement the foregoing functions, each device includes a corresponding hardware structure and/or software module for performing each function. A person skilled in the art should be easily aware that units and algorithm operations in the examples described with reference to embodiments disclosed in this specification may be implemented in a form of hardware or in a form of a combination of hardware and computer software in this application. Whether a function is performed by hardware or hardware driven by computer software depends on a particular application and a design constraint of technical solutions. A person skilled in the art may use different methods to implement the described functions for each particular application, but it should not be considered that the implementation goes beyond the scope of this application.

In embodiments of this application, the AP or the STA may be divided into functional modules based on the foregoing method examples. For example, each functional module may be obtained through division based on a corresponding function, or two or more functions may be integrated into one processing module. The integrated module may be implemented in a form of hardware, or may be implemented in a form of a software functional module. It should be noted that, in embodiments of this application, division into the modules is an example and is merely logical function division. In other embodiments, another division manner may be used.

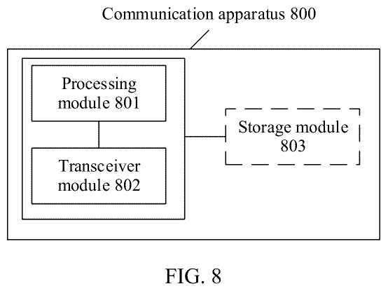

When an integrated module is used, FIG. 8 is a schematic diagram of a structure of a communication apparatus according to an embodiment of this application. A communication apparatus 800 may be applied to the method shown in FIG. 6. As shown in FIG. 8, the communication apparatus 800 includes a processing module 801 and a transceiver module 802. The processing module 801 may be one or more processors, and the transceiver module 802 may be a transceiver or a communication interface. The communication apparatus may be configured to implement the AP or the STA in any one of the foregoing method embodiments, or configured to implement functions of the network element in any one of the foregoing method embodiments. The network element or network function may be a network element in a hardware device, a software function running on dedicated hardware, or a virtualization function instantiated on a platform (for example, a cloud platform). Optionally, the communication apparatus 800 may further include a storage module 803, configured to store program code and data that are of the communication apparatus 800.

In an instance, when the communication apparatus is used as a STA or a chip applied to a STA, and performs the operations performed by the STA in the foregoing method embodiments, the transceiver module 802 is configured to support communication with an AP and the like, and the transceiver module performs a sending and/or receiving action performed by the STA in FIG. 6. For example, the transceiver module supports the STA in performing operation 602, and/or is configured to perform another process of the technology described in this specification. The processing module 801 may be configured to support the communication apparatus 800 in performing the processing actions in the foregoing method embodiments. For example, the processing module supports the STA in performing operation 603, and/or performs another process of the technology described in this specification.

For example, the processing module 801 is configured to generate a sounding frame. The sounding frame includes a first field, the first field includes a predefined first sequence, the first sequence includes a sequence obtained after a second sequence is modulated by using at least one of the following modulation modes, and the modulation modes include: quadrature phase shift keying QPSK, 16-quadrature amplitude modulation 16-QAM, 64-QAM, 256-QAM, 1024-QAM, and 4096-QAM. The transceiver module 802 is configured to send the sounding frame. For the first sequence, refer to related descriptions in FIG. 7. Details are not described herein again.

In an instance, when the communication apparatus is used as an AP or a chip applied to an AP, and performs the operations performed by the AP in the foregoing method embodiments, the transceiver module 802 is configured to support communication with a STA and the like, and the transceiver module performs a sending and/or receiving action performed by the AP in FIG. 6. For example, the transceiver module supports the AP in performing operation 601, and/or is configured to perform another process of the technology described in this specification. The processing module 801 may be configured to support the communication apparatus 800 in performing the processing actions in the foregoing method embodiments. For example, the processing module supports the AP in performing another process of the technology described in this specification.

For example, the transceiver module 802 is configured to receive a sounding frame. The sounding frame includes a first field, the first field includes a predefined first sequence, the first sequence includes a sequence obtained after a second sequence is modulated by using at least one of the following modulation modes, and the modulation modes include: quadrature phase shift keying QPSK, 16-quadrature amplitude modulation 16-QAM, 64-QAM, 256-QAM, 1024-QAM, and 4096-QAM. The processing module 801 is configured to perform channel measurement based on the first sequence. For the first sequence, refer to related descriptions in FIG. 7. Details are not described herein again.

In an embodiment, when the STA or the AP is a chip, the transceiver module 802 may be an input/output interface, a pin, a circuit, or the like. For example, the input/output interface may be configured to input to-be-processed data to a logic circuit, and may output a processing result of the logic circuit to the outside. In some embodiments, the input/output interface may be a general purpose input output (GPIO) interface, and may be connected to a plurality of peripheral devices (for example, a display (LCD), a camera, a radio frequency (RF) module, and an antenna). The input/output interface is connected to the processor by using a bus.

The processing module 801 may be a logic circuit, and the logic circuit may execute stored instructions, so that the chip performs the method according to the embodiment shown in FIG. 6. It may be understood that the instructions may be stored in the storage module.

The storage module may be a storage module inside the chip, for example, a register or a cache. Alternatively, the storage module may be a storage module located outside the chip, for example, a read-only memory (ROM), another type of static storage device that can store static information and instructions, or a random access memory (RAM).

It should be noted that a function corresponding to each of the logic circuit and the input/output interface may be implemented by using a hardware design, may be implemented by using a software design, or may be implemented by a combination of software and hardware. This is not limited herein.

An embodiment of this application further provides a communication apparatus, including a processor and a transceiver. The processor is configured to support the communication apparatus in performing the embodiment shown in FIG. 6. The transceiver is configured to support communication between the communication apparatus and another communication apparatus other than the communication apparatus. The communication apparatus may further include a memory. The memory is configured to be coupled to the processor, and the memory stores program instructions and data for the communication apparatus. The transceiver may be integrated into the communication apparatus or independent of the communication apparatus. This is not limited herein. For example, in a distributed scenario, the transceiver may be disposed remotely independent of the communication apparatus.

An embodiment of this application further provides a chip. The chip includes at least one logic circuit and an input/output interface. The logic circuit is configured to read and execute stored instructions. When the instructions are run, the chip is enabled to perform the embodiment shown in FIG. 6.

An embodiment of this application further provides a computer-readable storage medium. The computer-readable storage medium stores a computer program, the computer program includes program instructions, and when the program instructions are executed by a computer, the computer is enabled to perform the embodiment shown in FIG. 6.

An embodiment of this application further provides a computer program product including instructions. When the computer program product is run on a computer, the computer is enabled to implement the embodiment shown in FIG. 6.

The foregoing units described as separate parts may or may not be physically separate, and parts displayed as units may or may not be physical units, may be located in one position, or may be distributed on a plurality of network units. Some or all of the units may be selected based on an actual requirement, to achieve the objectives of the solutions in embodiments of this application. In addition, the network element units in embodiments of this application may be integrated into one processing unit, or each of the units may exist alone physically, or two or more units are integrated into one unit. The integrated unit may be implemented in a form of hardware, or may be implemented in a form of a software network element unit.

When the integrated unit is implemented in the form of a software network element unit and sold or used as an independent product, the integrated unit may be stored in a computer-readable storage medium. Based on such an understanding, a part essentially contributing to the technical solutions of this application, or all or some of the technical solutions may be embodied in a form of a software product. The computer software product is stored in a storage medium, and includes several instructions for instructing a computer device (which may be a personal computer, a server, a network device, or the like) to perform all or some of the operations of the methods described in embodiments of this application. The foregoing storage medium includes any medium that can store program code, such as a USB flash drive, a removable hard disk, a read-only memory (ROM), a random access memory (RAM), a magnetic disk, or an optical disc. The foregoing descriptions are merely examples of this application, but are not intended to limit the protection scope of this application. Any equivalent modification or replacement readily figured out by a person skilled in the art within the technical scope disclosed in this application shall fall within the protection scope of this application. Therefore, the protection scope of this application shall be subject to the protection scope of the claims.

1. An apparatus, comprising:
at least one processor, and at least one memory coupled to the at least one processor and storing programming instructions for execution by the at least one processor and causing the apparatus to:
generate a sounding frame including a first field, wherein the first field comprises a predefined first sequence having a sequence obtained after a second sequence is modulated by using at least one of the following modulation modes, and wherein the modulation modes comprise: quadrature phase shift keying QPSK, 16-quadrature amplitude modulation 16-QAM, 64-QAM, 256-QAM, 1024-QAM, and 4096-QAM; and
send the sounding frame.

2. The apparatus according to claim 1, wherein the second sequence is a high efficiency long training field HE-LTF sequence or an extremely high throughput long training field EHT-LTF sequence in a 4× mode at an 80 MHz bandwidth;
the HE-LTF sequence is:
HE-LTF₄ₓ(−500:500) =
[1, −1, −1, −1, −1, 1, −1, −1, 1, −1, −1, −1, 1, 1, −1, −1, −1, 1, −1, −1, 1, −1, 1, 1, 1, −1, 1, −1,
1, −1, −1, −1, −1, 1, 1, 1, 1, 1, −1, −1, 1, −1, 1, −1, −1, −1, 1, 1, −1, −1, 1, −1, −1, −1, 1, 1, 1, −1, −1,
1, 1, −1, −1, 1, −1, 1, 1, −1, 1, −1, 1, 1, 1, −1, 1, −1, 1, 1, 1, 1, 1, 1, −1, −1, −1, 1, −1, 1, −1, −1, −1,
1, −1, −1, 1, 1, 1, 1, 1, 1, −1, 1, −1, 1, 1, −1, 1, −1, 1, −1, 1, −1, 1, −1, −1, 1, 1, 1, 1, −1, −1, −1, −1,
−1, −1, −1, −1, 1, −1, −1, 1, −1, −1, 1, 1, 1, −1, 1, −1, −1, −1, 1, 1, 1, −1, 1, 1, −1, −1, 1, −1, −1, −1,
1, 1, 1, 1, −1, 1, 1, 1, 1, 1, 1, −1, 1, −1, −1, 1, −1, 1, −1, −1, 1, 1, 1, 1, 1, −1, 1, 1, −1, −1, 1, 1, 1, −1,
1, 1, −1, 1, 1, −1, −1, 1, 1, −1, −1, −1, −1, 1, 1, 1, 1, 1, −1, 1, 1, 1, 1, 1, −1, 1, −1, 1, −1, −1, 1, −1,
−1, −1, −1, −1, 1, −1, −1, −1, 1, 1, −1, 1, −1, 1, −1, −1, −1, −1, −1, 1, 1, 1, 1, −1, 1, −1, −1, 1, 1, −1,
−1, −1, 1, 1, 1, 1, 1, −1, 1, −1, 1, −1, −1, 1, 1, 1, −1, 1, 1, 1, 1, 1, −1, 1, 1, −1, 1, −1, 1, −1, −1, −1, −1,
−1, 1, −1, −1, −1, −1, −1, 1, 1, 1, 1, −1, −1, 1, 1, −1, −1, 1, −1, −1, 1, −1, −1, −1, 1, 1, −1, −1, 1, −1,
−1, −1, −1, −1, 1, 1, −1, 1, −1, 1, 1, −1, 1, −1, −1, −1, −1, −1, −1, 1, −1, −1, −1, −1, 1, 1, 1, −1, 1, 1,
−1, −1, 1, −1, −1, −1, 1, 1, 1, −1, 1, −1, 1, −1, −1, −1, 1, −1, 1, −1, 1, −1, −1, −1, 1, −1, −1, 1, −1, 1,
1, −1, −1, −1, 1, 1, −1, −1, −1, −1, 1, −1, 1, 1, −1, 1, −1, 1, 1, 1, 1, 1, 1, −1, −1, 1, −1, −1, −1, 1, −1,
1, −1, −1, −1, 1, 1, 1, 1, 1, 1, −1, 1, −1, 1, 1, 1, −1, 1, −1, 1, 1, −1, 1, −1, −1, 1, 1, −1, −1, 1, 1, 1, −1,
−1, −1, 1, −1, −1, 1, 1, −1, −1, −1, 1, −1, 1, −1, −1, 1, 1, 1, 1, 1, −1, −1, −1, −1, 1, −1, 1, −1, 1, 1, 1,
−1, 1, −1, −1, 1, −1, −1, −1, 1, 1, −1, −1, −1, 1, −1, −1, 1, −1, −1, −1, −1, 1, −1, 1, 1, −1, −1, −1, 1,
−1, −1, 0, 0, 0, 0, 0, −1, −1, 1, −1, 1, 1, 1, 1, 1, 1, −1, −1, −1, −1, 1, −1, −1, 1, −1, −1, −1, 1, 1, −1, −1,
−1, 1, −1, −1, 1, −1, 1, 1, 1, −1, 1, −1, 1, −1, −1, −1, −1, 1, 1, 1, 1, 1, −1, −1, 1, −1, 1, −1, −1, −1, 1,
1, −1, −1, 1, −1, −1, −1, 1, 1, 1, −1, −1, 1, 1, −1, −1, 1, −1, 1, 1, −1, 1, −1, 1, 1, 1, −1, 1, −1, 1, 1, 1,
1, 1, 1, −1, −1, −1, 1, −1, 1, −1, −1, −1, 1, −1, −1, 1, 1, 1, 1, 1, 1, −1, 1, −1, 1, 1, −1, 1, −1, −1, −1,
−1, 1, 1, −1, −1, −1, 1, 1, −1, 1, −1, −1, 1, −1, −1, −1, 1, −1, 1, −1, 1, −1, −1, −1, 1, −1, 1, −1, 1, 1, 1,
−1, −1, −1, 1, −1, −1, 1, 1, −1, 1, 1, 1, −1, −1, −1, −1, 1, −1, −1, −1, −1, −1, −1, 1, −1, 1, 1, −1, 1, −1,
1, 1, −1, −1, −1, −1, −1, 1, −1, −1, 1, 1, −1, −1, −1, 1, −1, −1, 1, −1, −1, 1, 1, −1, −1, 1, 1, 1, 1, −1,
−1, −1, −1, −1, 1, −1, −1, −1, −1, −1, 1, −1, 1, −1, 1, 1, −1, 1, 1, 1, 1, 1, −1, 1, 1, 1, −1, −1, 1, −1, 1,
−1, 1, 1, 1, 1, 1, −1, −1, −1, 1, 1, −1, −1, −1, −1, −1, −1, −1, −1, 1, 1, 1, 1, 1, −1, 1, −1, 1, −1, −1, 1, 1,
1, −1, 1, 1, 1, 1, 1, −1, 1, 1, −1, 1, −1, 1, −1, −1, −1, −1, −1, 1, −1, −1, −1, −1, −1, 1, 1, 1, 1, −1, −1,
1, 1, −1, −1, 1, −1, −1, 1, −1, −1, −1, 1, 1, −1, −1, 1, −1, −1, −1, −1, −1, 1, 1, −1, 1, −1, 1, 1, −1, 1,
−1, −1, −1, −1, −1, −1, 1, −1, −1, −1, −1, 1, 1, 1, −1, 1, 1, −1, −1, 1, −1, −1, −1, 1, 1, 1, −1, 1, −1, −1,
−1, 1, 1, −1, 1, 1, −1, 1, 1, 1, 1, 1, 1, 1, 1, −1, −1, −1, −1, 1, 1, −1, 1, −1, 1, −1, 1, −1, 1, −1, −1, 1,
−1, 1, −1, −1, −1, −1, −1, −1, 1, 1, −1, 1, 1, 1, −1, 1, −1, 1, 1, 1, −1, −1, −1, −1, −1, −1, 1, −1, 1, −1,
−1, −1, 1, −1, 1, −1, −1, 1, −1, 1, 1, −1, −1, 1, 1, −1, −1, −1, 1, 1, 1, −1, 1, 1, −1, −1, 1, 1, 1, −1, 1, −1,
1, 1, −1, −1, −1, −1, −1, 1, 1, 1, 1, −1, 1, −1, 1, −1, −1, −1, 1, −1, 1, 1, −1, 1, 1, 1, −1, −1, 1, 1, 1, −1,
1, 1, −1, 1, 1, 1, 1, −1;
and
the EHT-LTF sequence is:
HE-LTF₄ₓ(−500:500) =
[1, −1, −1, −1, −1, 1, −1, −1, 1, −1, −1, −1, 1, 1, −1, −1, −1, 1, −1, −1, 1, −1, 1, 1, 1, −1, 1, −1,
1, −1, −1, −1, −1, 1, 1, 1, 1, 1, −1, −1, 1, −1, 1, −1, −1, −1, 1, 1, −1, −1, 1, −1, −1, −1, 1, 1, 1, −1, −1,
1, 1, −1, −1, 1, −1, 1, 1, −1, 1, −1, 1, 1, 1, −1, 1, −1, 1, 1, 1, 1, 1, 1, −1, −1, −1, 1, −1, 1, −1, −1, −1,
1, −1, −1, 1, 1, 1, 1, 1, 1, −1, 1, −1, 1, 1, −1, 1, −1, 1, −1, 1, −1, 1, −1, −1, 1, 1, 1, 1, −1, −1, −1, −1,
−1, −1, −1, −1, 1, −1, −1, 1, −1, −1, 1, 1, 1, −1, 1, −1, −1, −1, 1, 1, 1, −1, 1, 1, −1, −1, 1, −1, −1, −1,
1, 1, 1, 1, −1, 1, 1, 1, 1, 1, 1, −1, 1, −1, −1, 1, −1, 1, −1, −1, 1, 1, 1, 1, 1, −1, 1, 1, −1, −1, 1, 1, 1, −1,
1, 1, −1, 1, 1, −1, −1, 1, 1, −1, −1, −1, −1, 1, 1, 1, 1, 1, −1, 1, 1, 1, 1, 1, −1, 1, −1, 1, −1, −1, 1, −1,
−1, −1, −1, −1, 1, −1, −1, −1, 1, 1, −1, 1, −1, 1, −1, −1, −1, −1, −1, 1, 1, 1, 1, −1, 1, −1, −1, 1, 1, −1,
−1, −1, 1, 1, 1, 1, 1, −1, 1, −1, 1, −1, −1, 1, 1, 1, −1, 1, 1, 1, 1, 1, −1, 1, 1, −1, 1, −1, 1, −1, −1, −1, −1,
−1, 1, −1, −1, −1, −1, −1, 1, 1, 1, 1, −1, −1, 1, 1, −1, −1, 1, −1, −1, 1, −1, −1, −1, 1, 1, −1, −1, 1, −1,
−1, −1, −1, −1, 1, 1, −1, 1, −1, 1, 1, −1, 1, −1, −1, −1, −1, −1, −1, 1, −1, −1, −1, −1, 1, 1, 1, −1, 1, 1,
−1, −1, 1, −1, −1, −1, 1, 1, 1, −1, 1, −1, 1, −1, −1, −1, 1, −1, 1, −1, 1, −1, −1, −1, 1, −1, −1, 1, −1, 1,
1, −1, −1, −1, 1, 1, −1, −1, −1, −1, 1, −1, 1, 1, −1, 1, −1, 1, 1, 1, 1, 1, 1, −1, −1, 1, −1, −1, −1, 1, −1,
1, −1, −1, −1, 1, 1, 1, 1, 1, 1, −1, 1, −1, 1, 1, 1, −1, 1, −1, 1, 1, −1, 1, −1, −1, 1, 1, −1, −1, 1, 1, 1, −1,
−1, −1, 1, −1, −1, 1, 1, −1, −1, −1, 1, −1, 1, −1, −1, 1, 1, 1, 1, 1, −1, −1, −1, −1, 1, −1, 1, −1, 1, 1, 1,
−1, 1, −1, −1, 1, −1, −1, −1, 1, 1, −1, −1, −1, 1, −1, −1, 1, −1, −1, −1, −1, 1, −1, 1, 1, −1, −1, −1, 1,
−1, −1, 0, 0, 0, 0, 0, −1, −1, 1, −1, 1, 1, 1, 1, 1, 1, −1, −1, −1, −1, 1, −1, −1, 1, −1, −1, −1, 1, 1, −1, −1,
−1, 1, −1, −1, 1, −1, 1, 1, 1, −1, 1, −1, 1, −1, −1, −1, −1, 1, 1, 1, 1, 1, −1, −1, 1, −1, 1, −1, −1, −1, 1,
1, −1, −1, 1, −1, −1, −1, 1, 1, 1, −1, −1, 1, 1, −1, −1, 1, −1, 1, 1, −1, 1, −1, 1, 1, 1, −1, 1, −1, 1, 1, 1,
1, 1, 1, −1, −1, −1, 1, −1, 1, −1, −1, −1, 1, −1, −1, 1, 1, 1, 1, 1, 1, −1, 1, −1, 1, 1, −1, 1, −1, −1, −1,
−1, 1, 1, −1, −1, −1, 1, 1, −1, 1, −1, −1, 1, −1, −1, −1, 1, −1, 1, −1, 1, −1, −1, −1, 1, −1, 1, −1, 1, 1, 1,
−1, −1, −1, 1, −1, −1, 1, 1, −1, 1, 1, 1, −1, −1, −1, −1, 1, −1, −1, −1, −1, −1, −1, 1, −1, 1, 1, −1, 1, −1,
1, 1, −1, −1, −1, −1, −1, 1, −1, −1, 1, 1, −1, −1, −1, 1, −1, −1, 1, −1, −1, 1, 1, −1, −1, 1, 1, 1, 1, −1,
−1, −1, −1, −1, 1, −1, −1, −1, −1, −1, 1, −1, 1, −1, 1, 1, −1, 1, 1, 1, 1, 1, −1, 1, 1, 1, −1, −1, 1, −1, 1,
−1, 1, 1, 1, 1, 1, −1, −1, −1, 1, 1, −1, −1, −1, −1, −1, −1, −1, −1, 1, 1, 1, 1, 1, −1, 1, −1, 1, −1, −1, 1, 1,
1, −1, 1, 1, 1, 1, 1, −1, 1, 1, −1, 1, −1, 1, −1, −1, −1, −1, −1, 1, −1, −1, −1, −1, −1, 1, 1, 1, 1, −1, −1,
1, 1, −1, −1, 1, −1, −1, 1, −1, −1, −1, 1, 1, −1, −1, 1, −1, −1, −1, −1, −1, 1, 1, −1, 1, −1, 1, 1, −1, 1,
−1, −1, −1, −1, −1, −1, 1, −1, −1, −1, −1, 1, 1, 1, −1, 1, 1, −1, −1, 1, −1, −1, −1, 1, 1, 1, −1, 1, −1, −1,
−1, 1, 1, −1, 1, 1, −1, 1, 1, 1, 1, 1, 1, 1, 1, −1, −1, −1, −1, 1, 1, −1, 1, −1, 1, −1, 1, −1, 1, −1, −1, 1,
−1, 1, −1, −1, −1, −1, −1, −1, 1, 1, −1, 1, 1, 1, −1, 1, −1, 1, 1, 1, −1, −1, −1, −1, −1, −1, 1, −1, 1, −1,
−1, −1, 1, −1, 1, −1, −1, 1, −1, 1, 1, −1, −1, 1, 1, −1, −1, −1, 1, 1, 1, −1, 1, 1, −1, −1, 1, 1, 1, −1, 1, −1,
1, 1, −1, −1, −1, −1, −1, 1, 1, 1, 1, −1, 1, −1, 1, −1, −1, −1, 1, −1, 1, 1, −1, 1, 1, 1, −1, −1, 1, 1, 1, −1,
1, 1, −1, 1, 1, 1, 1, −1],
wherein
wherein HE−LTF_{4×}(−500: 500) means that values on tones whose sequence numbers are −500 to 500 are values in the HE-LTF sequence successively; and
wherein EHT-31 LTF_{4×}(−500: 500) means that values on tones whose sequence numbers are −500 to 500 are values in the EHT-LTF sequence successively.

3. The apparatus according to claim 1, wherein the first sequence meets the following formula:
sᵢ=[a₀, cᵢ, 0,0,0,0,0, (−1j)*a₁], wherein
the second sequence is the HE-LTF sequence, a₀ and a₁ are subsequences in the HE-LTF sequence, j is an imaginary unit, and i is an integer greater than or equal to 1 and less than or equal to 7;
c₁=[1j,1j,1j,−1j,−1j,−1j,1j,1j,−1j];
c₂=[−1,−1,−1,−1j, j,1j,−1j];
c₃=[−1,−1,−1,1,1,−1j,1j,1j,−1j];
c₄=[−1,−1,−1,1,1,1,1j,−1],
c₅=[−1,−1,−1,1,1,1,−1,1j,−1j];
c₆=[−1,−1,−1,1,1,1,−1,−1,−1j]; and
c₇=[−1,−1,−1,1,1,1,−1,−1,1].

4. The apparatus according to claim 1, wherein the first sequence meets the following formula:
$${q}_{1} = \frac{2}{\sqrt{5}} {e}^{\frac{j π}{4}} {s}_{k 1} + \frac{1}{\sqrt{5}} {e}^{\frac{j π}{4}} {s}_{k 2} ,$$
wherein
sₖ₁=[a₀, c_{k1,0,0,0,0,0}, (−1j)*a₁]; sₖ₂=[a₀, c_{k2,0,0,0,0,0}, (−1j)*a₁]; and the second sequence is the HE-LTF sequence, a₀ and a₁ are subsequences in the HE-LTF sequence, and j is an imaginary unit, wherein
k1 is 1, and k2 is 7; or
k1 is 4, and k2 is 5 or 6; or
k1 is 5, and k2 is 1 or 2;
c₁=[1j,1j,1j,−1j,−1j,−1j,1j,1j,−1j];
c₂=[−1,−1,−1,−1j,−1j,−1j,1j,1j,−1j];
c₄=[−1,−1,−1,1,1,1,1j,1j,−1j];
c₆=[−1,−1,−1,1,1,1,−1,−1j,−1j]; and
c₇=[−1,−1,−1,1,1,1,−1,−1,1j].

5. The apparatus according to claim 1, wherein the first sequence meets the following formula:
$${q}_{2} = \frac{4}{\sqrt{21}} {e}^{\frac{j π}{4}} {s}_{k 3} + \frac{2}{\sqrt{21}} {e}^{\frac{j π}{4}} {s}_{k 4} + \frac{1}{\sqrt{21}} {e}^{\frac{j π}{4}} {s}_{k 5} ,$$
wherein
sₖ₃=[a₀, c_{k3,0,0,0,0,0}, (−1j)*a₁]; sₖ₄=[a₀, c_{k4,0,0,0,0,0}, (−1j)*a₁]; sₖ₅=[a₀, c_{k5,0,0,0,0,0}, (−1j)*a₁]; and the second sequence is the HE-LTF sequence, a₀ and a₁ are subsequences in the HE-LTF sequence, and j is an imaginary unit, wherein
k3 is 1, k4 is 6, and k5 is 7; or
k3 is 1, k4 is 7, and k5 is 5 or 6; or
k3 is 2, k4 is 7, and k5 is 6 or 7; or
k3 is 3, k4 is 5, and k5 is 6; or
k3 is 3, k4 is 5, and k5 is 7; or
k3 is 3, k4 is 6, and k5 is 5 or 6; or
k3 is 3, k4 is 7, and k5 is 1, 2, 3, or 4; or
k3 is 4, k4 is 4, and k5 is 7; or
k3 is 4, k4 is 5, and k5 is 3, 4, or 5; or
k3 is 4, k4 is 6, and k5 is 1, 2, 3, or 4; or
k3 is 5, k4 is 1, and k5 is 3 or 4; or
k3 is 5, k4 is 1, and k5 is 5; or
k3 is 5, k4 is 2, and k5 is 4, 5, or 6; or
k3 is 5, k4 is 3, and k5 is 1, 2, 3, or 4; or
k3 is 5, k4 is 4, and k5 is 1 or 2; or
k3 is 6, k4 is 1, and k5 is 1 or 2; or
k3 is 6, k4 is 2, and k5 is 1, 2, or 3;
c₁=[1j,1j,1j,−1j,−1j,−1j,1j,1j,−1j];
c₂=[−1,−1,−1,−1j,−1j,−1j,1j,1j,−1j];
c₃=[−1, −1,−1,1,1,−1j,1j,1j,−1j];
c₄=[−1,−1,−1,1,1,1,1j,1j,−1j];
c₅=[−1,−1,−1,1,1,1,−1,1j,−1j];
c₆=[−1,−1,−1,1,1,1,−1,−1,−1j]; and
c₇=[−1,−1,−1,1,1,1,−1,−1,1].

6. The apparatus according to claim 1, wherein the first sequence meets the following formula:
$${q}_{3} = \frac{8}{\sqrt{85}} {e}^{\frac{j π}{4}} {s}_{k 6} + \frac{4}{\sqrt{85}} {e}^{\frac{j π}{4}} {s}_{k 7} + \frac{2}{\sqrt{85}} {e}^{\frac{j π}{4}} {s}_{k 8} + \frac{1}{\sqrt{85}} {e}^{\frac{j π}{4}} {s}_{k 9} ,$$
wherein
sₖ₆=[a₀, c_{k6,0,0,0,0,0}, (−1j)*a₁]; sₖ₇=[a₀, c_{k7,0,0,0,0,0}, (−1j)*a₁]; sₖ₈=[a₀, c_{k8,0,0,0,0,0}, (−1j)*a₁]; sₖ₉=[a₀, c_{k9,0,0,0,0,0}, (−1j)*a₁]; and the second sequence is the HE-LTF sequence, a₀ and a₁ are subsequences in the HE-LTF sequence, and j is an imaginary unit, wherein
k6 is 1, k7 is 7, k8 is 4, and k9 is 7; or
k6 is 1, k7 is 7, k8 is 6, and k9 is 3; or
k6 is 2, k7 is 7, k8 is 7, and k9 is 4; or
k6 is 3, k7 is 5, k8 is 7, and k9 is 4; or
k6 is 3, k7 is 6, k8 is 5, and k9 is 5; or
k6 is 3, k7 is 7, k8 is 1, and k9 is 5; or
k6 is 3, k7 is 7, k8 is 2, and k9 is 6; or
k6 is 3, k7 is 7, k8 is 3, and k9 is 4; or
k6 is 4, k7 is 4, k8 is 6, and k9 is 7; or
k6 is 4, k7 is 6, k8 is 1, and k9 is 6; or
k6 is 4, k7 is 6, k8 is 4, and k9 is 3; or
k6 is 5, k7 is 1, k8 is 1, and k9 is 7; or
k6 is 5, k7 is 2, k8 is 6, and k9 is 2; or
k6 is 5, k7 is 4, k8 is 1, and k9 is 1; or
k6 is 5, k7 is 4, k8 is 2, and k9 is 3; or
k6 is 6, k7 is 1, k8 is 1, and k9 is 1;
c₁=[1j,1j,1j,−1j,−1j,−1j,1j,1j,−1];
c₂=[−1,−1,−1,−1j,−1j,−1j,1j,1j,−1j];
c₃=[−1,−1,−1,1,1,−1j,1j,1j,−1j];
c₄=[−1,−1,−1,1,1,1,1j,1j];
c₅=[−1,−1,−1,1,1,1,−1,1j,−1j];
c₆=[−1,−1,−1,1,1,1,−1,−1,−1j]; and
c₇=[−1,−1,−1,1,1,1,−1,−1,1].

7. The apparatus according to claim 1, wherein the first sequence meets the following formula:
$${q}_{4} = \frac{16}{\sqrt{341}} {e}^{\frac{j π}{4}} {s}_{k 10} + \frac{8}{\sqrt{341}} {e}^{\frac{j π}{4}} {s}_{k 11} + \frac{4}{\sqrt{341}} {e}^{\frac{j π}{4}} {s}_{k 12} + \frac{2}{\sqrt{341}} {e}^{\frac{j π}{4}} {s}_{k 13} + \frac{1}{\sqrt{345}} {e}^{\frac{j π}{4}} {s}_{k 14} ,$$
wherein
sₖ₁₀=[a₀, c_{k10,0,0,0,0,0}, (−1j)*a₁]; sₖ₁₁=[a₀, c_{k11,0,0,0,0,0}, (−1j)*a₁]; sₖ₁₂=[a₀, c_{k12,0,0,0,0,0}, (−1j)*a₁]; sₖ₁₃=[a₀, c_{k13,0,0,0,0,0}, (−1j)*a₁]; sₖ₁₄=[a₀, c_{k14,0,0,0,0,0}, (−1j)*a₁]; and the second sequence is the HE-LTF sequence, a₀ and a₁ are subsequences in the HE-LTF sequence, and j is an imaginary unit, wherein
k10 is 1, k11 is 7, k12 is 6, k13 is 1, and k14 is 5; or
k10 is 2, k11 is 7, k12 is 5, k13 is 7, and k14 is 5; or
k10 is 6, k11 is 1, k12 is 2, k13 is 4, and k14 is 4; or
k10 is 4, k11 is 6, k12 is 4, k13 is 1, and k14 is 6; or
k10 is 6, k11 is 2, k12 is 1, k13 is 4, and k14 is 5; or
k10 is 3, k11 is 6, k12 is 7, k13 is 1, and k14 is 2; or
k10 is 5, k11 is 3, k12 is 1, k13 is 6, and k14 is 1; or
k10 is 4, k11 is 6, k12 is 2, k13 is 6, and k14 is 6;
c₁=[1j,1j,1j,−1j,−1j,−1j,1j,1j,−1j];
c₂=[−1,−1,−1,−1j,−1j,−1j,1j,1j,−1j];
c₃=[−1,−1,−1,1,1,−1j,1j,1j,−1j];
c₄=[−1,−1,−1,1,1,1,1j,−1j];
c₅=[−1,−1,−1,1,1,1,−1,1j,−1j];
c₆=[−1,−1,−1,1,1,1,−1,−1,−1j]; and
c₇=[−1,−1,−1,1,1,1,−1,−1,−1];

8. The apparatus according to claim 1, wherein the first sequence meets the following formula:
$${q}_{5} = \frac{16}{\sqrt{1365}} {e}^{\frac{j π}{4}} {s}_{k 15} + \frac{16}{\sqrt{1365}} {e}^{\frac{j π}{4}} {s}_{k 16} + \frac{8}{\sqrt{1365}} {e}^{\frac{j π}{4}} {s}_{k 17} + \frac{4}{\sqrt{1365}} {e}^{\frac{j π}{4}} {s}_{k 18} + \frac{2}{\sqrt{1365}} {e}^{\frac{j π}{4}} {s}_{k 19} + \frac{1}{\sqrt{1365}} {e}^{\frac{j π}{4}} {s}_{k 20} ,$$
wherein
sₖ₁₅=[a₀, c_{k15,0,0,0,0,0}, (−1j)*a₁]; sₖ₁₆=[a₀, c_{k16,0,0,0,0,0}, (−1j)*a₁]; sₖ₁₇=[a₀, c_{k17,0,0,0,0,0}, (−1j)*a₁]; sₖ₁₈=[a₀, c_{k18,0,0,0,0,0}, (−1j)*a₁]; sₖ₁₉=[a₀, c_{k19,0,0,0,0,0}, (−1j)*a₁]; sₖ₂₀=[a₀, c_{k20,0,0,0,0,0}, (−1j)*a₁]; and the second sequence is the HE-LTF sequence, a₀ and a₁ are subsequences in the HE-LTF sequence, and j is an imaginary unit, wherein
k15 is 5, k16 is 2, k17 is 4, k18 is 7, k19 is 2, and k20 is 5; or
k15 is 5, k16 is 2, k17 is 5, k18 is 1, k19 is 7, and k20 is 2; or
k15 is 6, k16 is 2, k17 is 2, k18 is 3, k19 is 7, and k20 is 5; or
k15 is 3, k16 is 6, k17 is 6, k18 is 4, k19 is 5, and k20 is 4; or
k15 is 4, k16 is 7, k17 is 2, k18 is 2, k19 is 3, and k20 is 2; or
k15 is 6, k16 is 1, k17 is 2, k18 is 3, k19 is 5, and k20 is 4; or
k15 is 2, k16 is 7, k17 is 7, k18 is 3, k19 is 6, and k20 is 3; or
k15 is 1, k16 is 7, k17 is 5, k18 is 5, k19 is 4, and k20 is 2;
c₁=[1j,1j,1j,−1j,−1j,−1j,1j,1j,−1j];
c₂=[−1,−1,−1,−1j, −1j,−1j,1j,1j,−1j];
c₃=[−1,−1,−1,1,1,−1j,1j,1j,−1j];
c₄=[−1,−1,−1,1,1,1,1j,−1j];
c₅=[−1,−1,−1,1,1,1,−1,1j,−1j];
c₆=[−1,−1,−1,1,1,1,−1,−1,−1j]; and
c₇=[−1,−1,−1,1,1,1,−1,−1,1].

9. The apparatus according to claim 3, wherein a₀ is a subsequence of 1^{st} to 489^{th} elements in the HE-LTF sequence, and a₁ is a subsequence of 504^{th} to 1001^{st} elements in the HE-LTF sequence.

10. An apparatus, comprising:
at least one processor, and
at least one memory coupled to the at least one processor and storing programming instructions for execution by the at least one processor and causing the apparatus to:
receive a sounding frame including a first field, wherein the first field comprises a predefined first sequence having a sequence obtained after a second sequence is modulated by using at least one of the following modulation modes, and wherein the modulation modes comprise: quadrature phase shift keying QPSK, 16-quadrature amplitude modulation 16-QAM, 64-QAM, 256-QAM, 1024-QAM, and 4096-QAM; and
perform channel measurement based on the first sequence.

11. The apparatus according to claim 10, wherein the second sequence is a high efficiency long training field HE-LTF sequence or an extremely high throughput long training field EHT-LTF sequence in a 4× mode at an 80 MHz bandwidth;
the HE-LTF sequence is:
HE-LTF₄ₓ(−500:500) =
[1, −1, −1, −1, −1, 1, −1, −1, 1, −1, −1, −1, 1, 1, −1, −1, −1, 1, −1, −1, 1, −1, 1, 1, 1, −1, 1, −1,
1, −1, −1, −1, −1, 1, 1, 1, 1, 1, −1, −1, 1, −1, 1, −1, −1, −1, 1, 1, −1, −1, 1, −1, −1, −1, 1, 1, 1, −1, −1,
1, 1, −1, −1, 1, −1, 1, 1, −1, 1, −1, 1, 1, 1, −1, 1, −1, 1, 1, 1, 1, 1, 1, −1, −1, −1, 1, −1, 1, −1, −1, −1,
1, −1, −1, 1, 1, 1, 1, 1, 1, −1, 1, −1, 1, 1, −1, 1, −1, 1, −1, 1, −1, 1, −1, −1, 1, 1, 1, 1, −1, −1, −1, −1,
−1, −1, −1, −1, 1, −1, −1, 1, −1, −1, 1, 1, 1, −1, 1, −1, −1, −1, 1, 1, 1, −1, 1, 1, −1, −1, 1, −1, −1, −1,
1, 1, 1, 1, −1, 1, 1, 1, 1, 1, 1, −1, 1, −1, −1, 1, −1, 1, −1, −1, 1, 1, 1, 1, 1, −1, 1, 1, −1, −1, 1, 1, 1, −1,
1, 1, −1, 1, 1, −1, −1, 1, 1, −1, −1, −1, −1, 1, 1, 1, 1, 1, −1, 1, 1, 1, 1, 1, −1, 1, −1, 1, −1, −1, 1, −1,
−1, −1, −1, −1, 1, −1, −1, −1, 1, 1, −1, 1, −1, 1, −1, −1, −1, −1, −1, 1, 1, 1, 1, −1, 1, −1, −1, 1, 1, −1,
−1, −1, 1, 1, 1, 1, 1, −1, 1, −1, 1, −1, −1, 1, 1, 1, −1, 1, 1, 1, 1, 1, −1, 1, 1, −1, 1, −1, 1, −1, −1, −1, −1,
−1, 1, −1, −1, −1, −1, −1, 1, 1, 1, 1, −1, −1, 1, 1, −1, −1, 1, −1, −1, 1, −1, −1, −1, 1, 1, −1, −1, 1, −1,
−1, −1, −1, −1, 1, 1, −1, 1, −1, 1, 1, −1, 1, −1, −1, −1, −1, −1, −1, 1, −1, −1, −1, −1, 1, 1, 1, −1, 1, 1,
−1, −1, 1, −1, −1, −1, 1, 1, 1, −1, 1, −1, 1, −1, −1, −1, 1, −1, 1, −1, 1, −1, −1, −1, 1, −1, −1, 1, −1, 1,
1, −1, −1, −1, 1, 1, −1, −1, −1, −1, 1, −1, 1, 1, −1, 1, −1, 1, 1, 1, 1, 1, 1, −1, −1, 1, −1, −1, −1, 1, −1,
1, −1, −1, −1, 1, 1, 1, 1, 1, 1, −1, 1, −1, 1, 1, 1, −1, 1, −1, 1, 1, −1, 1, −1, −1, 1, 1, −1, −1, 1, 1, 1, −1,
−1, −1, 1, −1, −1, 1, 1, −1, −1, −1, 1, −1, 1, −1, −1, 1, 1, 1, 1, 1, −1, −1, −1, −1, 1, −1, 1, −1, 1, 1, 1,
−1, 1, −1, −1, 1, −1, −1, −1, 1, 1, −1, −1, −1, 1, −1, −1, 1, −1, −1, −1, −1, 1, −1, 1, 1, −1, −1, −1, 1,
−1, −1, 0, 0, 0, 0, 0, −1, −1, 1, −1, 1, 1, 1, 1, 1, 1, −1, −1, −1, −1, 1, −1, −1, 1, −1, −1, −1, 1, 1, −1, −1,
−1, 1, −1, −1, 1, −1, 1, 1, 1, −1, 1, −1, 1, −1, −1, −1, −1, 1, 1, 1, 1, 1, −1, −1, 1, −1, 1, −1, −1, −1, 1,
1, −1, −1, 1, −1, −1, −1, 1, 1, 1, −1, −1, 1, 1, −1, −1, 1, −1, 1, 1, −1, 1, −1, 1, 1, 1, −1, 1, −1, 1, 1, 1,
1, 1, 1, −1, −1, −1, 1, −1, 1, −1, −1, −1, 1, −1, −1, 1, 1, 1, 1, 1, 1, −1, 1, −1, 1, 1, −1, 1, −1, −1, −1,
−1, 1, 1, −1, −1, −1, 1, 1, −1, 1, −1, −1, 1, −1, −1, −1, 1, −1, 1, −1, 1, −1, −1, −1, 1, −1, 1, −1, 1, 1, 1,
−1, −1, −1, 1, −1, −1, 1, 1, −1, 1, 1, 1, −1, −1, −1, −1, 1, −1, −1, −1, −1, −1, −1, 1, −1, 1, 1, −1, 1, −1,
1, 1, −1, −1, −1, −1, −1, 1, −1, −1, 1, 1, −1, −1, −1, 1, −1, −1, 1, −1, −1, 1, 1, −1, −1, 1, 1, 1, 1, −1,
−1, −1, −1, −1, 1, −1, −1, −1, −1, −1, 1, −1, 1, −1, 1, 1, −1, 1, 1, 1, 1, 1, −1, 1, 1, 1, −1, −1, 1, −1, 1,
−1, 1, 1, 1, 1, 1, −1, −1, −1, 1, 1, −1, −1, −1, −1, −1, −1, −1, −1, 1, 1, 1, 1, 1, −1, 1, −1, 1, −1, −1, 1, 1,
1, −1, 1, 1, 1, 1, 1, −1, 1, 1, −1, 1, −1, 1, −1, −1, −1, −1, −1, 1, −1, −1, −1, −1, −1, 1, 1, 1, 1, −1, −1,
1, 1, −1, −1, 1, −1, −1, 1, −1, −1, −1, 1, 1, −1, −1, 1, −1, −1, −1, −1, −1, 1, 1, −1, 1, −1, 1, 1, −1, 1,
−1, −1, −1, −1, −1, −1, 1, −1, −1, −1, −1, 1, 1, 1, −1, 1, 1, −1, −1, 1, −1, −1, −1, 1, 1, 1, −1, 1, −1, −1,
−1, 1, 1, −1, 1, 1, −1, 1, 1, 1, 1, 1, 1, 1, 1, −1, −1, −1, −1, 1, 1, −1, 1, −1, 1, −1, 1, −1, 1, −1, −1, 1,
−1, 1, −1, −1, −1, −1, −1, −1, 1, 1, −1, 1, 1, 1, −1, 1, −1, 1, 1, 1, −1, −1, −1, −1, −1, −1, 1, −1, 1, −1,
−1, −1, 1, −1, 1, −1, −1, 1, −1, 1, 1, −1, −1, 1, 1, −1, −1, −1, 1, 1, 1, −1, 1, 1, −1, −1, 1, 1, 1, −1, 1, −1,
1, 1, −1, −1, −1, −1, −1, 1, 1, 1, 1, −1, 1, −1, 1, −1, −1, −1, 1, −1, 1, 1, −1, 1, 1, 1, −1, −1, 1, 1, 1, −1,
1, 1, −1, 1, 1, 1, 1, −1];
and
the EHT-LTF sequence is:
HE-LTF₄ₓ(−500:500) =
[1, −1, −1, −1, −1, 1, −1, −1, 1, −1, −1, −1, 1, 1, −1, −1, −1, 1, −1, −1, 1, −1, 1, 1, 1, −1, 1, −1,
1, −1, −1, −1, −1, 1, 1, 1, 1, 1, −1, −1, 1, −1, 1, −1, −1, −1, 1, 1, −1, −1, 1, −1, −1, −1, 1, 1, 1, −1, −1,
1, 1, −1, −1, 1, −1, 1, 1, −1, 1, −1, 1, 1, 1, −1, 1, −1, 1, 1, 1, 1, 1, 1, −1, −1, −1, 1, −1, 1, −1, −1, −1,
1, −1, −1, 1, 1, 1, 1, 1, 1, −1, 1, −1, 1, 1, −1, 1, −1, 1, −1, 1, −1, 1, −1, −1, 1, 1, 1, 1, −1, −1, −1, −1,
−1, −1, −1, −1, 1, −1, −1, 1, −1, −1, 1, 1, 1, −1, 1, −1, −1, −1, 1, 1, 1, −1, 1, 1, −1, −1, 1, −1, −1, −1,
1, 1, 1, 1, −1, 1, 1, 1, 1, 1, 1, −1, 1, −1, −1, 1, −1, 1, −1, −1, 1, 1, 1, 1, 1, −1, 1, 1, −1, −1, 1, 1, 1, −1,
1, 1, −1, 1, 1, −1, −1, 1, 1, −1, −1, −1, −1, 1, 1, 1, 1, 1, −1, 1, 1, 1, 1, 1, −1, 1, −1, 1, −1, −1, 1, −1,
−1, −1, −1, −1, 1, −1, −1, −1, 1, 1, −1, 1, −1, 1, −1, −1, −1, −1, −1, 1, 1, 1, 1, −1, 1, −1, −1, 1, 1, −1,
−1, −1, 1, 1, 1, 1, 1, −1, 1, −1, 1, −1, −1, 1, 1, 1, −1, 1, 1, 1, 1, 1, −1, 1, 1, −1, 1, −1, 1, −1, −1, −1, −1,
−1, 1, −1, −1, −1, −1, −1, 1, 1, 1, 1, −1, −1, 1, 1, −1, −1, 1, −1, −1, 1, −1, −1, −1, 1, 1, −1, −1, 1, −1,
−1, −1, −1, −1, 1, 1, −1, 1, −1, 1, 1, −1, 1, −1, −1, −1, −1, −1, −1, 1, −1, −1, −1, −1, 1, 1, 1, −1, 1, 1,
−1, −1, 1, −1, −1, −1, 1, 1, 1, −1, 1, −1, 1, −1, −1, −1, 1, −1, 1, −1, 1, −1, −1, −1, 1, −1, −1, 1, −1, 1,
1, −1, −1, −1, 1, 1, −1, −1, −1, −1, 1, −1, 1, 1, −1, 1, −1, 1, 1, 1, 1, 1, 1, −1, −1, 1, −1, −1, −1, 1, −1,
1, −1, −1, −1, 1, 1, 1, 1, 1, 1, −1, 1, −1, 1, 1, 1, −1, 1, −1, 1, 1, −1, 1, −1, −1, 1, 1, −1, −1, 1, 1, 1, −1,
−1, −1, 1, −1, −1, 1, 1, −1, −1, −1, 1, −1, 1, −1, −1, 1, 1, 1, 1, 1, −1, −1, −1, −1, 1, −1, 1, −1, 1, 1, 1,
−1, 1, −1, −1, 1, −1, −1, −1, 1, 1, −1, −1, −1, 1, −1, −1, 1, −1, −1, −1, −1, 1, −1, 1, 1, −1, −1, −1, 1,
−1, −1, 0, 0, 0, 0, 0, −1, −1, 1, −1, 1, 1, 1, 1, 1, 1, −1, −1, −1, −1, 1, −1, −1, 1, −1, −1, −1, 1, 1, −1, −1,
−1, 1, −1, −1, 1, −1, 1, 1, 1, −1, 1, −1, 1, −1, −1, −1, −1, 1, 1, 1, 1, 1, −1, −1, 1, −1, 1, −1, −1, −1, 1,
1, −1, −1, 1, −1, −1, −1, 1, 1, 1, −1, −1, 1, 1, −1, −1, 1, −1, 1, 1, −1, 1, −1, 1, 1, 1, −1, 1, −1, 1, 1, 1,
1, 1, 1, −1, −1, −1, 1, −1, 1, −1, −1, −1, 1, −1, −1, 1, 1, 1, 1, 1, 1, −1, 1, −1, 1, 1, −1, 1, −1, −1, −1,
−1, 1, 1, −1, −1, −1, 1, 1, −1, 1, −1, −1, 1, −1, −1, −1, 1, −1, 1, −1, 1, −1, −1, −1, 1, −1, 1, −1, 1, 1, 1,
−1, −1, −1, 1, −1, −1, 1, 1, −1, 1, 1, 1, −1, −1, −1, −1, 1, −1, −1, −1, −1, −1, −1, 1, −1, 1, 1, −1, 1, −1,
1, 1, −1, −1, −1, −1, −1, 1, −1, −1, 1, 1, −1, −1, −1, 1, −1, −1, 1, −1, −1, 1, 1, −1, −1, 1, 1, 1, 1, −1,
−1, −1, −1, −1, 1, −1, −1, −1, −1, −1, 1, −1, 1, −1, 1, 1, −1, 1, 1, 1, 1, 1, −1, 1, 1, 1, −1, −1, 1, −1, 1,
−1, 1, 1, 1, 1, 1, −1, −1, −1, 1, 1, −1, −1, −1, −1, −1, −1, −1, −1, 1, 1, 1, 1, 1, −1, 1, −1, 1, −1, −1, 1, 1,
1, −1, 1, 1, 1, 1, 1, −1, 1, 1, −1, 1, −1, 1, −1, −1, −1, −1, −1, 1, −1, −1, −1, −1, −1, 1, 1, 1, 1, −1, −1,
1, 1, −1, −1, 1, −1, −1, 1, −1, −1, −1, 1, 1, −1, −1, 1, −1, −1, −1, −1, −1, 1, 1, −1, 1, −1, 1, 1, −1, 1,
−1, −1, −1, −1, −1, −1, 1, −1, −1, −1, −1, 1, 1, 1, −1, 1, 1, −1, −1, 1, −1, −1, −1, 1, 1, 1, −1, 1, −1, −1,
−1, 1, 1, −1, 1, 1, −1, 1, 1, 1, 1, 1, 1, 1, 1, −1, −1, −1, −1, 1, 1, −1, 1, −1, 1, −1, 1, −1, 1, −1, −1, 1,
−1, 1, −1, −1, −1, −1, −1, −1, 1, 1, −1, 1, 1, 1, −1, 1, −1, 1, 1, 1, −1, −1, −1, −1, −1, −1, 1, −1, 1, −1,
−1, −1, 1, −1, 1, −1, −1, 1, −1, 1, 1, −1, −1, 1, 1, −1, −1, −1, 1, 1, 1, −1, 1, 1, −1, −1, 1, 1, 1, −1, 1, −1,
1, 1, −1, −1, −1, −1, −1, 1, 1, 1, 1, −1, 1, −1, 1, −1, −1, −1, 1, −1, 1, 1, −1, 1, 1, 1, −1, −1, 1, 1, 1, −1,
1, 1, −1, 1, 1, 1, 1, −1],
wherein
wherein HE−LTF_{4×}(−500: 500) means that values on tones whose sequence numbers are −500 to 500 are values in the HE-LTF sequence successively; and
wherein EHT−LTF_{4×}(−500: 500) means that values on tones whose sequence numbers are −500 to 500 are values in the EHT-LTF sequence successively.

12. The apparatus according to claim 10, wherein the first sequence meets the following formula:
sᵢ=[a₀, cᵢ, 0,0,0,0,0, (−1j)*a₁], wherein the second sequence is the HE-LTF sequence, a₀ and a₁ are subsequences in the HE-LTF sequence, j is an imaginary unit, and i is an integer greater than or equal to 1 and less than or equal to 7;
c₁=[1j,1j,1j,−1j,−1j,−1j,1j,1j,−1j];
c₂=[−1,−1,−1,−1j,−1j,−1j,1j,1j,−1j];
c₃=[−1,−1,−1,1,1,−1j,1j,1j,−1j];
c₄=[−1,−1,−1,1,1,1,1j,1j,−1j];
c₅=[−1,−1,−1,1,1,1,−1,1j,−1j];
c₆=[−1,−1,−1,1,1,1,−1,−1,−1j]; and
c₇=[−1,−1,−1,1,1,1,−1,−1,1j].

13. The apparatus according to claim 10, wherein the first sequence meets the following formula:
$${q}_{1} = \frac{2}{\sqrt{5}} {e}^{\frac{j π}{4}} {s}_{k 1} + \frac{1}{\sqrt{5}} {e}^{\frac{j π}{4}} {s}_{k 2} ,$$
wherein
sₖ₁=[a₀, c_{k1,0,0,0,0,0}, (−1j)*a₁]; sₖ₂=[a₀, c_{k2,0,0,0,0,0}, (−1j)*a₁]; and the second sequence is the HE-LTF sequence, a₀ and a₁ are subsequences in the HE-LTF sequence, and j is an imaginary unit, wherein
k1 is 1, and k2 is 7; or
k1 is 4, and k2 is 5 or 6; or
k1 is 5, and k2 is 1 or 2;
c₁=[1j,1j,1j,−1j,−1j,−1j,1j,1j,−1j];
c₂=[−1,−1,−1,−1j,−1j,−1j,1j,1j,−1j];
c₄=[−1,−1,−1,1,1,1,1j,1j,−1j];
c₆=[−1,−1,−1,1,1,1,−1,−1,−1j]; and
c₇=[−1,−1,−1,1,1,1,−1,−1,1].

14. The apparatus according to claim 1, wherein the first sequence meets the following formula:
$${q}_{2} = \frac{4}{\sqrt{21}} {e}^{\frac{j π}{4}} {s}_{k 3} + \frac{2}{\sqrt{21}} {e}^{\frac{j π}{4}} {s}_{k 4} + \frac{1}{\sqrt{21}} {e}^{\frac{j π}{4}} {s}_{k 5} ,$$
wherein
sₖ₃=[a₀, c_{k3,0,0,0,0,0}, (−1j)*a₁]; sₖ₄=[a₀, c_{k4,0,0,0,0,0}, (−1j)*a₁]; sₖ₅=[a₀, c_{k5,0,0,0,0,0}, (−1j)*a₁]; and the second sequence is the HE-LTF sequence, a₀ and a₁ are subsequences in the HE-LTF sequence, and j is an imaginary unit, wherein
k3 is 1, k4 is 6, and k5 is 7; or
k3 is 1, k4 is 7, and k5 is 5 or 6; or
k3 is 2, k4 is 7, and k5 is 6 or 7; or
k3 is 3, k4 is 5, and k5 is 6; or
k3 is 3, k4 is 5, and k5 is 7; or
k3 is 3, k4 is 6, and k5 is 5 or 6; or
k3 is 3, k4 is 7, and k5 is 1, 2, 3, or 4; or
k3 is 4, k4 is 4, and k5 is 7; or
k3 is 4, k4 is 5, and k5 is 3, 4, or 5; or
k3 is 4, k4 is 6, and k5 is 1, 2, 3, or 4; or
k3 is 5, k4 is 1, and k5 is 3 or 4; or
k3 is 5, k4 is 1, and k5 is 5; or
k3 is 5, k4 is 2, and k5 is 4, 5, or 6; or
k3 is 5, k4 is 3, and k5 is 1, 2, 3, or 4; or
k3 is 5, k4 is 4, and k5 is 1 or 2; or
k3 is 6, k4 is 1, and k5 is 1 or 2; or
k3 is 6, k4 is 2, and k5 is 1, 2, or 3;
c₁=[1j,1j,1j,−1j,−1j,−1j,1j,1j,−1j];
c₂=[−1,−1,−1,−1j,−1j,−1j,1j,1j,−1j];
c₃=[−1, −1,−1,1,1,−1j,1j,1j,−1j];
c₄=[−1,−1,−1,1,1,1,1j,1j,−1j];
c₅=[−1,−1,−1,1,1,1,−1,1j,−1j];
c₆=[−1,−1,−1,1,1,1,−1,−1,−1j]; and
c₇=[−1,−1,−1,1,1,1,−1,−1,1].

15. The apparatus according to claim 10, wherein the first sequence meets the following formula:
$${q}_{3} = \frac{8}{\sqrt{85}} {e}^{\frac{j π}{4}} {s}_{k 6} + \frac{4}{\sqrt{85}} {e}^{\frac{j π}{4}} {s}_{k 7} + \frac{2}{\sqrt{85}} {e}^{\frac{j π}{4}} {s}_{k 8} + \frac{1}{\sqrt{85}} {e}^{\frac{j π}{4}} {s}_{k 9} ,$$
wherein
sₖ₆=[a₀, c_{k6,0,0,0,0,0}, (−1j)*a₁]; sₖ₇=[a₀, c_{k7,0,0,0,0,0}, (−1j)*a₁]; sₖ₈=[a₀, c_{k8,0,0,0,0,0}, (−1j)*a₁]; sₖ₉=[a₀, c_{k9,0,0,0,0,0}, (−1j)*a₁]; and the second sequence is the HE-LTF sequence, a₀ and a₁ are subsequences in the HE-LTF sequence, and j is an imaginary unit, wherein
k6 is 1, k7 is 7, k8 is 4, and k9 is 7; or
k6 is 1, k7 is 7, k8 is 6, and k9 is 3; or
k6 is 2, k7 is 7, k8 is 7, and k9 is 4; or
k6 is 3, k7 is 5, k8 is 7, and k9 is 4; or
k6 is 3, k7 is 6, k8 is 5, and k9 is 5; or
k6 is 3, k7 is 7, k8 is 1, and k9 is 5; or
k6 is 3, k7 is 7, k8 is 2, and k9 is 6; or
k6 is 3, k7 is 7, k8 is 3, and k9 is 4; or
k6 is 4, k7 is 4, k8 is 6, and k9 is 7; or
k6 is 4, k7 is 6, k8 is 1, and k9 is 6; or
k6 is 4, k7 is 6, k8 is 4, and k9 is 3; or
k6 is 5, k7 is 1, k8 is 1, and k9 is 7; or
k6 is 5, k7 is 2, k8 is 6, and k9 is 2; or
k6 is 5, k7 is 4, k8 is 1, and k9 is 1; or
k6 is 5, k7 is 4, k8 is 2, and k9 is 3; or
k6 is 6, k7 is 1, k8 is 1, and k9 is 1;
c₁=[1j,1j,1j,−1j,−1j,−1j,1j,1j,−1];
c₂=[−1,−1,−1,−1j,−1j,−1j,1j,1j,−1j];
c₃=[−1,−1,−1,1,1,−1j,1j,1j,−1j];
c₄=[−1,−1,−1,1,1,1,1j,1j];
c₅=[−1,−1,−1,1,1,1,−1,1j,−1j];
c₆=[−1,−1,−1,1,1,1,−1,−1,−1j]; and
c₇=[−1,−1,−1,1,1,1,−1,−1,1].

16. The apparatus according to claim 10, wherein the first sequence meets the following formula:
$${q}_{4} = \frac{16}{\sqrt{341}} {e}^{\frac{j π}{4}} {s}_{k 10} + \frac{8}{\sqrt{341}} {e}^{\frac{j π}{4}} {s}_{k 11} + \frac{4}{\sqrt{341}} {e}^{\frac{j π}{4}} {s}_{k 12} + \frac{2}{\sqrt{341}} {e}^{\frac{j π}{4}} {s}_{k 13} + \frac{1}{\sqrt{345}} {e}^{\frac{j π}{4}} {s}_{k 14} ,$$
wherein
sₖ₁₀=[a₀, c_{k10,0,0,0,0,0}, (−1j)*a₁]; sₖ₁₁=[a₀, c_{k11,0,0,0,0,0}, (−1j)*a₁]; sₖ₁₂=[a₀, c_{k12,0,0,0,0,0}, (−1j)*a₁];sₖ₁₃=[a₀, c_{k13,0,0,0,0,0}, (−1j)*a₁]; sₖ₁₄=[a₀, c_{k14,0,0,0,0,0}, (−1j)*a₁]; and the second sequence is the HE-LTF sequence, a₀ and a₁ are subsequences in the HE-LTF sequence, and j is an imaginary unit, wherein
k10 is 1, k11 is 7, k12 is 6, k13 is 1, and k14 is 5; or
k10 is 2, k11 is 7, k12 is 5, k13 is 7, and k14 is 5; or
k10 is 6, k11 is 1, k12 is 2, k13 is 4, and k14 is 4; or
k10 is 4, k11 is 6, k12 is 4, k13 is 1, and k14 is 6; or
k10 is 6, k11 is 2, k12 is 1, k13 is 4, and k14 is 5; or
k10 is 3, k11 is 6, k12 is 7, k13 is 1, and k14 is 2; or
k10 is 5, k11 is 3, k12 is 1, k13 is 6, and k14 is 1; or
k10 is 4, k11 is 6, k12 is 2, k13 is 6, and k14 is 6;
c₁=[1j,1j,1j,−1j,−1j,−1j,1j,1j,−1j];
c₂=[−1,−1,−1,−1j,−1j,−1j,1j,1j,−1j];
c₃=[−1,−1,−1,1,1,−1j,1j,1j,−1j];
c₄=[−1,−1,−1,1,1,1,1j,−1j];
c₅=[−1,−1,−1,1,1,1,−1,1j,−1j];
c₆=[−1,−1,−1,1,1,1,−1,−1,−1j]; and
c₇=[−1,−1,−1,1,1,1,−1,−1,−1];

17. The apparatus according to claim 10, wherein the first sequence meets the following formula:
$${q}_{5} = \frac{16}{\sqrt{1365}} {e}^{\frac{j π}{4}} {s}_{k 15} + \frac{16}{\sqrt{1365}} {e}^{\frac{j π}{4}} {s}_{k 16} + \frac{8}{\sqrt{1365}} {e}^{\frac{j π}{4}} {s}_{k 17} + \frac{4}{\sqrt{1365}} {e}^{\frac{j π}{4}} {s}_{k 18} + \frac{2}{\sqrt{1365}} {e}^{\frac{j π}{4}} {s}_{k 19} + \frac{1}{\sqrt{1365}} {e}^{\frac{j π}{4}} {s}_{k 20} ,$$
wherein
sₖ₁₅=[a₀, c_{k15,0,0,0,0,0}, (−1j)*a₁]; sₖ₁₆=[a₀, c_{k16,0,0,0,0,0}, (−1j)*a₁]; sₖ₁₇=[a₀, c_{k17,0,0,0,0,0}, (−1j)*a₁]; sₖ₁₈=[a₀, c_{k18,0,0,0,0,0}, (−1j)*a₁]; sₖ₁₉=[a₀, c_{k19,0,0,0,0,0}, (−1j)*a₁]; sₖ₂₀=[a₀, c_{k20,0,0,0,0,0}, (−1j)*a₁]; and the second sequence is the HE-LTF sequence, a₀ and a₁ are subsequences in the HE-LTF sequence, and j is an imaginary unit, wherein
k15 is 5, k16 is 2, k17 is 4, k18 is 7, k19 is 2, and k20 is 5; or
k15 is 5, k16 is 2, k17 is 5, k18 is 1, k19 is 7, and k20 is 2; or
k15 is 6, k16 is 2, k17 is 2, k18 is 3, k19 is 7, and k20 is 5; or
k15 is 3, k16 is 6, k17 is 6, k18 is 4, k19 is 5, and k20 is 4; or
k15 is 4, k16 is 7, k17 is 2, k18 is 2, k19 is 3, and k20 is 2; or
k15 is 6, k16 is 1, k17 is 2, k18 is 3, k19 is 5, and k20 is 4; or
k15 is 2, k16 is 7, k17 is 7, k18 is 3, k19 is 6, and k20 is 3; or
k15 is 1, k16 is 7, k17 is 5, k18 is 5, k19 is 4, and k20 is 2;
c₁=[1j,1j,1j,−1j,−1j,−1j,1j,1j,−1j];
c₂=[−1,−1,−1,−1j,−1j,−1j,1j,1j,−1j];
c₃=[−1,−1,−1,1,1,−1j,1j,1j,−1j];
c₄=[−1,−1,−1,1,1,1,1j,−1j];
c₅=[−1,−1,−1,1,1,1,−1,1j,−1j];
c₆=[−1,−1,−1,1,1,1,−1,−1,−1j]; and
c₇=[−1,−1,−1,1,1,1,−1,−1,1].

18. The apparatus according to claim 12, wherein a₀ is a subsequence of 1^{st} to 489^{th} elements in the HE-LTF sequence, and a₁ is a subsequence of 504^{th} to 1001^{st} elements in the HE-LTF sequence.

19. A sounding frame transmission method applied to a first device, the method comprising:
generating a sounding frame including a first field, wherein the first field comprises a predefined first sequence having a sequence obtained after a second sequence is modulated by using at least one of the following modulation modes, and wherein the modulation modes comprise: quadrature phase shift keying QPSK, 16-quadrature amplitude modulation 16-QAM, 64-QAM, 256-QAM, 1024-QAM, and 4096-QAM; and
sending the sounding frame.

20. The method according to claim 1 , wherein the second sequence is a high efficiency long training field HE-LTF sequence or an extremely high throughput long training field EHT-LTF sequence in a 4× mode at an 80 MHz bandwidth;
the HE-LTF sequence is:
HE-LTF₄ₓ(−500:500) =
[1, −1, −1, −1, −1, 1, −1, −1, 1, −1, −1, −1, 1, 1, −1, −1, −1, 1, −1, −1, 1, −1, 1, 1, 1, −1, 1, −1,
1, −1, −1, −1, −1, 1, 1, 1, 1, 1, −1, −1, 1, −1, 1, −1, −1, −1, 1, 1, −1, −1, 1, −1, −1, −1, 1, 1, 1, −1, −1,
1, 1, −1, −1, 1, −1, 1, 1, −1, 1, −1, 1, 1, 1, −1, 1, −1, 1, 1, 1, 1, 1, 1, −1, −1, −1, 1, −1, 1, −1, −1, −1,
1, −1, −1, 1, 1, 1, 1, 1, 1, −1, 1, −1, 1, 1, −1, 1, −1, 1, −1, 1, −1, 1, −1, −1, 1, 1, 1, 1, −1, −1, −1, −1,
−1, −1, −1, −1, 1, −1, −1, 1, −1, −1, 1, 1, 1, −1, 1, −1, −1, −1, 1, 1, 1, −1, 1, 1, −1, −1, 1, −1, −1, −1,
1, 1, 1, 1, −1, 1, 1, 1, 1, 1, 1, −1, 1, −1, −1, 1, −1, 1, −1, −1, 1, 1, 1, 1, 1, −1, 1, 1, −1, −1, 1, 1, 1, −1,
1, 1, −1, 1, 1, −1, −1, 1, 1, −1, −1, −1, −1, 1, 1, 1, 1, 1, −1, 1, 1, 1, 1, 1, −1, 1, −1, 1, −1, −1, 1, −1,
−1, −1, −1, −1, 1, −1, −1, −1, 1, 1, −1, 1, −1, 1, −1, −1, −1, −1, −1, 1, 1, 1, 1, −1, 1, −1, −1, 1, 1, −1,
−1, −1, 1, 1, 1, 1, 1, −1, 1, −1, 1, −1, −1, 1, 1, 1, −1, 1, 1, 1, 1, 1, −1, 1, 1, −1, 1, −1, 1, −1, −1, −1, −1,
−1, 1, −1, −1, −1, −1, −1, 1, 1, 1, 1, −1, −1, 1, 1, −1, −1, 1, −1, −1, 1, −1, −1, −1, 1, 1, −1, −1, 1, −1,
−1, −1, −1, −1, 1, 1, −1, 1, −1, 1, 1, −1, 1, −1, −1, −1, −1, −1, −1, 1, −1, −1, −1, −1, 1, 1, 1, −1, 1, 1,
−1, −1, 1, −1, −1, −1, 1, 1, 1, −1, 1, −1, 1, −1, −1, −1, 1, −1, 1, −1, 1, −1, −1, −1, 1, −1, −1, 1, −1, 1,
1, −1, −1, −1, 1, 1, −1, −1, −1, −1, 1, −1, 1, 1, −1, 1, −1, 1, 1, 1, 1, 1, 1, −1, −1, 1, −1, −1, −1, 1, −1,
1, −1, −1, −1, 1, 1, 1, 1, 1, 1, −1, 1, −1, 1, 1, 1, −1, 1, −1, 1, 1, −1, 1, −1, −1, 1, 1, −1, −1, 1, 1, 1, −1,
−1, −1, 1, −1, −1, 1, 1, −1, −1, −1, 1, −1, 1, −1, −1, 1, 1, 1, 1, 1, −1, −1, −1, −1, 1, −1, 1, −1, 1, 1, 1,
−1, 1, −1, −1, 1, −1, −1, −1, 1, 1, −1, −1, −1, 1, −1, −1, 1, −1, −1, −1, −1, 1, −1, 1, 1, −1, −1, −1, 1,
−1, −1, 0, 0, 0, 0, 0, −1, −1, 1, −1, 1, 1, 1, 1, 1, 1, −1, −1, −1, −1, 1, −1, −1, 1, −1, −1, −1, 1, 1, −1, −1,
−1, 1, −1, −1, 1, −1, 1, 1, 1, −1, 1, −1, 1, −1, −1, −1, −1, 1, 1, 1, 1, 1, −1, −1, 1, −1, 1, −1, −1, −1, 1,
1, −1, −1, 1, −1, −1, −1, 1, 1, 1, −1, −1, 1, 1, −1, −1, 1, −1, 1, 1, −1, 1, −1, 1, 1, 1, −1, 1, −1, 1, 1, 1,
1, 1, 1, −1, −1, −1, 1, −1, 1, −1, −1, −1, 1, −1, −1, 1, 1, 1, 1, 1, 1, −1, 1, −1, 1, 1, −1, 1, −1, −1, −1,
−1, 1, 1, −1, −1, −1, 1, 1, −1, 1, −1, −1, 1, −1, −1, −1, 1, −1, 1, −1, 1, −1, −1, −1, 1, −1, 1, −1, 1, 1, 1,
−1, −1, −1, 1, −1, −1, 1, 1, −1, 1, 1, 1, −1, −1, −1, −1, 1, −1, −1, −1, −1, −1, −1, 1, −1, 1, 1, −1, 1, −1,
1, 1, −1, −1, −1, −1, −1, 1, −1, −1, 1, 1, −1, −1, −1, 1, −1, −1, 1, −1, −1, 1, 1, −1, −1, 1, 1, 1, 1, −1,
−1, −1, −1, −1, 1, −1, −1, −1, −1, −1, 1, −1, 1, −1, 1, 1, −1, 1, 1, 1, 1, 1, −1, 1, 1, 1, −1, −1, 1, −1, 1,
−1, 1, 1, 1, 1, 1, −1, −1, −1, 1, 1, −1, −1, −1, −1, −1, −1, −1, −1, 1, 1, 1, 1, 1, −1, 1, −1, 1, −1, −1, 1, 1,
1, −1, 1, 1, 1, 1, 1, −1, 1, 1, −1, 1, −1, 1, −1, −1, −1, −1, −1, 1, −1, −1, −1, −1, −1, 1, 1, 1, 1, −1, −1,
1, 1, −1, −1, 1, −1, −1, 1, −1, −1, −1, 1, 1, −1, −1, 1, −1, −1, −1, −1, −1, 1, 1, −1, 1, −1, 1, 1, −1, 1,
−1, −1, −1, −1, −1, −1, 1, −1, −1, −1, −1, 1, 1, 1, −1, 1, 1, −1, −1, 1, −1, −1, −1, 1, 1, 1, −1, 1, −1, −1,
−1, 1, 1, −1, 1, 1, −1, 1, 1, 1, 1, 1, 1, 1, 1, −1, −1, −1, −1, 1, 1, −1, 1, −1, 1, −1, 1, −1, 1, −1, −1, 1,
−1, 1, −1, −1, −1, −1, −1, −1, 1, 1, −1, 1, 1, 1, −1, 1, −1, 1, 1, 1, −1, −1, −1, −1, −1, −1, 1, −1, 1, −1,
−1, −1, 1, −1, 1, −1, −1, 1, −1, 1, 1, −1, −1, 1, 1, −1, −1, −1, 1, 1, 1, −1, 1, 1, −1, −1, 1, 1, 1, −1, 1, −1,
1, 1, −1, −1, −1, −1, −1, 1, 1, 1, 1, −1, 1, −1, 1, −1, −1, −1, 1, −1, 1, 1, −1, 1, 1, 1, −1, −1, 1, 1, 1, −1,
1, 1, −1, 1, 1, 1, 1, −1];
and
the EHT-LTF sequence is:
HE-LTF₄ₓ(−500:500) =
[1, −1, −1, −1, −1, 1, −1, −1, 1, −1, −1, −1, 1, 1, −1, −1, −1, 1, −1, −1, 1, −1, 1, 1, 1, −1, 1, −1,
1, −1, −1, −1, −1, 1, 1, 1, 1, 1, −1, −1, 1, −1, 1, −1, −1, −1, 1, 1, −1, −1, 1, −1, −1, −1, 1, 1, 1, −1, −1,
1, 1, −1, −1, 1, −1, 1, 1, −1, 1, −1, 1, 1, 1, −1, 1, −1, 1, 1, 1, 1, 1, 1, −1, −1, −1, 1, −1, 1, −1, −1, −1,
1, −1, −1, 1, 1, 1, 1, 1, 1, −1, 1, −1, 1, 1, −1, 1, −1, 1, −1, 1, −1, 1, −1, −1, 1, 1, 1, 1, −1, −1, −1, −1,
−1, −1, −1, −1, 1, −1, −1, 1, −1, −1, 1, 1, 1, −1, 1, −1, −1, −1, 1, 1, 1, −1, 1, 1, −1, −1, 1, −1, −1, −1,
1, 1, 1, 1, −1, 1, 1, 1, 1, 1, 1, −1, 1, −1, −1, 1, −1, 1, −1, −1, 1, 1, 1, 1, 1, −1, 1, 1, −1, −1, 1, 1, 1, −1,
1, 1, −1, 1, 1, −1, −1, 1, 1, −1, −1, −1, −1, 1, 1, 1, 1, 1, −1, 1, 1, 1, 1, 1, −1, 1, −1, 1, −1, −1, 1, −1,
−1, −1, −1, −1, 1, −1, −1, −1, 1, 1, −1, 1, −1, 1, −1, −1, −1, −1, −1, 1, 1, 1, 1, −1, 1, −1, −1, 1, 1, −1,
−1, −1, 1, 1, 1, 1, 1, −1, 1, −1, 1, −1, −1, 1, 1, 1, −1, 1, 1, 1, 1, 1, −1, 1, 1, −1, 1, −1, 1, −1, −1, −1, −1,
−1, 1, −1, −1, −1, −1, −1, 1, 1, 1, 1, −1, −1, 1, 1, −1, −1, 1, −1, −1, 1, −1, −1, −1, 1, 1, −1, −1, 1, −1,
−1, −1, −1, −1, 1, 1, −1, 1, −1, 1, 1, −1, 1, −1, −1, −1, −1, −1, −1, 1, −1, −1, −1, −1, 1, 1, 1, −1, 1, 1,
−1, −1, 1, −1, −1, −1, 1, 1, 1, −1, 1, −1, 1, −1, −1, −1, 1, −1, 1, −1, 1, −1, −1, −1, 1, −1, −1, 1, −1, 1,
1, −1, −1, −1, 1, 1, −1, −1, −1, −1, 1, −1, 1, 1, −1, 1, −1, 1, 1, 1, 1, 1, 1, −1, −1, 1, −1, −1, −1, 1, −1,
1, −1, −1, −1, 1, 1, 1, 1, 1, 1, −1, 1, −1, 1, 1, 1, −1, 1, −1, 1, 1, −1, 1, −1, −1, 1, 1, −1, −1, 1, 1, 1, −1,
−1, −1, 1, −1, −1, 1, 1, −1, −1, −1, 1, −1, 1, −1, −1, 1, 1, 1, 1, 1, −1, −1, −1, −1, 1, −1, 1, −1, 1, 1, 1,
−1, 1, −1, −1, 1, −1, −1, −1, 1, 1, −1, −1, −1, 1, −1, −1, 1, −1, −1, −1, −1, 1, −1, 1, 1, −1, −1, −1, 1,
−1, −1, 0, 0, 0, 0, 0, −1, −1, 1, −1, 1, 1, 1, 1, 1, 1, −1, −1, −1, −1, 1, −1, −1, 1, −1, −1, −1, 1, 1, −1, −1,
−1, 1, −1, −1, 1, −1, 1, 1, 1, −1, 1, −1, 1, −1, −1, −1, −1, 1, 1, 1, 1, 1, −1, −1, 1, −1, 1, −1, −1, −1, 1,
1, −1, −1, 1, −1, −1, −1, 1, 1, 1, −1, −1, 1, 1, −1, −1, 1, −1, 1, 1, −1, 1, −1, 1, 1, 1, −1, 1, −1, 1, 1, 1,
1, 1, 1, −1, −1, −1, 1, −1, 1, −1, −1, −1, 1, −1, −1, 1, 1, 1, 1, 1, 1, −1, 1, −1, 1, 1, −1, 1, −1, −1, −1,
−1, 1, 1, −1, −1, −1, 1, 1, −1, 1, −1, −1, 1, −1, −1, −1, 1, −1, 1, −1, 1, −1, −1, −1, 1, −1, 1, −1, 1, 1, 1,
−1, −1, −1, 1, −1, −1, 1, 1, −1, 1, 1, 1, −1, −1, −1, −1, 1, −1, −1, −1, −1, −1, −1, 1, −1, 1, 1, −1, 1, −1,
1, 1, −1, −1, −1, −1, −1, 1, −1, −1, 1, 1, −1, −1, −1, 1, −1, −1, 1, −1, −1, 1, 1, −1, −1, 1, 1, 1, 1, −1,
−1, −1, −1, −1, 1, −1, −1, −1, −1, −1, 1, −1, 1, −1, 1, 1, −1, 1, 1, 1, 1, 1, −1, 1, 1, 1, −1, −1, 1, −1, 1,
−1, 1, 1, 1, 1, 1, −1, −1, −1, 1, 1, −1, −1, −1, −1, −1, −1, −1, −1, 1, 1, 1, 1, 1, −1, 1, −1, 1, −1, −1, 1, 1,
1, −1, 1, 1, 1, 1, 1, −1, 1, 1, −1, 1, −1, 1, −1, −1, −1, −1, −1, 1, −1, −1, −1, −1, −1, 1, 1, 1, 1, −1, −1,
1, 1, −1, −1, 1, −1, −1, 1, −1, −1, −1, 1, 1, −1, −1, 1, −1, −1, −1, −1, −1, 1, 1, −1, 1, −1, 1, 1, −1, 1,
−1, −1, −1, −1, −1, −1, 1, −1, −1, −1, −1, 1, 1, 1, −1, 1, 1, −1, −1, 1, −1, −1, −1, 1, 1, 1, −1, 1, −1, −1,
−1, 1, 1, −1, 1, 1, −1, 1, 1, 1, 1, 1, 1, 1, 1, −1, −1, −1, −1, 1, 1, −1, 1, −1, 1, −1, 1, −1, 1, −1, −1, 1,
−1, 1, −1, −1, −1, −1, −1, −1, 1, 1, −1, 1, 1, 1, −1, 1, −1, 1, 1, 1, −1, −1, −1, −1, −1, −1, 1, −1, 1, −1,
−1, −1, 1, −1, 1, −1, −1, 1, −1, 1, 1, −1, −1, 1, 1, −1, −1, −1, 1, 1, 1, −1, 1, 1, −1, −1, 1, 1, 1, −1, 1, −1,
1, 1, −1, −1, −1, −1, −1, 1, 1, 1, 1, −1, 1, −1, 1, −1, −1, −1, 1, −1, 1, 1, −1, 1, 1, 1, −1, −1, 1, 1, 1, −1,
1, 1, −1, 1, 1, 1, 1, −1],
wherein
wherein HE−LTF_{4×}(−500: 500) means that values on tones whose sequence numbers are −500 to 500 are values in the HE-LTF sequence successively; and
wherein EHT−LTF_{4×}(−500: 500) means that values on tones whose sequence numbers are −500 to 500 are values in the EHT-LTF sequence successively.
